(19) United States
(12) Patent Application Publication
(10) Pub. No.: US 2008/0019261 A1
(43) Pub. Date: Jan. 24, 2008

(54) INFORMATION RECORDING MEDIUM, INFORMATION RECORDING/PLAYBACK APPARATUS, INSPECTION METHOD OF INFORMATION RECORDING MEDIUM, AND INSPECTION APPARATUS OF INFORMATION RECORDING MEDIUM

(75) Inventors: Tsukasa Nakai, Hino-shi (JP); Koji Takazawa, Tokyo (JP); Hideo Ando, Hino-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/779,533

(22) Filed: Jul. 18, 2007

(30) Foreign Application Priority Data
Jul. 18, 2006 (JP) 2006-196217

(51) Int. Cl. G11B 7/24; H04N 3/14

(52) U.S. Cl. 369/275.4; 348/207.99; 348/294; 369/275.1

(57) ABSTRACT

According to one embodiment, there is disclosed an information recording medium which includes a first information layer formed on a transparent substrate having tracks of a concentric or spiral shape, and a second information layer formed on the first information layer, and allows optical recording and playback from one surface, and in which eccentricity amounts of the tracks of the information layers fall within the range from 0 to 70 μm.

### CROSS-REFERENCE TO RELATED APPLICATIONS

This application is based upon and claims the benefit of priority from Japanese Patent Application No. 2006-196217, filed Jul. 18, 2006, the entire contents of which are incorporated herein by reference.

### BACKGROUND

1. Field

One embodiment of the present invention relates to an information recording medium which allows information recording and playback processes using various kinds of laser beams, and a disc apparatus which attains the recording and playback processes.

2. Description of the Related Art

As information storage media that can play back and record a large capacity of video information, DVDs (Digital Versatile Discs) have prevailed. A movie or video content for about two hours is recorded on a DVD, and the recorded information is played back using a player, so that the user can freely enjoy video contents such as movies and the like at home.

In recent years, digitization of television broadcast has been proposed, and practical use of a high-resolution television system called a high-definition television (HDTV) system has been planned. For this reason, the standards of a next-generation DVD which increases the recording capacity by narrowing down a beam spot size by shortening the laser wavelength, increasing the numerical aperture NA, or the like have been proposed.

As disclosed in Jpn. Pat. Appln. KOKAI Publication No. 2004-206849, a method of increasing the recording capacity includes a method using a single-sided, recordable/reproducible, multi-layer information storage medium which can attain recording and playback for respective recording layers by providing a plurality of recording layers on a disc, moving an objective lens in the optical axis direction, and focusing a beam on respective layers from one side, in addition to the method of narrowing down the beam spot size.

On such multi-layer information storage medium, upon focusing a laser beam on a predetermined recording layer, inter-layer crosstalk (inter-layer XT) readily occurs due to irradiation of some light components on a recording layer other than the predetermined recording layer. This inter-layer XT affects not only recording and playback signals, but also a tracking signal and the like. In an actual recording/playback apparatus, since the temperature inside the apparatus rises, a storage playback medium tends to slightly deform. In this case, so-called disc tilt occurs, and has adverse effects such as an increase in error rate and the like upon recording or playing back information. Such disc tilt also affects not only recording and playback signals, but also a tracking signal and the like.

On this single-sided, recordable/reproducible, multi-layer information storage medium, tracks of respective recording layers readily suffer eccentricity due to misregistration upon adhering substrates, eccentricity of a stamper, and the like in the manufacture. The eccentricity means both deviations from a perfect circle and with the corresponding track in other layers. If the eccentricity from the center of rotation of the information recording medium worsens, problems occur in the recording/playback characteristics of the information recording medium, and result in tracking disability in the worst case.

To solve such problems, as disclosed in, e.g., Jpn. Pat. Appln. KOKAI Publication No. 2003-263789, a method of determining defectives by measuring the edge of the inner periphery of a disc-shaped information recording medium to inspect the eccentricity amount of a disc, or the like has been proposed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic sectional view for explaining the basic structure of an information recording medium according to the present invention;

FIG. 2 is a schematic sectional view for explaining the structure of an information recording medium according to the first aspect of the present invention;

FIG. 3 is a schematic sectional view for explaining the structure of an information recording medium according to the second aspect of the present invention;

FIG. 4 is a schematic sectional view for explaining the structure of an information recording medium according to the third aspect of the present invention;

FIG. 5 is a schematic diagram showing an example of an inspection apparatus for an information recording medium according to the ninth aspect;

FIG. 6 is a schematic diagram showing an example of an inspection apparatus for an information recording medium according to the 10th aspect;

FIG. 7 is a sectional view showing another example of the layer structure of a write-once information storage medium according to the present invention;

FIG. 8 is a sectional view showing an example of the layer structure of a rewritable information storage medium according to the present invention;

FIG. 9 is a block diagram of a process chamber used in the present invention;

FIG. 10 is a flowchart showing the process procedure upon layer formation;

FIGS. 11A and 11B are schematic views of an inspection method according to the present invention;

FIG. 12 is a schematic view of another inspection method according to the present invention;

FIG. 13 is a graph showing the relationship among the linear velocity, eccentricity amount, and tracking;

FIG. 14 is a block diagram for explaining the arrangement of an embodiment of an information recording/playback apparatus that can be used in the present invention;

FIG. 15 is a block diagram showing a signal processing circuit using a PRML detection method;

FIG. 16 is a block diagram showing the arrangement in a Viterbi decoder 156;

FIG. 17 is a chart showing status transition in PR(1, 2, 2, 2, 1) class;

FIG. 18 is a view showing the structure and dimensions of an information storage medium according to one embodiment of the present invention;

FIG. 19 is a view showing the method of setting physical sector numbers on a write-once information storage medium or a read-only information storage medium having a single-layer structure;

FIGS. 20A and 20B are views showing the method of setting physical sector numbers on a read-only information storage medium having a double-layer (or dual-layer) structure;

FIG. 21 is a table showing the physical sector number setting method on a writable information storage medium;

FIG. 22 is a table sowing general parameter values on the writable information storage medium;

FIGS. 23A, 23B, 23C, 239, 23E, and 23F are views showing comparison between the data structures of data areas DTA and data lead-out areas DTLDO of various types of information storage media;

FIG. 24 is a chart showing the waveform (write strategy) of recording pulses used to make a trial write on a drive test zone;

FIG. 25 is a chart showing the definition of a recording pulse shape;

FIG. 26 is a view showing the data structures in a control data zone CDZ and R-physical information zone RIZ;

FIG. 27 is a table showing the detailed information contents in physical format information PFI and R-physical format information R_PFI;

FIG. 28 is a chart showing an overview of the conversion sequence until a physical sector structure is formed;

FIG. 29 is a view showing the structure in a data frame;

FIG. 30 is an explanatory view of an ECC block structure;

FIG. 31 is an explanatory view of a scrambled frame array;

FIG. 32 is an explanatory view of an interleave method of PO;

FIGS. 33A and 33B are explanatory views of the structure in a physical sector;

FIG. 34 is an explanatory view of sync code pattern contents;

FIG. 35 is a block diagram showing the arrangement of a modulation block;

FIG. 36 is a view showing comparison of data recording formats for various kinds of information recording media;

FIGS. 37A and 37B are comparative explanatory views of the data structure in various kinds of information recording media with the prior art;

FIG. 38 is a comparative explanatory of the data structure in various kinds of information recording media with the prior art;

FIG. 39 is a view showing a data recording method of rewritable data to be recorded on a rewritable information storage medium;

FIG. 40 is an explanatory view of data random shift of rewritable data to be recorded on the rewritable information storage medium;

FIG. 41 is an explanatory view of a write-once method of write-once data to be recorded on a write-once information storage medium;

FIG. 42 is a view showing the detailed structure of ECC blocks after PO interleave shown in FIG. 32;

FIGS. 43A, 43B, and 43C are tables showing recording condition parameters expressed as a function of the mark length/the preceding space length;

FIG. 44 is an explanatory view of another embodiment associated with a write-once method of write-once data to be recorded on a write-once information storage medium;

FIG. 45 is a block diagram showing the detailed arrangement of a peripheral unit including a sync code position extraction unit 145 shown in FIG. 14;

FIG. 46 is a view showing an example of the structure and dimensions in an information storage medium;

FIG. 47 is an explanatory view of the relationship between the wobble shape and address bit in an address bit area;

FIGS. 48A, 48B, 48C, and 48D are comparative explanatory views of the positional relationship between wobble sync patterns and allocations in wobble data units;

FIGS. 49A, 49B, 49C, and 49D are explanatory views associated with the data structure in wobble address information on a write-once information storage medium;

FIG. 50 shows a light beam on another layer during recording or playback of a certain layer of a disc;

FIG. 51 is a view for explaining clearance that prevents the influence of the other layer;

FIG. 52 shows a PSN on layer 0 and a corresponding recordable physical sector on layer 1;

FIG. 53 is a view showing the configuration of a lead-in area and lead-out area;

FIG. 54 is a view showing the configuration of an initial middle area;

FIG. 55 is a view showing a track path;

FIG. 56 is a view showing the physical sector layout and physical sector numbers;

FIG. 57 is a view showing the configurations of the middle area before and after extension;

FIG. 58 is a view showing the configuration of the middle area before extension;

FIG. 59 is a view showing the configuration of the middle area after small-size extension;

FIG. 60 is a view showing the configuration of the middle area after large-size extension;

FIG. 61 is a view showing an overview of two neighboring tracks to explain the selection sequence of physical segment types;

FIG. 62 is a view showing an example of a terminator recorded upon finalization of layer 1;

FIG. 63 is a view showing other examples of the terminator recorded upon finalization of layer 1;

FIG. 64 is a flowchart showing a modification example of the recording sequence; and

FIG. 65 is a flowchart showing another modification example of the recording sequence.

### DETAILED DESCRIPTION

Various embodiments according to the invention will be described hereinafter with reference to the accompanying drawings. In general, according to one embodiment of the invention, there is disclosed an information recording medium which includes a first information layer formed on a transparent substrate having tracks of a concentric or spiral shape, and a second information layer formed on the first information layer, and allows optical recording and playback from one surface, and in which eccentricity amounts of the tracks of the information layers fall within the range from 0 to 70 μm.

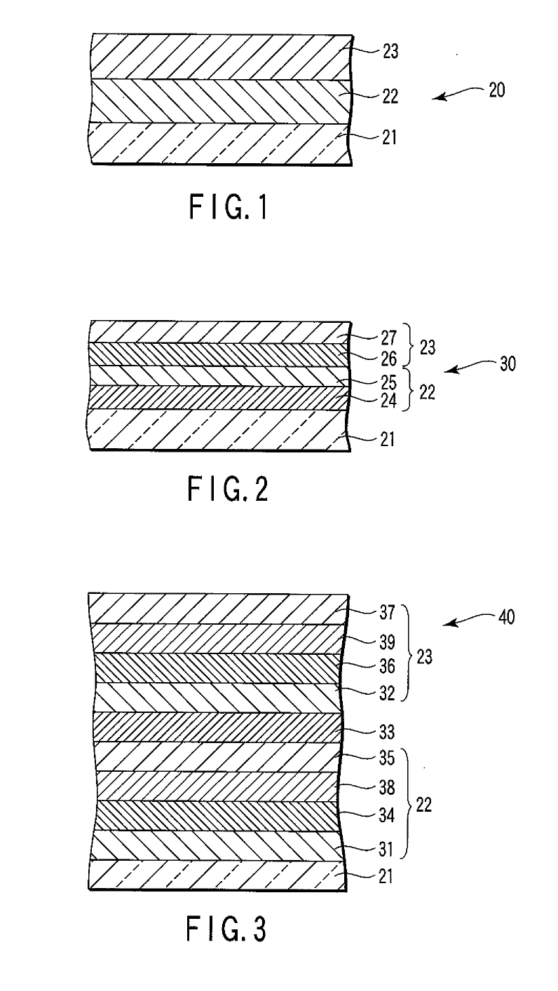

FIG. 1 is a schematic sectional view for explaining the basic structure of an information recording medium according to the present invention.

As shown in FIG. 1, an information recording medium 20 of the present invention is basically an optically recordable/reproducible information recording medium from one side, which includes a first information layer 22 formed on a transparent substrate 21 having tracks of a concentric or spiral shape (not shown), and a second information layer 23 formed on the first information layer 22, and is characterized in that the eccentricity amount of tracks of the information layers fall within a range from 0 to 70 μm.

According to the present invention, since the eccentricity amount is 70 μm or less, recording and playback signals and a tracking signal can be stably obtained even under a condition in which inter-layer crosstalk readily occurs.

The information recording medium according to the present invention is roughly classified into the following seven aspects depending on the configurations of the first and second information layers, and the wavelength of its recording/playback light.

FIG. 2 is a schematic sectional view for explaining the structure of an information recording medium according to the first aspect of the present invention.

An information recording medium 30 according to the first aspect of the present invention can undergo recording and playback using light with a wavelength falling within a range from 180 nm to 620 nm. A first information layer 22 of the medium 30 is formed on a transparent substrate 21, and includes a first organic dye layer 24 and a first reflecting layer 25 formed on the first organic dye layer 24. A second information layer 23 of the medium 23 is formed on the first reflecting film 25, and has a second organic dye layer 26 and a second reflecting layer 27 formed on the second organic dye layer 26.

The information recording medium according to the first aspect can undergo recording and playback using light such as light of a short wavelength of 620 nm or less, e.g., blue-violet laser light of 405 nm or the like, and can be used as a write-once optical recording medium (e.g., DVD-R or the like) since its recording layers include the organic dye layers.

An intermediate layer as an interlayer dielectric layer used to optically separate the first and second information layers can be formed between the first reflecting layer and second organic dye layer.

Note that in the present invention, the eccentricity amount includes deviations from the center of a disc-shaped substrate and from the center of rotation of the substrate, which respectively indicate maximum values of deviations from the tracks on the first and second information layers.

In the present invention, assume that the reflecting layer includes a total reflecting layer and semitransparent reflecting layer.

In the present invention, the multi-layer information recording medium has two or more information layers, and more information layers such as a third information layer, fourth information layer, and the like can be arbitrarily provided.

FIG. 3 is a schematic sectional view for explaining the structure of an information recording medium according to the second aspect of the present invention.

An information recording medium 40 according to the second aspect of the present invention can undergo recording and playback using light with a wavelength falling within the range from 180 nm to 620 nm. A first information layer 22 of the medium 40 is formed on a transparent substrate 21, and includes a first dielectric layer 31, first phase change recording layer 34, second dielectric layer 38, and first reflecting layer 35. A second information layer 23 of the medium 40 is formed on the first information layer 22 via an intermediate layer 33, and has a third dielectric layer 32, second phase change recording layer 36, fourth dielectric layer 39, and second reflecting layer 37.

The information recording medium according to the second aspect can undergo recording and playback using light such as light of a short wavelength of 620 nm or less, e.g., blue-violet laser light of 405 nm or the like, and can be used as a rewritable optical recording medium (e.g., DVD-RW, DVD-RAM, or the like) since its recording layers include the phase change recording layers.

The dielectric layer can arbitrarily include a protection layer, interface layer, and the like.

The interface layer can be formed to be in contact with one or both of the principal surfaces of the first and second phase change recording layers. The whole dielectric layer may be the interface layer.

The first and second reflecting layers can be formed to be in contact with the corresponding dielectric layers of the respective information layers. Another dielectric layer may be formed above the reflecting layer so as to attain optical enhancement, thermal diffusion, SN ratio improvement, and the like.

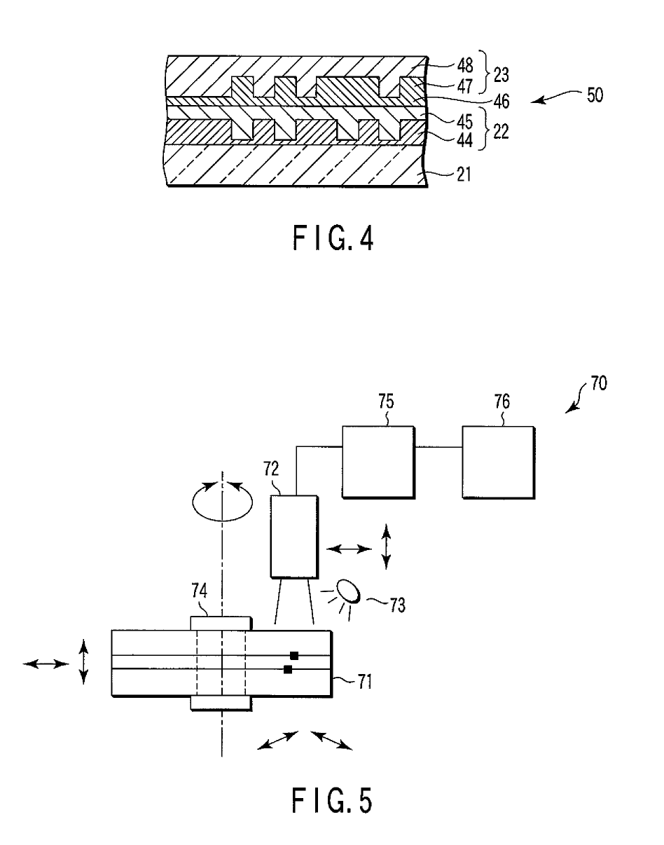

FIG. 4 is a schematic sectional view for explaining the structure of an information recording medium according to the third aspect of the present invention.

An information recording medium according to the third aspect of the present invention can undergo recording and playback using light with a wavelength falling within the range from 180 nm to 620 nm. A first information layer 22 of the medium 50 includes a first information pattern 44 embossed on the surface of a transparent resin substrate 21, and a first reflecting layer 45 formed on this first information pattern. A second information layer 23 of the medium 50 is formed on the first reflecting layer, and has a transparent resin layer 46 or transparent resin substrate on which a second information pattern 47 is embossed, and a second reflecting layer 48 formed on the second information pattern 47.

The information recording medium according to the third aspect can undergo playback using light such as light of a short wavelength of 620 nm or less, e.g., blue-violet laser light of 405 nm or the like, and can be used as a read-only optical recording medium (e.g., DVD-ROM or the like) since its recording layers include the embossed information patterns.

An information recording medium according to the fourth aspect has the same structure as that according to the first aspect, except that recording and playback are done at a linear velocity of 30 (m/sec) or higher and using light with a wavelength falling within the range from 620 nm (exclusive) to 830 nm (inclusive).

An information recording medium according to the fifth aspect has the same structure as that according to the second aspect, except that recording and playback are done at a linear velocity of 30 (m/sec) or higher and using light with a wavelength falling within the range from 620 nm (exclusive) to 830 nm (inclusive).

An information recording medium according to the sixth aspect has the same structure as that according to the first aspect, except that playback can be done using light of two or more different wavelengths.

An information recording medium according to the seventh aspect has the same structure as that according to the third aspect, except that playback can be done using light of two or more different wavelengths.

An information recording/playback apparatus according to the eighth aspect of the present invention is an apparatus which records and plays back one of the information recording media according to the first to seventh aspects.

An inspection apparatus for an information recording medium according to the present invention is roughly classified into two aspects, i.e., the ninth and 10th aspects.

FIG. 5 is a schematic diagram showing an example of an inspection apparatus for an information recording medium according to the ninth aspect.

As shown in FIG. 5, an inspection apparatus 70 for an information recording medium according to the present invention has a mechanism 74 which clamps a multi-layer information recording medium 71, which includes first and second information layers having tracks of a concentric or spiral shape, and allows playback from one side using light with a wavelength falling within the range from 180 nm to 620 nm, an illumination system 73 which irradiates the multi-layer information recording medium 71 with an illumination that does not contain light components of wavelengths of 620 nm or less, an image sensing mechanism 72 such as a CCD camera or the like which senses images of the tracks of the first and second information layers, an image processing unit 75 which extracts the paths of the tracks by processing image information obtained from the image sensing mechanism 72, and an arithmetic and control unit 76 which calculates the eccentricity amounts of the tracks based on the extracted information. The unit is a personal computer or like it.

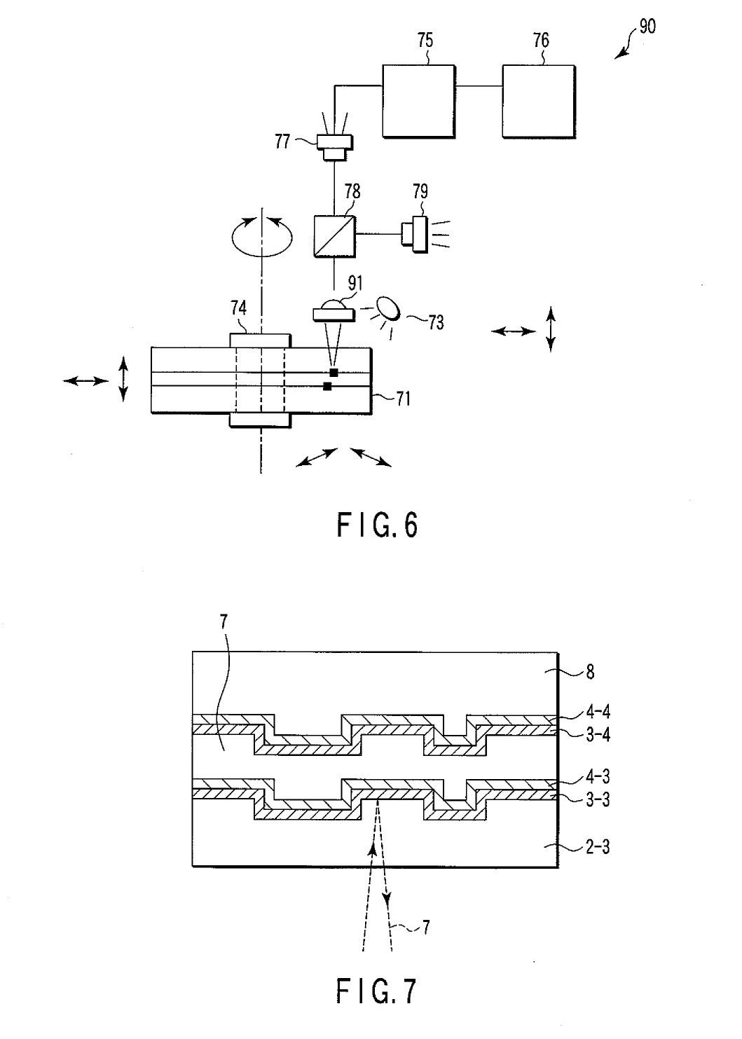

FIG. 6 is a schematic diagram showing an example of an inspection apparatus for an information recording medium according to the 10th aspect.

As shown in FIG. 6, an inspection apparatus 90 for an information recording medium has the same arrangement as in FIG. 5, except that, in place of the image sensing mechanism 72, it comprises a light source 79 such as an LD, LED, or the like, a mirror 78 which diffracts light from the light source 79 in a predetermined direction, a lens 91 for focusing the light diffracted by the mirror 78 and radiating the tracks of a desired recording layer with the focused light, and a reflectance measuring device 77 (e.g., photodetector) which receives the light reflected by the recording layer.

An inspection method of an information recording medium according to the present invention can be roughly classified into two aspects, i.e., the 11th and 12th aspects.

An inspection method of an information recording medium according to the 11th aspect is a method using the inspection apparatus according to the ninth aspect, and comprises steps of: irradiating a multi-layer information recording medium, which includes first and second information layers having tracks of a concentric or spiral shape, and allows playback from one surface using light with a wavelength falling within the range from 180 nm to 620 nm, with an illumination that does not contain light components with wavelengths of 620 nm or less, and sensing images for at least one round of the tracks by focusing a light spot on the tracks of the first and second information layers using the image sensing mechanism; and extracting paths of the tracks by processing the obtained image information by the image processing unit and calculating the eccentricity amounts of the tracks based on the extracted information by the arithmetic and control unit.

Furthermore, an inspection method of an information recording medium according to the 12th aspect is a method using the inspection apparatus according to the 10th aspect, and is the same as the method according to the 11th aspect, except that the method comprises steps of: measuring reflectance distributions of reflected light for at least one round of the tracks of the first and second information layers using a reflectance distribution measurement mechanism while irradiating the multi-layer information recording medium with a laser beam using a laser beam irradiation device, in place of the step of irradiating the multi-layer information recording medium with illumination that does not contain light components with wavelengths of 620 nm or less, and sensing images for at least one round of tracks by focusing the light spot on the tracks of the first and second information layers using the image sensing mechanism; and extracting paths of the tracks by applying image processing to the reflectance distributions in place of the obtained image information.

The operation of an optical recording medium according to the present invention will be described in more detail hereinafter.

FIG. 7 shows another example of the layer structure of a write-once information storage medium associated with the first, fourth, and sixth aspects.

The information storage medium has a structure, from the light incidence side, in which an L0 information layer is prepared by stacking an organic dye recording layer 3-3 and reflecting layer 4-3 in turn on a transparent substrate 2-3, an L1 information layer is prepared by stacking an interlayer dielectric layer 7 as an adhesive layer, organic dye recording layer 3-4, and reflecting layer 4-4 in turn on the L0 layer, and another transparent substrate 8 is adhered on the resultant structure. Note that the information storage medium may have a structure in which the reflecting layer 4-4 and organic dye recording layer 3-4 are stacked in turn on the transparent substrate 8 used for the L1 information layer, and the resultant structure may be adhered to the L0 information layer using the interlayer dielectric layer 7 as an adhesive layer.

Note that the structure of the organic dye recording medium according to an embodiment of the present invention is not limited to that shown in FIG. 7. For example, a layer which prevents any reaction between the reflecting layer or semitransparent reflecting layer and the organic dye, or any change or deterioration of the reflecting layer or semitransparent reflecting layer due to a contact of the reflecting layer or semitransparent reflecting layer with the organic dye may be formed between the organic dye recording layer 3-3 and reflecting layer 4-3. The reflecting layer may be formed of a plurality of metal layers. More dielectric layers may be formed on a contact portion between the organic dye recording layer and reflecting layer, that between the organic dye and interlayer dielectric layer, that between the semitransparent reflecting layer and interlayer dielectric layer, that between the reflecting layer and transparent substrate, and the like.

In case of a double-layer medium, the first information layer closer to the light incidence surface and the second information layer farther from the light incidence surface, which layers have the above structures, are prepared, and these two information layers may be adhered via an adhesive layer to attain interlayer separation. Basically the same applies to multi-layer media having three or more layers.

Furthermore, the present invention is also applicable to a medium which receives light via a transparent sheet as thin as about 0.1 mm adhered on a substrate on which various layers are formed (assume that such medium uses an objective lens with an NA as high as about 0.85). This is because the characteristics required for the organic dye recording film layer and reflecting layer materials to be used are not much different between a case wherein the transparent cover layer as thin as about 0.1 mm is used on the light incidence side and a case wherein a 0.6-mm thick transparent substrate mainly used in the present invention is used.

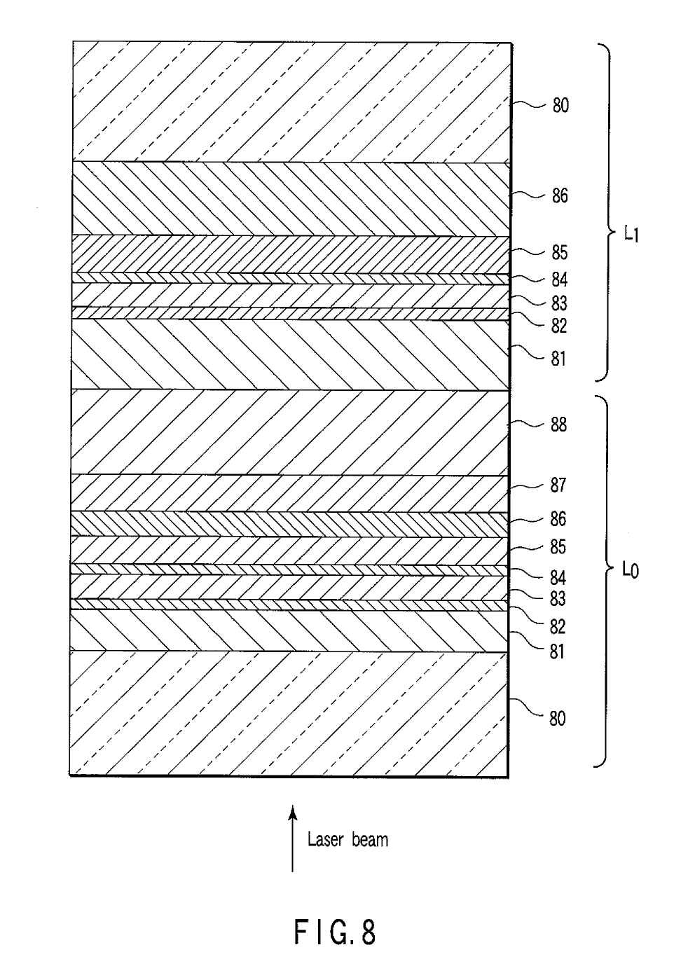

FIG. 8 shows an example of the layer structure of a rewritable information recording medium associated with the second and fifth aspects.

The information recording medium has a structure, from the light incidence side, in which an L0 information layer is prepared by stacking, in turn, a first interference layer 81 (also called a protection layer or dielectric layer; the same applies to the following description), lower interface layer 82, recording layer 83, upper interface layer 84, second interference layer 85, reflecting layer 86, and third interference layer 87 on a transparent substrate 80, an L1 information layer is prepared by stacking, in turn, a reflecting layer 86, second interference layer 85, upper interface layer 84, recording layer 83, lower interface layer 82, and first interference layer 81 on a transparent substrate 80 in the order opposite to the L0 layer, and the two information layers are adhered using an interlayer dielectric layer 88.

Note that the structure of a phase change recording medium according to an embodiment of the present invention is not limited to that shown in FIG. 8. For example, another dielectric layer may be formed between the second interference layer 85 and reflecting layer 86. The interference layers may be replaced by the material of the interface layers, and may be omitted. The reflecting layers may be omitted. Each reflecting layer may be made up of a plurality of metal layers. Another dielectric layer may be formed on the reflecting layer.

The substrate used in this embodiment is roughly classified into two types.

(a) A substrate of one type has a groove pitch of about 0.6 to 0.8 Mm, and uses a so-called land-groove recording method that makes recording on both the land and groove. In the following description, a medium using the substrate of this type will also be referred to as a rewritable type (1) information recording medium.

(b) A substrate of the other type has a groove pitch of about 0.3 to 0.4 μm, and uses a so-called groove recording method which makes recording on either the land or groove (a method that records only on the land will also be referred to as the groove recording method). In the following description, a rewritable medium using this method will also be referred to as a rewritable type (2) information recording medium. Also, a medium that uses organic dye recording layers and allows recording only once will be referred to as a write-once type medium (write-once information storage medium (write-once type medium)). After write, such medium is designed so that the pitch of written pits in the track direction becomes about 0.3 to 0.4 μm as in a read-only storage medium. On a read-only medium, no grooves are formed, and data are recorded using a pit array.

The thickness of the substrate on the light incidence side can range from a thickness as very small as about 0.1 mm to a thickness of 0.6 mm in accordance with the NA value of the objective lens of the optical pickup.

Examples to be described below use these information recording/playback apparatuses and discs (information recording media).

As a result of careful consideration of the aforementioned aspects, the present inventors reached a conclusion that the points to be described below were important. In an information recording/playback medium which is a single-sided, multi-layer medium which has a plurality of information layers that undergo recording or playback using light with a wavelength falling within the range from 620 nm (inclusive) to 180 nm (inclusive) and can access respective layers from one side, and which comprises a transparent substrate, interlayer dielectric layer, organic dye material, and reflecting layer or semitransparent reflecting layer, or in which a layer that prevents any reaction between the reflecting layer or semitransparent reflecting layer and the organic dye material, or a change or deterioration of the reflecting layer or semitransparent reflecting layer due to a contact of the reflecting layer or semitransparent reflecting layer with the organic dye material is formed between the reflecting layer or semitransparent reflecting layer and the organic dye material, an information recording/playback medium in which the eccentricity F amounts of tracks of the respective information layers are, for example, 70 μm or less and, more preferably, 40 μm or less, is preferable.

The eccentricity amounts of the tracks can be precisely presented since a precise evaluation method to be described later has been established. For this reason, establishment of the following evaluation method is one of important prerequisites of the present invention. The characteristics of the information storage medium of the present invention largely depend on the data structure, recording of system information, and the recording method, as described above. Conventionally, the data structure and the like, and improvement and stability of the recording and playback characteristics of an information storage medium could not be examined due to the influences that no accurate evaluation method was established, various variation factors in the manufacturing process of an information storage medium were present, and so forth. The present inventors were dedicated to exploring the physical structure of an information storage medium, and the data structure, recording method, and the like used in that medium, and made studies about points that were not explored conventionally, thus achieving the present invention.

Not only the measurement principle of the method of measuring the eccentricity amount of each track of the present invention is described, but also apparatuses using this method can be used as an inspection apparatus for storage media upon industrially mass-producing them. The conventionally used method has insufficient measurement accuracy, and requires very complicated measurement. Using the evaluation method of the present invention, storage media can be inspected at a rate of one medium per several seconds, i.e., within an equivalent time period required to manufacture one storage medium. Therefore, the evaluation method of the present invention is industrially very useful.

In an information recording/playback medium which is a single-sided, multi-layer medium which has a plurality of information layers that undergo recording or playback using light with a wavelength falling within the range from 620 nm (inclusive) to 180 nm (inclusive) and can access respective layers from one side, and which comprises a transparent substrate, interlayer dielectric layer, phase change recording material, protection layer, interference layer, and reflecting layer or semitransparent reflecting layer and also another protection layer formed on the semitransparent reflecting layer, an information recording/playback medium in which the eccentricity amounts of tracks of the respective information layers are, for example, 70 μm or less and, more preferably, 40 μm or less, is preferable.

In an information recording/playback medium which is a single-sided, multi-layer medium which has a plurality of information layers that undergo playback using light with a wavelength falling within the range from 620 nm (inclusive) to 180 nm (inclusive) and can access respective layers from one side, and which comprises a transparent substrate embossed with information, interlayer dielectric layer, and reflecting layer or semitransparent reflecting layer, an information recording/playback medium in which the eccentricity amounts of tracks of the respective information layers are, for example, 70 μm or less and, more preferably, 40 μm or less, is preferable.

An evaluation method which is a method of measuring the eccentricity amounts of respective track of the respective information layers, and which evaluates the eccentricity amounts of the tracks by focusing a beam spot on the respective information layers using an image processing apparatus, comprising an illumination system which does not include light components with wavelengths of 620 nm or less, a CCD camera, and track extraction mechanism, and an arithmetic and control apparatus, is preferable. Especially, since the material of a medium using an organic dye changes by irradiated light, the inspection method of the present invention selects the wavelength of the light of the illumination system to be used. On the other hand, the wavelength range of a light source used in the illumination system largely influences the sensitivity of the CCD camera as a detection system, the measurement accuracy, and the measurement time. In order to increase the detection accuracy, the wavelength range of the light source to be used is preferably shorter. Conversely, in consideration of the sensitivity of an organic dye, if light with a wavelength of 620 nm or less is used, the organic dye is unwantedly changed by evaluating it.

An evaluation method which is a method of measuring the eccentricity amounts of respective tracks of the respective information layers, and which evaluates the eccentricity amounts of the tracks by focusing on the respective information layers using an image processing apparatus comprising a laser irradiation device, reflectance distribution measurement mechanism, and track extraction mechanism, and an arithmetic and control apparatus, is preferable. Especially, since the material of a medium using an organic dye changes by irradiated light, the inspection method of the present invention can select the wavelength of the light of the illumination system to be used. On the other hand, the wavelength range of a light source used in the illumination system largely influences the sensitivity of the CCD camera as a detection system, the measurement accuracy, and the measurement time. In order to increase the detection accuracy, the wavelength range of the light source to be used is preferably shorter. Conversely, in consideration of the sensitivity of an organic dye, if light with a wavelength of 620 nm or less is used, the organic dye is unwantedly changed by evaluating it.

An evaluation method which is a method of measuring the eccentricity amounts of respective tracks of the respective information layers, and which evaluates the eccentricity amounts of the tracks characterized by using a laser irradiation device whose wavelength exceeds 620 nm, is preferable.

A method which is a method of measuring the eccentricity amounts of respective track of the respective information layers described above, and which measures the eccentricity amounts of the tracks using the tracks which have undergone trial recording for the purpose of learning, optimization, or the like of write strategy is preferable.

A measurement apparatus of the eccentricity amounts of respective track of the respective information layers using the aforementioned evaluation method is preferable.

An information recording/playback apparatus which comprises the aforementioned evaluation method is preferable.

In an information recording/playback medium which is a single-sided, multi-layer medium which has a plurality of information layers that undergo recording or playback using light with a wavelength that exceeds 620 nm and can access respective layers from one side, and which is driven at a linear velocity of 30 m/sec or higher and, more preferably, at a linear velocity of 40 m/sec or higher, and comprises a transparent substrate, interlayer dielectric layer, organic dye material, and reflecting layer or semitransparent reflecting layer, or in which a layer that prevents any reaction between the reflecting layer or semitransparent reflecting layer and the organic dye material, or a change or deterioration of the reflecting layer or semitransparent reflecting layer due to a contact of the reflecting layer or semitransparent reflecting layer with the organic dye material is formed between the reflecting layer or semitransparent reflecting layer and the organic dye material, an information recording/playback medium in which the eccentricity amounts of tracks of the respective information layers are, for example, 70 μm or less and, more preferably, 40 μm or less, is preferable.

In an information recording/playback medium which is a single-sided, multi-layer medium which has a plurality of information layers that undergo recording or playback using light with a wavelength falling within the range from 620 nm (inclusive) to 180 nm (inclusive) and can access respective layers from one side, and which is driven at a linear velocity of 30 m/sec or higher and, more preferably, at a linear velocity of 40 m/sec or higher, and comprises a transparent substrate, interlayer dielectric layer, phase change recording material, protection layer, interference layer, and reflecting layer or semitransparent reflecting layer and also another protection layer, an information recording/playback medium in which the eccentricity amounts of tracks of the respective information layers are, for example, 70 μm or less and, more preferably, 40 μm or less, is preferable.

The present invention is a single-sided, multi-layer medium which has a plurality of information layers that undergo recording or playback using light with a wavelength of 620 nm or less and can access respective layers from one side, and which has been examined. It was found that these techniques are useful even when the wavelength is 620 nm or more. Also, it was found that the effects are especially significant upon recording and playback at a high linear velocity, and these techniques are preferably applied to an information storage medium which is driven at a linear velocity of 40 m/sec or higher. Furthermore, when the above techniques are applied to an information storage medium which is driven at a linear velocity of 50 m/sec or higher, the difference from the prior arts is outstanding. The same effects obtained at a high linear velocity applies to a case of the wavelength of 620 nm or less, and when the present invention is applied to an information storage medium which is driven a linear velocity of 30 m/sec or higher, more preferably, a linear velocity of 40 m/sec or higher and, further more preferably, a linear velocity of 50 m/sec or higher, the difference from the prior arts is outstanding.

In an information recording/playback medium which is a single-sided, multi-layer medium which has a plurality of information layers that undergo recording or playback using light of a plurality of wavelengths and can access respective layers from one side, and which comprises a transparent substrate, interlayer dielectric layer, organic dye material, and reflecting layer or semitransparent reflecting layer, or in which a layer that prevents any reaction between the reflecting layer or semitransparent reflecting layer and the organic dye material, or a change or deterioration of the reflecting layer or semitransparent reflecting layer due to a contact of the reflecting layer or semitransparent reflecting layer with the organic dye material is formed between the reflecting layer or semitransparent reflecting layer and the organic dye material, an information recording/playback medium in which the eccentricity amounts of tracks of the respective information layers are, for example, 70 μm or less and, more preferably, 40 μm or less, is preferable.

In an information recording/playback medium which is a single-sided, multi-layer medium which has a plurality of information layers that undergo playback using light of a plurality of wavelengths and can access respective layers from one side, and which comprises a transparent substrate embossed with information, interlayer dielectric layer, and reflecting layer or semitransparent reflecting layer, an information recording/playback medium in which the eccentricity amounts of tracks of the respective information layers are, for example, 70 μm or less and, more preferably, 40 μm or less, is preferable.

An information recording/playback medium which is the aforementioned information recording/playback medium and is characterized in that any of the radial position where each information layer is formed, the radial positions of a pit forming part and groove forming part, the radial positions of a mirror part and groove forming part, the radial position of a zone boundary, and the radial position where wobble shapes are different, is different depending on the information layers, is preferable.

An information recording/playback medium which is the aforementioned information recording/playback medium and is characterized in that any of the radial position where each information layer is formed, crystalline position, and initialization position is different depending on the information layers, is preferable.

In the following explanation, examples of single-sided, double-layer media will be described.

Also, as measurement data of an optical disc manufactured by way of trial, the worst value of lands (L) and grooves (C) of L0 and L1 in each experiment is indicated as a typical value.

The experiments for evaluating the disc characteristics of rewritable information storage media are roughly classified into the following three experiments.

(1) Measurement of Bit Error Rate (SbER: Simulated Bit Error Rate)

One experiment is measurement of the bit error rate (SbER: Simulated bit Error Rate) and PRSNR by which the data error rate is measured. The other experiment is analog measurement for determining the readout signal quality. In the measurement of the SbER and PRSNR, a mark string or train including patterns from 2 T to 13 T at random was overwritten 10 times. Then, the same random patterns were overwritten 10 times on adjacent tracks on the two sides of the former track. After that, the SbER and PRSNR of the middle track were measured.

(2) Analog Measurement

The analog measurement was done as follows.

First, a mark string or train including patterns from 2 T to 13 T at random was overwritten 10 times. Then, a 9 T single pattern was overwritten once on this mark train, and the carrier-to-noise ratio (CNR) of the signal frequency of the 9 T mark was measured by a spectrum analyzer. After that, a laser beam having an erase power level was emitted for one rotation of the disc to erase the recorded marks. In this state, the reduction in carrier intensity of the 9 T mark was measured and defined as the erase ratio (ER). The head was then moved to a sufficiently separated track to measure the cross erase (E-X).

(3) Overwrite (OW) Test

As the third measurement, an experiment about the overwrite (OW) characteristic was conducted. In this experiment, the CNR was measured while a random signal was overwritten (OW) on the same track, thereby checking whether the count of overwrite was 2,000 or more when the CNR was reduced by 2 dB or more from the initial value. This experiment was not conducted to check the limit count of OW. For video recording, the limit count of OW is required to be about 1,000. For data recording of a PC, the limit count of OW is required to be 10,000 or more. However, since the market for video recording is much larger than that for data recording, the evaluation was performed in view of video recording.

As the criteria of evaluation, that for the SbER is 5.0×10⁻⁵ or less, and that for the PRSNR is 15.0 or more. Note that the read power of a single-sided, double-layer medium was selected in consideration of the optical characteristics (L0 reflectance and transmittance, and L1 reflectance) and sensitivity of the medium, and the signal amplitudes and SN ratios of playback signals, so that SN ratios and signal amplitudes of L0 and L1 playback signals were nearly equal to each other. When all characteristics met target values, that recording medium was determined as “good”, and when at least one characteristic did not meet a target value, it was determined as “rejection”.

On the other hand, in case of a write-once information storage medium (write-once type medium), the following four experiments were conducted:

(a), (b) (1) measurement of the bit error rate conducted for the rewritable medium;

(c) modulation; and

(d) reflectance and playback (read) stability of data part.

As the criteria of evaluation, that for the SbER is 5.0×10⁻⁵ or less, that for the PRSNR is 15.0 or more, that for modulation is 0.4 or more, that for reflectance is 4% or higher for each of L0 and L1 media in case of a single-sided, double-layer medium, and that for read stability is that the characteristics (a) to (d) achieve targets even after read of one million or more times when continuous read is made using a satisfactory power of any of 0.4 to 0.8 mW in case of a single-sided, double-layer medium. Note that the read power of a single-sided, double-layer medium was selected in consideration of the optical characteristics (L0 reflectance and transmittance, and L1 reflectance) and sensitivity of the medium, and the signal amplitudes and SN ratios of playback signals, so that SN ratios and signal amplitudes of L0 and L1 playback signals were nearly equal to each other. When all characteristics met target values, that recording medium was determined as “good”, and when at least one characteristic did not meet a target value, it was determined as “rejection”.

In case of a rewritable medium, the recording film on the entire medium surface of each layer was crystallized by using an initializing apparatus. After the initialization, the layers were adhered by a UV resin such that the surfaces on which the films are formed faced each other, thereby forming an interlayer dielectric layer. A write-once medium was fabricated via the processes of formation of an organic dye recording film by spin-coating, formation of a reflecting layer, and adhesion or bonding. A read-only information storage medium was fabricated by forming a reflecting layer on each of substrates on which information was recorded as pits, and bonding the substrates using a UV resin. The thickness of the interlayer dielectric layer falls within the range from 20 to 30 μm.

Evaluation was performed by using the ODU-1000 disc evaluation apparatus available from Pulstec. This apparatus is comprised of a blue-violet semiconductor laser having a wavelength of 405 nm, and an objective lens having NA=0.65. Recording/playback experiments were conducted under the condition of a linear velocity of 5.6 m/sec or 6.6 m/sec to evaluate rewritable media, and were conducted under the condition of a linear velocity of 6.6 m/sec to evaluate write-once media.

Note that the present invention is also applicable to a medium which receives light via a transparent sheet as thin as about 0.1 mm adhered on a substrate on which various layers are formed (assume that such medium uses an object lens with an NA as high as about 0.85). This is because the characteristics required for the phase change recording layer, interface layer, protection layer, organic dye recording layer, and reflecting layer materials to be used are not much different between a case wherein the transparent cover layer as thin as about 0.1 mm is used on the light incidence side and a case wherein a 0.6-mm thick transparent substrate mainly used in the present invention is used.

The following examples will mainly exemplify single-sided, double-layer media shown in FIGS. 7 and 8 to help understand the effects of the present invention.

### EXAMPLE 1

As a substrate, a 0.6-mm thick polycarbonate (PC) substrate fabricated by injection molding was used. Grooves are formed on the substrate at a track pitch of 0.4 μm. A single-layer medium is fabricated in such a manner that a dye is applied onto the substrate by spin-coating, a reflecting layer is formed on the dye film by sputtering, and a 0.6-mm thick PC substrate is adhered onto the resultant structure using a UV-curing resin.

On the other hand, a single-sided, double-layer medium can use two different methods. In the first method, the medium is fabricated in such a manner that a dye is applied onto an L0 substrate by spin-coating, a semitransparent reflecting layer is formed on the dye film by sputtering, an interlayer dielectric layer is formed on the reflecting layer by the 2P method, grooves for L1 are formed in the interlayer dielectric layer, a dye is applied to the interlayer dielectric layer by spin-coating, a reflecting layer is formed on the dye film by sputtering, and a 0.6-mm thick PC substrate is finally adhered onto the resultant structure using a UV-curing resin. With this method, after formation of the semitransparent reflecting layer of the L0 layer, another layer can be formed on the reflecting layer for the purpose of adjustment of the optical characteristics. In the second method, an L0 substrate on which a dye is applied by spin-coating and a semitransparent reflecting layer is formed on the dye film is prepared, and an L1 substrate on which a reflecting film is formed initially by sputtering, and a dye is applied onto the reflecting layer by spin-coating is prepared. The fabricated L0 and L1 layers are adhered using a UV-curing resin so that their semitransparent layer surface and organic dye surface face each other. With this method, another layer can be inserted between the organic dye layer as the L1 recording layer and the UV-curing resin for the purpose of stabilization of the organic dye as the L1 recording layer material or adjustment of the optical characteristics. The present invention conducted experiments using media fabricated using these two methods.

Organic dye materials used (to be also simply referred to as “dye” hereinafter) are roughly classified into three types, i.e., (1) anion-cation based, (2) organic metal complex (azo based), and (3) a dye mixture of anion-cation based and organic metal complex (azo based). The reflecting layer used a binary based Ag alloy selected from the group consisting of AgAu, AgBi, AgCa, AgCe, AgCo, AgGa, AgLa, AgMg, AgN, AgNi, AgNd, AgPd, AgY, AgW, and AgZr, and a ternary based Ag alloy selected from the group consisting of AgAlMg, AgAuBi, AgBiGa, AgAuCo, AgAuCe, AgAuNi, AgAuMg, AgBiMg, AgBiN, AgBiPd, and AgBiZr, and the effects upon simultaneously adding additive elements of first and second groups and N (nitrogen) were confirmed. The film formation method used the aforementioned respective Ag alloy targets, multiple-target sputter whose sputter conditions were adjusted to obtain a desired composition, or the like. A reaction with nitrogen was conducted using, as a sputter gas, a gas mixture of Ar and N (nitrogen) in place of normal Ar alone. The composition film thicknesses of the dye and reflecting layer and the substrate shape were respectively adjusted to obtain satisfactory signal characteristics.

The additive amounts of additive elements in Ag alloy reflecting layers used in Examples used four levels, i.e., 0.05, 1, 2, and 5 at. %, and the organic dye materials as the recording layer used three levels, i.e., (1), (2), and (3). Therefore, the total number of samples prepared in Examples is 12.

Tables 1 and 2 below show additive element names of Ag alloy reflecting layers used in Examples. The media were fabricated to have the eccentricity amounts of 70 μm or less of the tracks of the information layers. Note that the media with smaller eccentricity amounts were fabricated from the stage of a stamper, and substrates which were molded using the stamper and had smaller eccentricity amounts were selected. The bonding process was adjusted to reduce the eccentricity amounts. Note that the conditions for smaller eccentricity amounts were explored by improving the reproducibility of the eccentricity amounts by forming a stamper also in consideration of temperature management and the like.

### EXAMPLE

### Binary Based

TABLE 1
Example (binary based)

| | |
|---|---|
| Reflecting film | Organic |

| | Additive | Additive element | dye |
|---|---|---|---|
| Example | element | amount at. % | material |
| 1 | Au | 0.05, 1, 2, 5 | \textcircled{1}, \textcircled{2}, \textcircled{3} |
| 2 | Bi | 0.05, 1, 2, 5 | \textcircled{1}, \textcircled{2}, \textcircled{3} |
| 3 | Ga | 0.05, 1, 2, 5 | \textcircled{1}, \textcircled{2}, \textcircled{3} |
| 4 | Mg | 0.05, 1, 2, 5 | \textcircled{1}, \textcircled{2}, \textcircled{3} |
| 5 | N | 0.05, 1, 2, 5 | \textcircled{1}, \textcircled{2}, \textcircled{3} |
| 6 | Nd | 0.05, 1, 2, 5 | \textcircled{1}, \textcircled{2}, \textcircled{3} |
| 7 | Pd | 0.05, 1, 2, 5 | \textcircled{1}, \textcircled{2}, \textcircled{3} |
| 8 | Zr | 0.05, 1, 2, 5 | \textcircled{1}, \textcircled{2}, \textcircled{3} |

### EXAMPLE

### Ternary Based

TABLE 2
Example (ternary based)

| | |
|---|---|
| Reflecting film | Organic |

| | Additive | Additive element | dye |
|---|---|---|---|
| Example | element | amount at. % | material |
| 9 | AgAuBi | 0.05, 1, 2, 5 | \textcircled{1}, \textcircled{2}, \textcircled{3} |
| 10 | AgBiGa | 0.05, 1, 2, 5 | \textcircled{1}, \textcircled{2}, \textcircled{3} |
| 11 | AgAuMg | 0.05, 1, 2, 5 | \textcircled{1}, \textcircled{2}, \textcircled{3} |
| 12 | AgBiMg | 0.05, 1, 2, 5 | \textcircled{1}, \textcircled{2}, \textcircled{3} |
| 13 | AgBiN | 0.05, 1, 2, 5 | \textcircled{1}, \textcircled{2}, \textcircled{3} |
| 14 | AgBiZr | 0.05, 1, 2, 5 | \textcircled{1}, \textcircled{2}, \textcircled{3} |

Au was used as an additive element of the Ag alloy reflecting layer, the additive amounts used four levels, i.e., 0.05, 1, 2, and 5 at. %, and the organic dye materials of the recording layer used three levels, i.e., (1), (2), and (3). In order to cover all combinations of the additive element amounts and dye materials, all the combinations, i.e., 12 types of recording media were fabricated, and their recording/playback characteristics were evaluated. Table 3 below lists combinations of the compositions of the reflecting layer and the organic dye materials of the recording layer in practice.

Combination of reflecting layer material (binary based) and composition, and organic dye material of recording layer

TABLE 3
Combination of reflecting film material (binary based) and composition,
and organic dye material of recording film of Example 1

| | Reflecting film | Organic dye |
|---|---|---|
| | material and | material of |
| Example | composition | recording film |
| 1-1 | Ag_{99.95}Au_{0.05} | \textcircled{1} |
| 1-2 | Ag_{99.95}Au_{0.05} | \textcircled{2} |
| 1-3 | Ag_{99.95}Au_{0.05} | \textcircled{3} |
| 1-4 | Ag_{99.0}Au_{1.0} | \textcircled{1} |
| 1-5 | Ag_{99.0}Au_{1.0} | \textcircled{2} |
| 1-6 | Ag_{99.0}Au_{1.0} | \textcircled{3} |
| 1-7 | Ag_{98.0}Au_{2.0} | \textcircled{1} |
| 1-8 | Ag_{98.0}Au_{2.0} | \textcircled{2} |
| 1-9 | Ag_{98.0}Au_{2.0} | \textcircled{3} |
| 1-10 | Ag_{95.0}Au_{5.0} | \textcircled{1} |
| 1-11 | Ag_{95.0}Au_{5.0} | \textcircled{2} |
| 1-12 | Ag_{95.0}Au_{5.0} | \textcircled{3} |

Upon evaluating the characteristics (a) to (d) of the fabricated recording media, the results shown in Table 4 were obtained.

Evaluation Results (binary based) of Example

TABLE 4
Evaluation results of Example 1 (binary based)

| | | | | | | Eccentricity |
|---|---|---|---|---|---|---|
| Example | SbER | PRSNR | Mod. | R[%] | RS. | amount [μm] |
| 1-1 | 2.0 × 10⁻⁶ | 21.4 | 0.5 | 5.8 | One million times or more | 40-70 |
| 1-2 | 1.0 × 10⁻⁶ | 24.2 | 0.5 | 5.7 | One million times or more | 15-35 |
| 1-3 | 1.3 × 10⁻⁶ | 23.6 | 0.5 | 5.4 | One million times or more | 10-30 |
| 1-4 | 1.1 × 10⁻⁶ | 25.2 | 0.5 | 5.5 | One million times or more | 20-40 |
| 1-5 | 1.1 × 10⁻⁶ | 24.2 | 0.5 | 5.4 | One million times or more | 15-35 |
| 1-6 | 1.2 × 10⁻⁶ | 24.4 | 0.5 | 5.2 | One million times or more | 15-45 |
| 1-7 | 1.9 × 10⁻⁶ | 22.9 | 0.49 | 5.8 | One million times or more | 15-55 |
| 1-8 | 1.9 × 10⁻⁶ | 23.9 | 0.49 | 5.5 | One million times or more | 15-30 |
| 1-9 | 2.1 × 10⁻⁶ | 24.4 | 0.49 | 5.4 | One million times or more | 15-35 |
| 1-10 | 2.3 × 10⁻⁶ | 22.1 | 0.48 | 5.4 | One million times or more | 10-55 |
| 1-11 | 2.2 × 10⁻⁶ | 23.5 | 0.48 | 5.5 | One million times or more | 10-35 |
| 1-12 | 2.4 × 10⁻⁶ | 22.7 | 0.48 | 5.7 | One million times or more | 10-45 |

Mod.: modulation, RS.: read stability, and R: reflectance

As can be seen from these results, the respective recording media achieved, as target values, the SbER of 5.0×10⁻⁵ or less, the PRSNR of 15.0 or more, the modulation of 0.4 or more, the reflectance of 4% or higher, and the read stability of one million times or more. Therefore, “good” characteristics were obtained for the respective recording media.

Bi was used as an additive element of the Ag alloy reflecting layer, the additive amounts used four levels, i.e., 0.05, 1, 2, and 5 at. %, and the organic dye materials of the recording layer used three levels, i.e., (1), (2), and (3). As in Example 1, all the combinations, i.e., 12 types of recording media were fabricated, and their recording/playback characteristics were evaluated. Media having Bi additive amounts of 0.05, 1, 2, and 5 at. % were fabricated, and were evaluated. Table 5 below lists combinations of the compositions of the reflecting layer and the organic dye materials of the recording layer in practice.

TABLE 5
Combination of reflecting film material and composition, and organic
dye material of recording film of Example (binary based)

| | Reflecting film | Organic dye |
|---|---|---|
| | material and | material of |
| Example | composition | recording film |
| 2-1 | Ag_{99.95}Bi_{0.05} | \textcircled{1} |
| 2-2 | Ag_{99.95}Bi_{0.05} | \textcircled{2} |
| 2-3 | Ag_{99.95}Bi_{0.05} | \textcircled{3} |
| 2-4 | Ag_{99.0}Bi_{1.O} | \textcircled{1} |
| 2-5 | Ag_{99.0}Bi_{1.O} | \textcircled{2} |
| 2-6 | Ag_{99.0}Bi_{1.O} | \textcircled{3} |
| 2-7 | Ag_{98.0}Bi_{2.0} | \textcircled{1} |
| 2-8 | Ag_{98.0}Bi_{2.0} | \textcircled{2} |
| 2-9 | Ag_{98.0}Bi_{2.0} | \textcircled{3} |
| 2-10 | Ag_{95.0}Bi_{5.0} | \textcircled{1} |
| 2-11 | Ag_{95.0}Bi_{5.0} | \textcircled{2} |
| 2-12 | Ag_{95.0}Bi_{5.0} | \textcircled{3} |

Upon evaluating the characteristics (a) to (d) of the fabricated recording media, the results shown in Table 6 were obtained.

Evaluation Results (binary based) of Example

TABLE 6
Evaluation results of Example (binary based)

| | | | | | | Eccentricity |
|---|---|---|---|---|---|---|
| Example | SbER | PRSNR | Mod. | R[%] | RS. | amount [μm] |
| 2-1 | 7.4 × 10⁻⁸ | 28.2 | 0.5 | 5.6 | One million times or more | 15-55 |
| 2-2 | 1.6 × 10⁻⁷ | 27.6 | 0.5 | 5.7 | One million times or more | 15-30 |
| 2-3 | 8.0 × 10⁻⁸ | 25.4 | 0.5 | 5.8 | One million times or more | 15-35 |
| 2-4 | 1.2 × 10⁻⁷ | 20.9 | 0.48 | 5.7 | One million times or more | 10-55 |
| 2-5 | 3.2 × 10⁻⁷ | 24.7 | 0.48 | 5.8 | One million times or more | 15-35 |
| 2-6 | 1.6 × 10⁻⁷ | 31.4 | 0.5 | 5.5 | One million times or more | 10-30 |
| 2-7 | 1.6 × 10⁻⁷ | 29.9 | 0.49 | 5.4 | One million times or more | 20-40 |
| 2-8 | 1.8 × 10⁻⁶ | 29.2 | 0.49 | 5.2 | One million times or more | 15-35 |
| 2-9 | 3.9 × 10⁻⁹ | 28.2 | 0.49 | 5.4 | One million times or more | 10-55 |
| 2-10 | 2.2 × 10⁻⁶ | 24.1 | 0.48 | 5.4 | One million times or more | 10-35 |
| 2-11 | 2.1 × 10⁻⁶ | 26.5 | 0.48 | 5.3 | One million times or more | 10-45 |

As can be seen from these results, the respective recording media achieved, as target values, the SbER of 5.0×10⁻⁵ or less, the PRSNR of 15.0 or more, the modulation of 0.4 or more, the reflectance of 4% or higher for both L0 and L1 of single-sided, double-layer media, and the read stability of one million times or more. “Good” characteristics were obtained for the respective recording media.

As for other additive elements, the characteristics that met the target values were obtained, and “good” characteristics were obtained for the respective recording media.

By setting the eccentricity amounts of the tracks of the respective information layers of the fabricated media to be 70 μm or less, the characteristics could be improved. By setting the eccentricity amounts of the tracks of the respective information layers of the fabricated media to be 40 μm or less, the characteristics could be further improved. The respective media exhibited satisfactory characteristics. The improved tracking stability largely contributes to such improvements. This also influences the frequency of occurrence of out of tracking during the experiment. When the eccentricity amounts of the tracks are 70 μm or more, out of tracking have occurred several times or more during mere about 10 measurements, and it is difficult to attain stable measurements. The probability of such errors lowers with decreasing eccentricity amounts of the tracks. When the eccentricity amounts of the tracks are 40 μm or less, most of media can stably undergo experiments at higher linear velocities. This fact exerts very large effects in actual recording and playback apparatuses.

### EXAMPLE 2

FIG. 8 shows an optical recording medium according to one embodiment of the present invention.

This medium will be described in detail below. As substrates, those which were compatible to both the aforementioned methods (a) and (b), i.e., the land-groove recording method and groove recording method were used. That is, in the method (a), a 0.59-mm thick polycarbonate (PC) substrate formed by injection molding were used. Since the substrate on which grooves were formed at a groove pitch of 0.68 μm was used, this corresponds to a track pitch=0.34 μm upon recording on both the lands (L) and grooves (G). In the method (b), a 0.59-mm thick polycarbonate (PC) substrate formed by injection molding were also used, and a groove pitch was set to be 0.4 μm. An information layer L0 which was formed on the surface formed with the grooves of each of these PC substrate on the side closer to the light incidence side was prepared by forming ZnS:SiO₂, an interface layer, a recording layer, an interface layer, ZnS:SiO₂, an Ag alloy, and ZnS:SiO₂ in turn. On the other hand, an information layer L1 formed on the side farther from the light incidence side using a sputtering apparatus was prepared by forming an Ag alloy, ZnS:SiO₂, an interface layer, a recording film layer, an interface layer, and ZnS:SiO₂ in turn from the surface on the PC substrate. The sputtering apparatus used is a so-called cluster type sputtering film formation apparatus which forms respective layers by sputtering in different film formation chambers. The cluster type sputtering film formation apparatus comprises a load lock chamber which loads a substrate, a convey chamber, and a process chamber which forms respective layers.

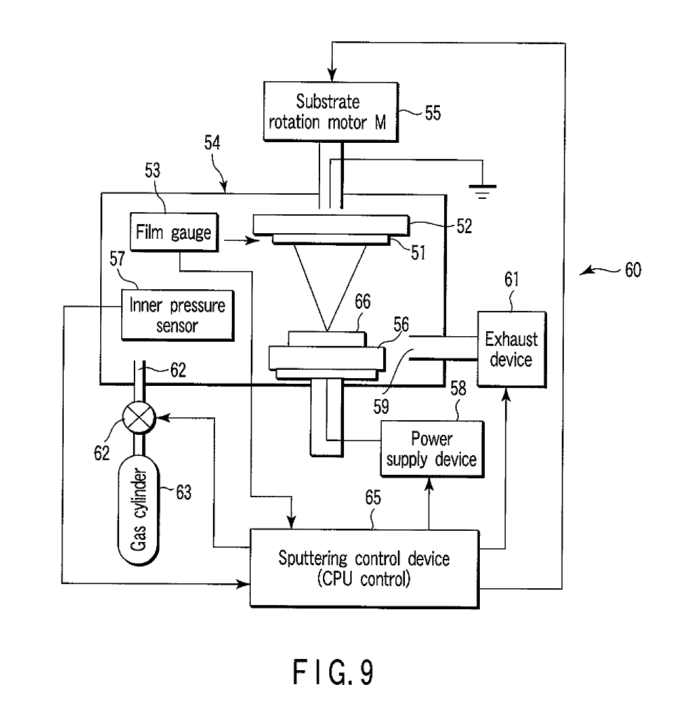

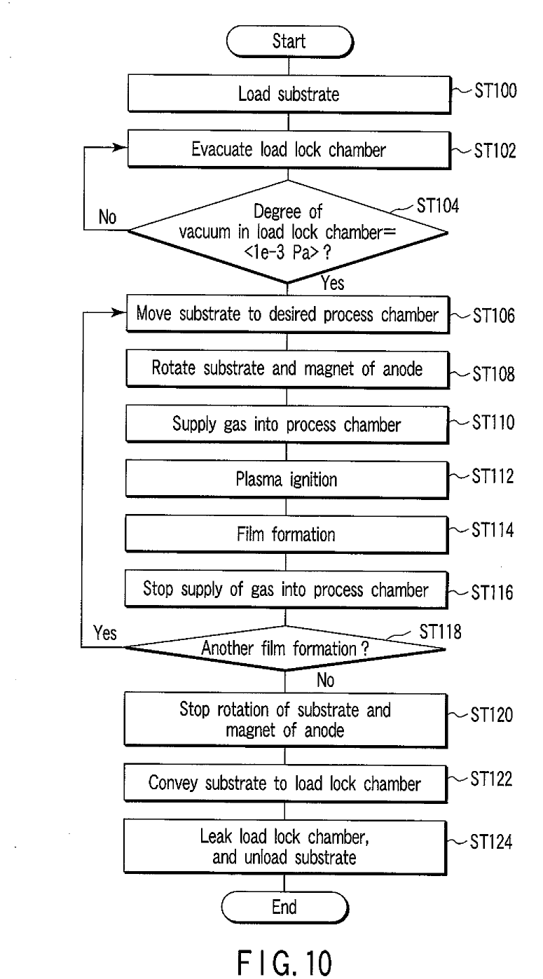

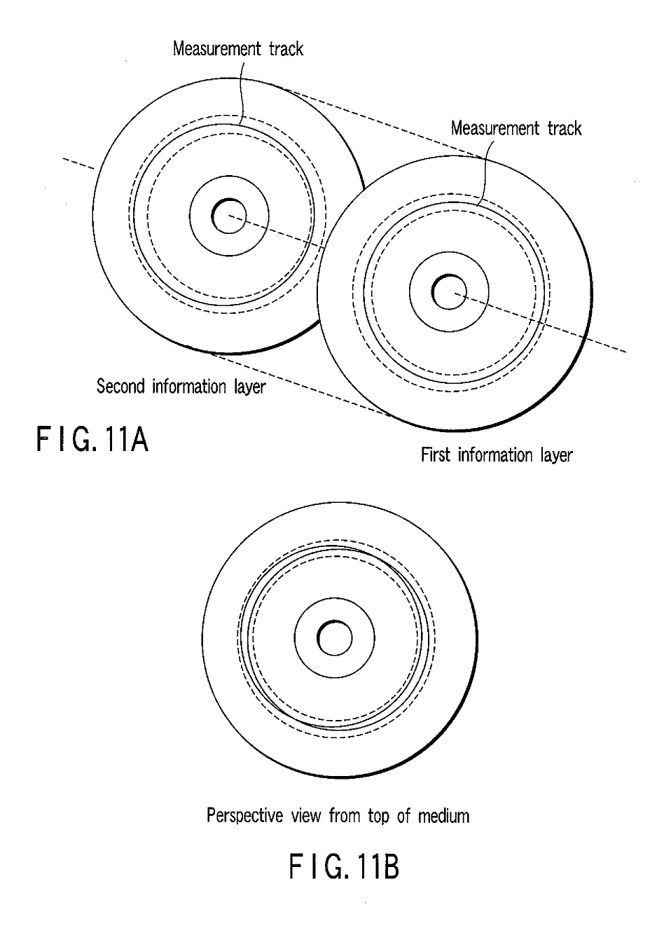

FIG. 9 is a block diagram showing the arrangement of one process chamber. A process chamber 60 is comprised of a device 61 for evacuating the chamber, a vacuum gauge 64, a pressure sensor 57, a film gauge 53, a sputtering target 66 as a material which is to undergo film formation, a loaded substrate 59, and the like. A rare gas of Ar and the like is mainly used as a sputter gas, and an oxygen or nitrogen gas, or like is used as needed. A discharge mode upon sputtering uses an RF power supply, DC power supply, and the like depending on materials which are undergo film formation, film thicknesses to be obtained, and the like. The process procedure in film formation is as shown in FIG. 10.

When a recording film layer was made up of Ge, Sb, and Te, and its composition was expressed by GeₓSb_{y}Te_{z} (for x+y+z=100), the recording film layer used a composition selected from those bounded by x=55 and z=45, x=45 and z=55, x=10, y=28, and z=42, and x=10, y=36, and z=54 on a GeSbTe ternary phase diagram. When the recording film was made up of Ge, Sb, Te, and Bi or Sn, and a composition obtained by partially substituting the GeSbTe composition by Bi and/or In and/or Sn was given by (Ge(1-w)Snw)x(Sb(1-v)(Bi(1-u)Inu)v)yTez (for x+y+z=100), the recording film layer used a composition selected from GeSnSbTe, GeSnSbTeIn, GeSbTeIn, GeSbTeBiIn, GeSbSnTeBiIn, GeSbTeBi, GeSnSbTeBi, and GeSnSbTeBiIn in which w, v, and u satisfied 0≦w≦0.5, 0≦v≦0.7, and 0≦u≦1.0. Furthermore, when the recording film layer was made up of Ge, Bi, and Te, and its composition GeₓBi_{y}Te_{z} (for x+y+z=100), the recording film layer used a composition selected from those bounded by x=55 and z=45, x=45 and z=55, x=10, y=28, and z=42, and x=10, y=36, and z=54 on a GeBiTe ternary phase diagram. Many compositions were examined, and Table 8 shows an example of such compositions. Note that the film thickness of the recording layer was set to be 10 nm or less.

The compositions of the interface layer material and recording layer were selected from Tables 7 and 8.

TABLE 7
Interface layer used

| No. | Interface layer |
|---|---|
| 1 | GeN |
| 2 | GeCrN |
| 3 | ZrO2 + Y2O3 |
| 4 | ZrO2 + Y2O3 + Cr2O3 |
| 5 | ZrO2 + Y2O3 + SiO2 + Cr2O3 |
| 6 | ZrSiO4 + Cr2O3 |
| 7 | HfO2 |
| 8 | (ZrO₂₋ₓNₓ)_{1-y}((Y₂O₃)_{1-z}(Nb₂O₅)_{z})_{y} |
| 9 | HfO₂₋ₓNₓ (0.1 ≦ x ≦ 0.2) |
| 10 | Cr2O3 |
| 11 | ZnO + Ta2O5 |
| 12 | ZnO + Ta2O3 + In2O3 |
| 13 | SnO2 + Sb2O3 |
| 14 | SnO2 + Ta2O5 |
| 15 | SnO2 + Nb2O5 |

Table 8 Composition of Recording Layer

TABLE 8
Composition of recording film

| No. | Composition of recording film |
|---|---|
| 1 | Ge10Sb2Tel3 |
| 2 | Ge4Sb2Te7 |
| 3 | Ge8Sb2Te13Bi2 |
| 4 | Ge3Sb2Te7Bi |
| 5 | Ge6Sb2Tel3Sn4 |
| 6 | Ge3Sb2Te7Sn |
| 7 | Ge10Bi2Tel3 |
| 8 | Ge2.9BiTe4.4 |
| 9 | Ge11.25BiTel2.75 |
| 10 | Ge10Sb1.5In0.5Te13 |
| 11 | Ge10Sb1.5In0.5Te13 |
| 12 | Ge4Sb1.5In0.5Te7 |
| 13 | Ge2.9Bi0.75In0.25Te4.4 |

A composition range defined by 0<x≦0.2, 0<y≦0.1, and 0≦z≦1 is preferable for (ZrO₂₋ₓNₓ)_{1-y}(Y₂O₃)_{1-z}(Nb₂O₅)_{z})_{y}, and that defined by 0.1≦x≦0.2 is preferable for HfO₂₋ₓNₓ.

In a medium using GeN on two sides, it was more preferable to use a combination of different composition ratios, as shown in Table 9: for example, Ge₅₄N₄₆ and Ge₄₇N₅₃, and the like.

Table 9 Composition ratio (at. %) of GeN used in Examples

TABLE 9
Composition ratio of GeN used in Example [at. %]

| No. | Ge | N |
|---|---|---|
| 1 | 54 | 46 |
| 2 | 52 | 48 |
| 3 | 50 | 50 |
| 4 | 48 | 52 |
| 5 | 47 | 53 |

The interface layer used GeN on the two sides, i.e., the light incidence side and the reflecting layer side. A ZnS:SiO₂ layer was formed using a target prepared by mixing SiO₂ in ZnS. A sputter apparatus used is a so-called cluster type sputter film formation apparatus which forms respective layers by sputtering in different film formation chambers. After fabrication of respective media, their reflectances and transmittances are measured by a spectrophotometer. The media were fabricated to have the eccentricity amounts of 70 μm or less of the tracks of the information layers.

Table 10 Example (Disc Characteristic Measurements)

TABLE 10
Example (disc characteristic measurement)

| | | | | | Eccentricity |
|---|---|---|---|---|---|
| Example | CNR[dB] | ER[dB] | SbER | PRSNR | amount [μm] |
| Example 1 | 52.9 | 33.8 | 1.8 × 10⁻⁶ | 21.4 | 15-30 |
| Example 2 | 52.6 | 33.1 | 1.5 × 10⁻⁶ | 25.2 | 15-35 |
| Example 3 | 52.8 | 33.1 | 1.6 × 10⁻⁶ | 24.2 | 10-55 |
| Example 4 | 53.7 | 34.8 | 1.9 × 10⁻⁶ | 25.2 | 20-40 |
| Example 5 | 53.6 | 34.9 | 2.2 × 10⁻⁶ | 24.2 | 15-35 |
| Example 6 | 53.7 | 34.8 | 1.8 × 10⁻⁶ | 24.4 | 10-55 |
| Example 7 | 52.0 | 30.9 | 2.6 × 10⁻⁶ | 22.9 | 15-55 |
| Example 8 | 53.2 | 34.6 | 1.9 × 10⁻⁶ | 23.9 | 10-30 |
| Example 9 | 53.6 | 34.7 | 2.2 × 10⁻⁶ | 22.9 | 20-40 |
| Example 10 | 51.9 | 31.3 | 2.6 × 10⁻⁶ | 23.9 | 15-35 |
| Example 11 | 53.8 | 34.8 | 2.0 × 10⁻⁶ | 23.5 | 15-45 |
| Example 12 | 53.7 | 34.9 | 1.9 × 10⁻⁶ | 22.7 | 15-35 |
| Example 13 | 53.1 | 34.9 | 1.4 × 10⁻⁶ | 23.6 | 10-55 |
| Example 14 | 51.9 | 34.6 | 1.5 × 10⁻⁶ | 25.2 | 15-55 |

As can be seen from these results, the respective recording media achieved, as target values, the SbER of 5.0×10⁻⁵ or less and the PRSNR of 15.0 or more. “Good” characteristics were obtained for the respective recording media.

By setting the eccentricity amounts of the tracks of the respective information layers of the fabricated media to be 70 μm or less, the characteristics could be improved. By setting the eccentricity amounts of the tracks of the respective information layers of the fabricated media to be 40 μm or less, the characteristics could be further improved. The respective media exhibited satisfactory characteristics. The improved tracking stability largely contributes to such improvements.

### EXAMPLE 3

As read-only media, a reflecting layer was formed on a transparent substrate embossed with information, and that structure was adhered to another substrate using a UV-curing resin, thus fabricating single-sided, dual-, triple-, and quadruple-layer media, The media were fabricated to have the eccentricity amounts of 70 μm or less of the tracks of the information layers. Read-only media originally have satisfactory base characteristics. Hence, as evaluations, situations that readily caused errors were created by putting many fingerprints and scratches on the substrate surface on the light incident side, and whether or not to stably play back information was also confirmed, in addition to evaluations of the SbER and PRSNR.

Table 11 Characteristics Measured in Situations that Readily Cause Errors by Putting Many Fingerprints and Scratches on Substrate Surface on Light Incidence Side

TABLE 11
Characteristics measured in situations that readily cause error by
putting fingerprints on substrate surface on liqht incident side

| | | | Eccentricity |
|---|---|---|---|
| Example | SbER | PRSNR | amount [μm] |
| Single-sided, | 1.1 × 10⁻¹⁰ | 44.4 | 15-70 |
| double-layer | | | |
| medium | | | |
| Single-sided, | 1.2 × 10⁻¹⁰ | 42.2 | 10-30 |
| triple-layer | | | |
| medium | | | |
| Single-sided, | 1.2 × 10⁻¹⁰ | 41.6 | 15-30 |
| quadruple- | | | |
| layer medium | | | |

The respective media exhibited satisfactory playback characteristics, and the stability could be improved compared to the prior art in situations that readily caused errors. The improved tracking stability largely contributes to such improvement.

### EXAMPLE 4

A method of measuring the eccentricity amounts of the tracks of the information layers in Examples 1 to 3 or Examples to be described hereinafter will be described. FIG. 5 is a block diagram of a measurement system. A measurement system comprises an illumination system that does not include any light components of wavelengths of 620 nm or less, a CCD camera, an image processing apparatus which includes a track extraction mechanism, and an arithmetic and control apparatus. Using this measurement system, the eccentricity amounts of respective tracks could be measured for several seconds, i.e., during the manufacture time period per storage medium. The image processing apparatus with the track extraction mechanism, arithmetic and control apparatus, and the like can be implemented when a so-called personal computer or the like executes predetermined procedures. The capability of an image sensing device such as the CCD camera or the like differs depending on media, and also depends on the accuracy of a lens system and clamp, the stage moving accuracy, and the like. Measurement can be made for media other than those using an organic dye sensitized at a wavelength of 620 nm or less without limiting the wavelength of the illumination system. However, the wavelength of the illumination system preferably fall within the range from 550 nm (inclusive) to 780 nm (inclusive) in consideration of the sensitivity of the CCD and image processing apparatus. In order to implement an apparatus which performs inspection independently of the types of media, an illumination system that does not include any light components of wavelengths of 620 nm or less is preferably used.

### EXAMPLE 5

A method of measuring the eccentricity amounts of the tracks of the information layers in Examples 1 to 3 or Examples to be described hereinafter will be described. FIG. 6 is a block diagram of a measurement system. A measurement system comprises a laser irradiation device, reflectance distribution measurement mechanism, image processing apparatus with a track extraction mechanism, and arithmetic and control apparatus. The laser irradiation device mainly uses an LD but may use an LED or the like instead. The reflectance distribution measurement mechanism comprises a photodetector, voltage/current measurement device, and the like. The image processing apparatus with the track extraction mechanism, arithmetic and control apparatus, and the like can be implemented when a so-called personal computer (PC) or the like executes predetermined procedures. By focusing a laser beam on the information layers to allow the camera to sense an image, the eccentricity amounts of tracks are measured and evaluated. Using this measurement system, the eccentricity amounts of respective tracks could be measured for several seconds, i.e., during the manufacture time period per storage medium. Since an evaluation system using the laser irradiation device can narrow down the beam spot size to a very small size, measurement with higher accuracy can be achieved. The accuracy on the submicron order can be achieved although it depends on the measurement time.

### EXAMPLE 6

As the method of measuring the eccentricity amounts of the tracks of the information layers described in Examples 1 and 2, a method of measuring the eccentricity amounts of the tracks using tracks which have undergone trial recording for the purpose of learning, optimization, or the like of write strategy is preferable. Since different write strategies required to write information on media are required depending on media, they must be optimized based on learning by actual trial recording. In case of a single-sided, double-layer medium, respective information layers need undergo trial recording to learn and optimize the write strategy. FIGS. 11A and 11B are views showing the concept of measurement.

FIG. 11A shows first and second information layers.

FIG. 11B is a top view of the first and second information layers which overlap each other.

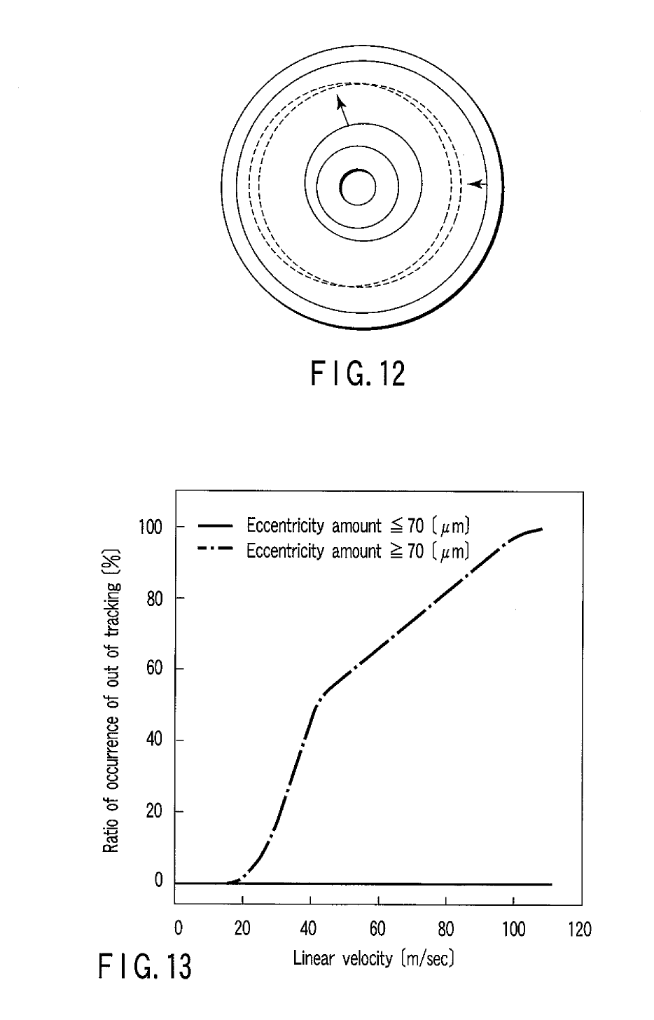

Note that eccentricity amounts at specific radial positions can be estimated even for a medium in which information layers have different radius of the trial recording positions (FIG. 12).

### EXAMPLE 7

As a substrate, a 0.6-mm thick polycarbonate (PC) substrate fabricated by injection molding was used. Grooves are formed on the substrate at a track pitch of 0.74 μm as in the current DVD. A dye is applied onto the substrate by spin-coating, a reflecting layer is formed on the dye film by sputtering, and a 0.6-mm thick PC substrate is adhered onto the resultant structure using a UV-curing resin, thus fabricating a medium. That is, the same substrates and the like as in a write-once DVD were used to form a medium using the organic dye and reflecting layer, and were adhered to fabricate a medium capable of information recording and playback on respective information layers using light with a wavelength of red (λ=650 nm) as in DVD. The media were fabricated to have the eccentricity amounts of 70 μm or less of the tracks of the information layers. As evaluations, jitters were measured. The evaluations were conducted at linear velocities of 30, 40, 70, 100, and 110 m/sec.

As shown in FIG. 13, when the linear velocity was less than 30 m/sec, out of tracking rarely occurred even when the eccentricity amount was 70 μm or more. However, when the linear velocity exceeded 30 m/sec, such phenomena began to appear. When the linear velocity exceeded 40 m/sec, the frequency of occurrence of out of tracking considerably increased, and it became impossible to apply stable tracking at linear velocities of 40 m/sec or higher. On the other hand, when the eccentricity amount was set to be 70 μm or more, the frequency of occurrence of out of tracking considerably increased, and it became impossible to apply stable tracking independently of linear velocities. When the eccentricity amount was set to be 70 μm or less, stable tracking could be applied independently of linear velocities, and stable evaluation could be made up to a linear velocity of 110 m/sec. Note that the linear velocity of about 110 m/sec approximately corresponds to the maximum rotational speed of a mechanical spindle.

Respective media achieved jitter values of 8% or less as the target value. “Good” characteristics were obtained for the respective media. The improved tracking stability largely contributes to these results. Even when the medium was rotated at a linear velocity as very high as 30 m/sec or higher, stable recording and playback could be attained.

### EXAMPLE 8

As a substrate, a 0.6-mm thick polycarbonate (PC) substrate fabricated by injection molding was used. Grooves are formed on the substrate at a track pitch of 0.74 μm as in the current DVD. A phase change recording layer material, protection layer, interface layer, and reflecting layer are formed on the substrate by sputtering, and a 0.6-mm thick PC substrate is adhered onto the resultant structure using a UV-curing resin, thus fabricating a medium. That is, the same substrates and the like as in a rewritable DVD were used to form a medium using the phase change recording layer material, protection layer, interface layer, and reflecting layer, and were adhered to fabricate a medium capable of information recording and playback on respective information layers using light with a wavelength of red as in DVD. The media were fabricated to have the eccentricity amounts of 70 μm or less of the tracks of the information layers. As evaluations, jitters were measured. The evaluations were conducted at linear velocities of 30, 40, 70, 100, and 110 m/sec.

As in FIG. 13 of Example 7, when the linear velocity was less than 30 m/sec, out of tracking rarely occurred even when the eccentricity amount was 70 μm or more. However, when the linear velocity exceeded 30 m/sec, such phenomena began to appear. When the linear velocity exceeded 40 m/sec, the frequency of occurrence of out of tracking considerably increased, and it became impossible to apply stable tracking at linear velocities of 40 m/sec or higher. On the other hand, when the eccentricity amount was set to be 70 μm or less, stable tracking could be applied independently of linear velocities, and stable evaluation could be made up to a linear velocity of 110 m/sec. Especially, since a rewritable medium had a lower reflectance than read-only and write-once media, the effect of the present invention further stood out.

Respective media achieved jitter values of 8% or less as the target value. “Good” characteristics were obtained for the respective media. The improved tracking stability largely contributes to these results. Even when the medium was rotated at a linear velocity as very high as 30 m/sec or higher, stable recording and playback could be attained. Especially, since a rewritable medium had a lower reflectance than read-only and write-once media, the effect of the present invention further stood out.

### EXAMPLE 9

As a read-only medium, a reflecting layer was formed on a transparent substrate embossed with information, and that structure was adhered to another substrate using a UV-curing resin, thus fabricating a so-called single-sided, double-layer twin disc (a medium using a wavelength of blue-violet and that (DVD) using a wavelength of red). Media were fabricated to have the eccentricity amounts of 70 μm or less and 40 μm or less of the tracks of the information layers. As evaluations, the SbER and PRSNR of the media using the wavelength of blue-violet were measured, and the jitters of the DVDs were measured. The media were fabricated to have the eccentricity amounts of 40 μm or less of the tracks of the information layers.

The respective media achieved, as target values, the SbER of 5.0×10⁻⁵ or less, the PRSNR of 15.0 or more, and the jitter values of 8% or less. “Good” characteristics were obtained for the respective media.

### EXAMPLE 10

The same medium as in Example 1 was fabricated except that one structure used the same substrate, organic dye, and reflecting layer as in a write-once DVD, and that structure was adhered to another substrate to fabricate a medium capable of information recording and playback on respective information layers using light beams with a plurality of wavelengths. Media were fabricated to have the eccentricity amounts of 70 μm or less and 40 μm or less of the tracks of the information layers. As evaluations, the SbER and PRSNR of the media using the wavelength of blue-violet were measured, and the jitters of the DVDs were measured. The media were fabricated to have the eccentricity amounts of 40 μm or less of the tracks of the information layers.

The respective media achieved, as target values, the SbER of 5.0×10⁻⁵ or less, the PRSNR of 15.0 or more, and the jitter values of 8% or less. “Good” characteristics were obtained for the respective media.

### EXAMPLE 11

As the method of measuring the eccentricity amounts of the tracks of the information recording/playback media described in Examples 1 to 3 and 7 to 10, when an information recording/playback medium characterized by different radial positions where the respective information layers are formed, as shown in FIG. 12, is used, the measurement accuracy can be improved, and the measurement time can be shortened. Evaluation can be done for several seconds per disc.

### EXAMPLE 12

As the method of measuring the eccentricity amounts of the tracks of the information recording/playback media described in Examples 1 to 3 and 7 to 10, when an information recording/playback medium characterized by different radial positions where the respective information layers are formed, as shown in FIG. 13, is used, the measurement accuracy can be improved, and the measurement time can be shortened. Evaluation can be done for several seconds per disc.

### COMPARATIVE EXAMPLE 1

The same media as in Example 1 were fabricated, and the eccentricity amounts of the tracks of the information layers of the fabricated media were not controlled to set 71 μm or more and, more specifically, 71, 72, and 80 μm. The fabricated media are the same as those of Example 1, but those which have reached evaluation are the same media as examples 1-1, 1-2, 1-3, and the like except for the eccentricity amounts.

When the eccentricity amounts were 71 μm or more, tracking became unstable, thus disturbing stable measurements. When the eccentricity amounts were 71 μm or more, the probability of out of tracking during measurements was raised. During the measurements of above Examples, out of tracking rarely occurred. However, when the eccentricity amounts were 71 μm or more, out of tracking occurred four times during 10 measurements of a certain experiment. When the eccentricity amounts were 72 μm or more, out of tracking occurred seven times during 10 measurements. When the eccentricity amounts were 80 μm, tracking could not be applied to disturb measurements themselves. As the evaluation results of the two discs having the eccentricity amounts of 71 and 72 μm, any of the SbER, PRSNR, and the like could not obtain satisfactory characteristics. Therefore, good media could not be obtained.

The detailed arrangement of an information recording/playback apparatus and a disc (information recording medium) to be used when the respective methods are used in the embodiment will be described below. A case will be described wherein the land-groove recording method as the method (a) is used.

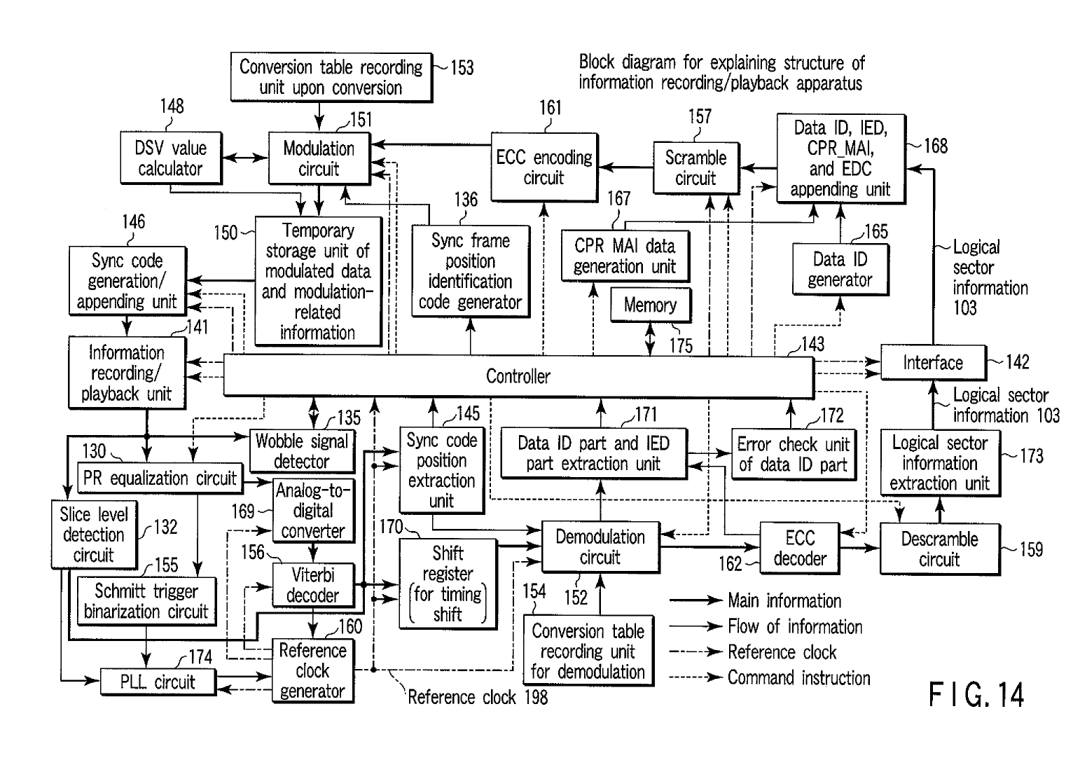

FIG. 14 is a block diagram for explaining the arrangement of an embodiment of an information recording/playback apparatus. Referring to FIG. 14, blocks above a controller 143 mainly represent an information recording control system on an information storage medium. An embodiment of an information playback apparatus corresponds to blocks excluding the information recording control system in FIG. 14. In FIG. 14, the bold solid line arrows indicate the flows of main information which means a playback signal or recording signal, the thin solid line arrows indicate those of information, one-dashed chain line arrows indicate reference clock lines, and thin broken line arrows indicate command instruction directions.

An information recording/playback unit 141 shown in FIG. 14 includes an optical head (not shown). This embodiment uses a PRML (Partial Response Maximum Likelihood) method in information playback to attain high-density information storage media. As a result of various experiments, when PR(1, 2, 2, 2, 1) is adopted as a PR class to be used, it is found that the linear density can be increased and reliability of a playback signal (demodulation reliability upon occurrence of servo correction errors such as out of focus, out of tracking, and the like) can be improved. Hence, this embodiment adopts PR(1, 2, 2, 2, 1). In this embodiment, a channel bit string or train after modulation is recorded on an information storage medium in accordance with a (d, k; m, n) modulation rule (the aforementioned description method means RLL(d, k) of m/n modulation). More specifically, ETM (Eight to Twelve Modulation) for converting 8-bit data to 12 channel bits (m=8, n=12) is adopted as a modulation system, and the condition of RLL (1, 10) in which a minimum value of a run of “0”s is defined as d=1, and a maximum value is defined as k=10 as a runlength limited RLL restriction that imposes a limitation on a “0” runlength in the channel bit train after modulation is set. In this embodiment, a channel bit gap is minimized aiming at the high density of an information storage medium. As a result, for example, when a pattern “101010101010101010101010” which is a repetition of a pattern of d=1 is recorded on the information storage medium, and the recorded data is reproduced by the information recording/playback unit 141, since the data is close to the cutoff frequency of the MTF characteristics of a playback optical system, the signal amplitude of a playback raw signal is almost buried in noise. Therefore, the technique of the PRML (Partial Response Maximum Likelihood) method is used as a method for playing back recording marks or pits, the density of which is increased up to the vicinity of the limit (cutoff frequency) of the MTF characteristics.

That is, a signal played back by the information recording/playback unit 141 undergoes playback waveform correction by a PR equalizer circuit 130. An analog-to-digital converter 169 converts the signal that has passed through the PR equalizer circuit 130 into a digital quantity by sampling it in synchronism with the timing of a reference clock 198 sent from a reference clock generation circuit 160, and a Viterbi decoder 156 applies Viterbi decoding processing to that digital data. The data after the Viterbi decoding processing is processed as the same data as conventional data which is binarized by a slice level. Upon adopting the technique of the PRML method, if the sampling timing of the analog-to-digital converter 169 shifts, the error rate of data after Viterbi decoding rises. Therefore, in order to improve the accuracy of the sampling timing, the information playback apparatus or information recording/playback apparatus of this embodiment especially has an independent sampling timing extraction circuit (a combination of a Schmitt trigger binarizing circuit 155 and PLL circuit 174).

The Schmitt trigger binarizing circuit 155 has a characteristic that provides a specific range (the forward voltage value of a diode in practice) to a slice reference level for binarization, and binarizes a signal only when the signal level exceeds that specific range. Therefore, when the pattern “101010101010101010101010” is input, as described above, since the signal amplitude is very small, switching of binarization does not take place. When “1001001001001001001001” or the like as a pattern coarser than the former is input, since the amplitude of a playback raw signal becomes large, polarity switching of a binary signal takes place in synchronism with the timings of “1”s in the Schmitt trigger binarizing circuit 155. This embodiment adopts an NRZI (Non Return to Zero Invert) method, and each “1” position of the above pattern matches the edge (boundary) of a recording mark or pit.

The PLL circuit 174 detects frequency and phase shifts between the binary signal as the output from the Schmitt trigger binarizing circuit 155 and the reference clock signal 198 sent from the reference clock generation circuit 160, and changes the frequency and phase of its output clock. The reference clock generation circuit 160 applies feedback control to (the frequency an phase of) the reference clock 198 using the output signal from the PLL circuit 174 and decoding characteristic information (more specifically, information of a convergent length (distance to convergence) in a path metric memory (not shown) in the Viterbi decoder 156) so as to attain a low error rate after Viterbi decoding. The reference clock 198 generated by the reference clock generation circuit 160 is used as a reference timing upon processing a playback signal.

A sync code position extraction unit 145 undertakes an extraction role of the start position of output data by detecting the position of a sync code mixed in an output data string of the Viterbi decoder 156. A demodulation circuit 152 demodulates data temporarily stored in a shift register circuit 170 with reference to this start position. In this embodiment, the demodulation circuit 152 demodulates an original bit string with reference to a conversion table recorded in a demodulation conversion table recording unit 154 every 12 channel bits. After that, an ECC decoding circuit 162 applies error correction processing to the signal, which is then descrambled by a descramble circuit 159. Address information is recorded in advance by wobble modulation on a recordable or rewritable information storage medium or write-once information storage medium of this embodiment. A wobble signal detector 135 plays back this address information, i.e., determines the contents of wobble signals, and supplies information required to access a desired location to the controller 143.

The information recording control system above the controller 143 will be described below. When a data ID generation unit 165 generates data ID information in correspondence with the recording position on an information storage medium, and a CPR_MAI data generation unit 167 generates copy control information, a data ID, IED, CPR_MAI, & EDC appending unit 168 appends various kinds of information, i.e., the data ID, IED, CPR_MAI, and EDC to information to be recorded. After the information is scrambled by a scramble circuit 157, an ECC encoding circuit 161 forms ECC blocks, which are converted into a channel bit string by a modulation circuit 151. A sync code generation/appending unit 146 appends a sync code to the channel bit string, and the information recording/playback unit 141 records data on an information storage medium. Upon modulation, a DSV (Digital Sum Value) value calculator 148 sequentially calculates DSV values after modulation, and feeds back them to code conversion upon modulation.

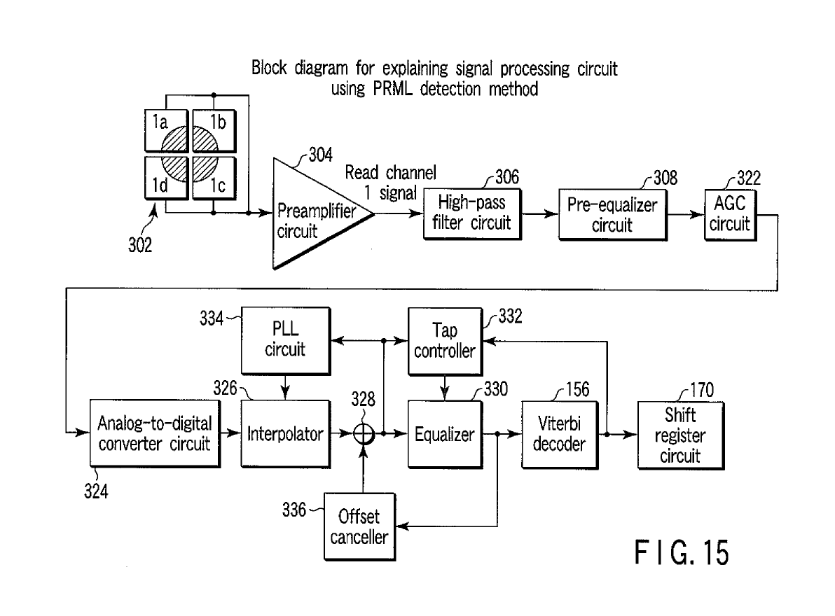

FIG. 15 shows a signal processing circuit which uses the PRML detection method in a data area, data lead-in area, and data lead-out area. A 4-split photodetector 302 in FIG. 15 is fixed in an optical head included in the information recording/playback unit 141 in FIG. 14. A signal as a sum total of detection signals obtained from respective photodetection cells of the 4-split photodetector 302 will be referred to as a read channel 1 signal hereinafter. The detailed structure in the PR equalizer circuit 130 in FIG. 14 comprises circuits from a preamplifier circuit 304 to a tap controller 332, equalizer 330, and offset canceller 336 in FIG. 15. A PLL circuit 334 in FIG. 15 is a part of the PR equalizer circuit 130 in FIG. 15, and means a circuit different from the Schmitt trigger binarizing circuit 155 in FIG. 14. The primary cutoff frequency of a highpass filter circuit 306 in FIG. 15 is set at 1 kHz. A pre-equalizer circuit 308 uses a 7-tap equalizer as in FIG. 3 (since the circuit scale can be minimized and a playback signal can be precisely detected if the 7-tap equalizer is used). The sampling clock frequency of an analog-to-digital converter 324 is set at 72 MHz, and its digital output is an 8-bit output. In the PRML detection method, errors readily occur upon Viterbi decoding under the influence of level variations (DC offsets) of the entire playback signal. In order to remove this influence, the offset canceller 336 cancels offsets using a signal output from the equalizer 330. In the embodiment shown in FIG. 15, the PR equalizer circuit 130 in FIG. 14 executes adaptive equalization processing. For this reason, the tap controller 332 that automatically corrects tap coefficients in the equalizer using the output signal of the Viterbi decoder 156 is used.

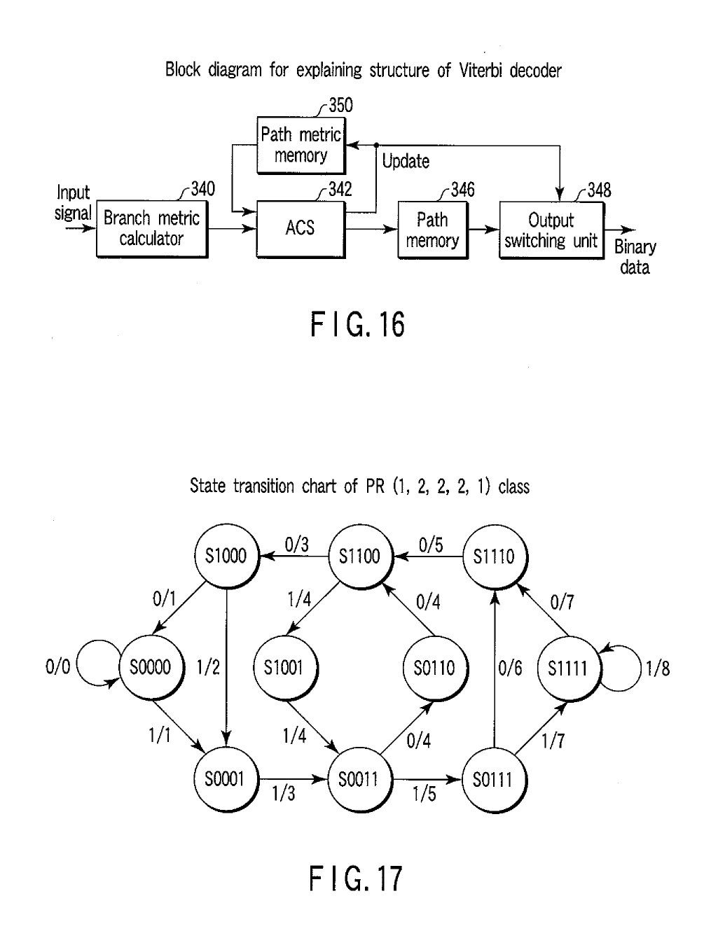

FIG. 16 shows the structure in the Viterbi decoder shown in FIG. 14 or 15. A branch metric calculator 340 calculates branch metrics for all predictable branches with respect to an input signal, and sends the calculated values to an ACS 342. The ACS 342 is a short for Add Compare Select. The ACS 342 calculates path metrics obtained by adding the branch metrics corresponding to respective predictable paths, and transfers the calculation results to a path metric memory 350. At this time, the ACS 342 executes calculation processing also with reference to information in the path metric memory 350. A path memory 346 temporarily stores predictable path (transition) status data and the path metric values calculated by the ACS 342 in correspondence with these paths. An output switching unit 348 compares the path metric values corresponding to the respective paths, and selects a path with a minimum path metric value.

FIG. 17 shows state transition in a PR(1, 2, 2, 2, 1) class in this embodiment. Since the possible state transition in the PR(1, 2, 2, 2, 1) class allows only that shown in FIG. 17, the Viterbi decoder 156 determines possible (predictable) paths upon decoding based on the transition chart in FIG. 17.

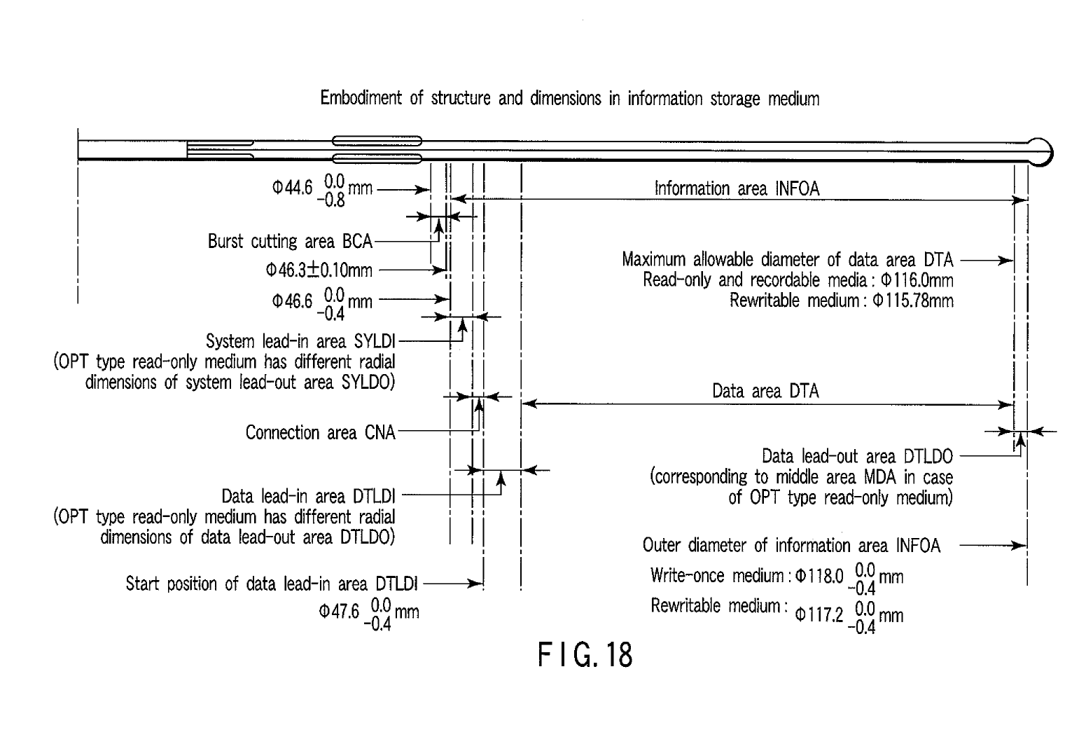

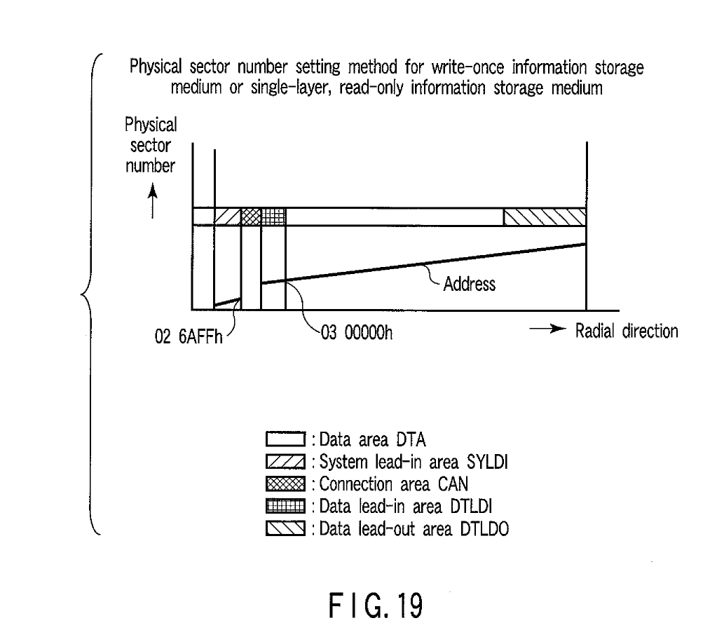

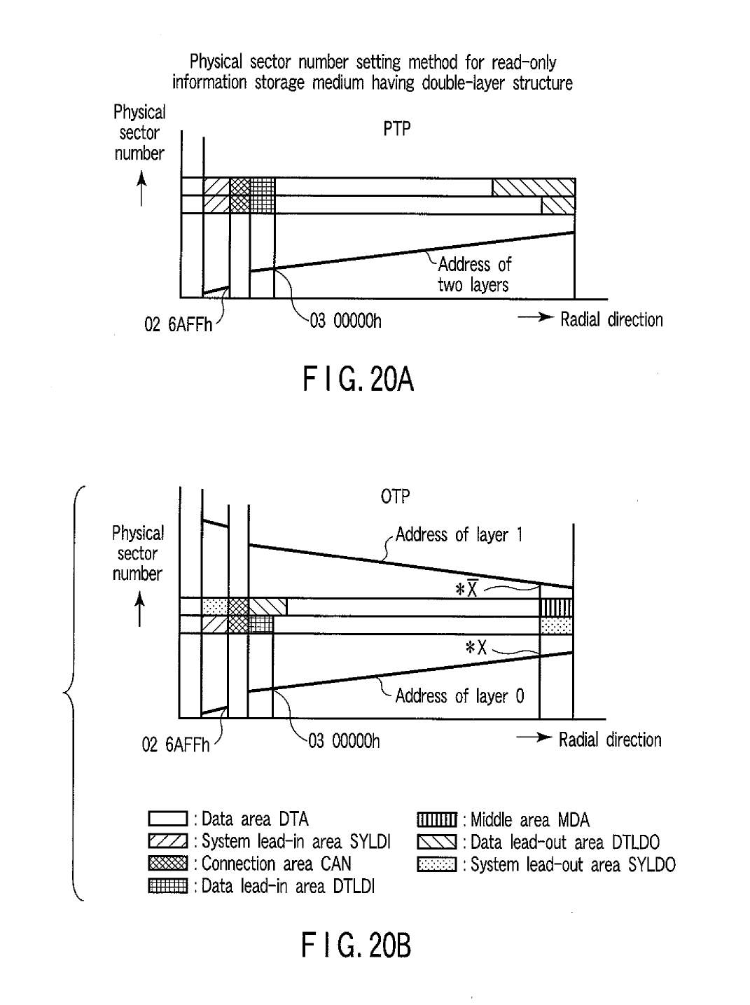

FIG. 18 shows the structure and dimensions of an information storage medium in this embodiment. As embodiments, those of three types of information storage media:

“read-only information storage medium” which is read-only and does not allow recording;

“write-once information storage medium” which allows additional recording only once (write-once recording); and

“rewritable information storage medium” which allows rewrite recording time and time again are clearly specified. As shown in FIG. 18, most of the structure and dimensions are common to these three types of information storage media. All of the three types of information storage media have a structure in which a burst cutting area BCA, system lead-in area SYLDI, connection area CNA, data lead-in area DTLDI, and data area DTA are allocated in turn from the inner periphery side. A data lead-out area DTLDO is allocated on the outer periphery portion of all the types of media except for an OPT type read-only medium. As will be described later, a middle area MDA is allocated on the outer periphery portion of the OPT type read-only medium. On the system lead-in area SYLDI, information is recorded in the form of embosses (prepits), and this area is read-only (write-once recording is inhibited) on both the write-once and rewritable media.

On the read-only information storage medium, information is recorded in the data lead-in area DTLDI in the form of embosses (prepits). However, on the write-once and rewritable information storage media, the data lead-in area DTLDI allows write-once recording (rewrite recording on the rewritable medium) of new information by means of formation of recording marks. As will be described later, on the write-once and rewritable information storage media, the data lead-out area DTLDO includes both an area that allows write-once recording (rewrite recording on the rewritable medium) of new information, and a read-only area on which information is recorded in the form of embosses (prepits). As described above, since the PRML method is used to play back signals recorded on the data area DTA, data lead-in area DTLDI, data lead-out area DTLDO, and middle area MDA shown in FIG. 18, an increase in density (especially, improvement of the linear density) of information storage media is achieved. Also, since the slice level detection method is used to play back signals recorded on the system lead-in area SYLDI and system lead-out area SYLDO, the compatibility to the current DVD and playback stability are assured.

Unlike in the current DVD specifications, in the embodiment shown in FIG. 18, the burst cutting area BCA and system lead-in area are positionally separated not to overlap each other. By physically separating these areas, interference between information recorded in the system lead-in area SYLDI and that recorded in the burst cutting area BCA upon information playback can be prevented, and information playback with high accuracy can be assured.

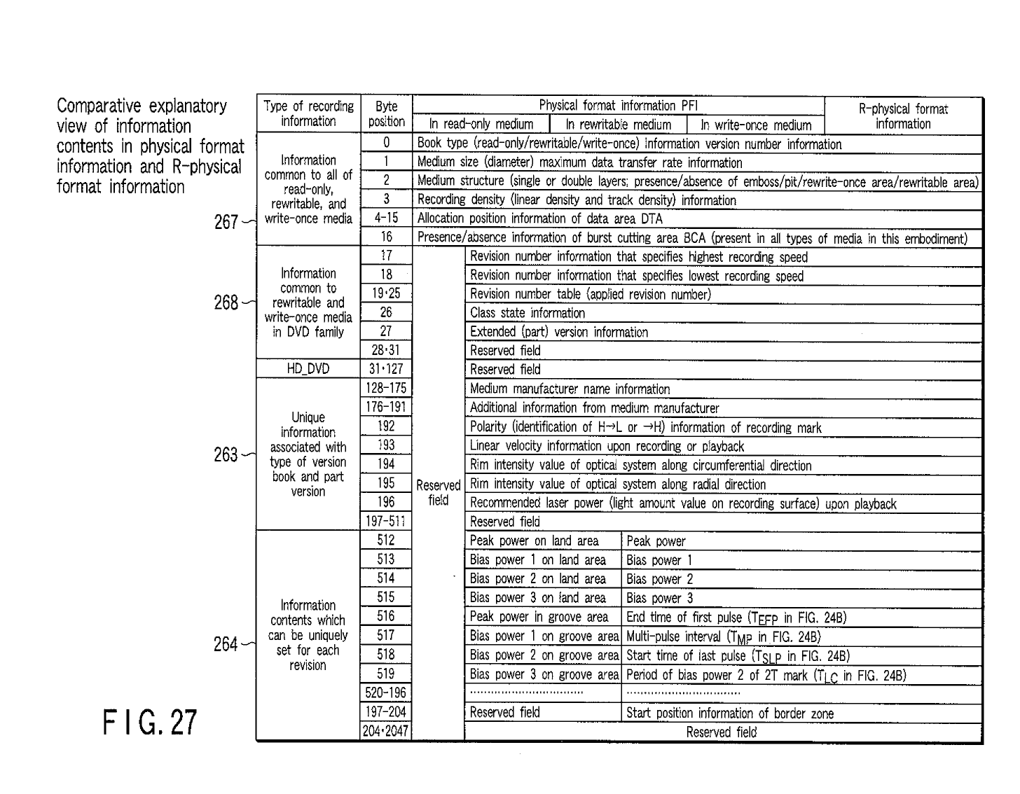

As another embodiment, a method of forming fine three-dimensional pattern in advance at an allocation position of the burst cutting area BCA upon using an “L→H” recording medium is available. In a description part about polarity (“H→L” or “L→H” identification) information of recording marks at the 192nd byte in FIG. 27 later, a description that the specifications include not only the conventional “H→L” recording film but also the “L→H” recording film to broaden the selection range of recording films so as to allow to supply high-speed recordable media and low-cost media will be given. As will be described later, this embodiment takes use of the “L→H” recording film into consideration. Data (barcode data) recorded in the burst cutting area BCA is formed by locally making laser exposure to the recording film.

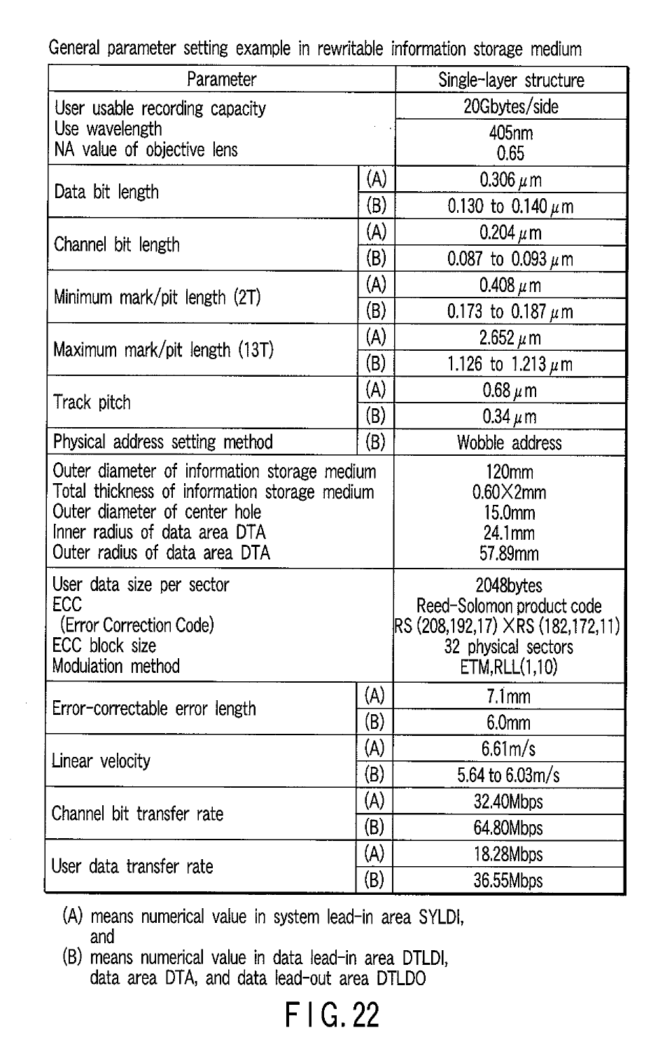

FIG. 22 shows parameter values of this embodiment in the rewritable information storage medium. The rewritable information storage medium has a larger recording capacity than the read-only or write-once information storage medium by decreasing the track pitch and increasing the linear density (data bit length). As will be described later, since the rewritable information storage medium adopts land/groove recording, the track pitch is decreased by reducing the influence of crosstalk between neighboring tracks. All of the read-only, write-once, and rewritable information storage media are characterized in that the data bit length and track pitch (corresponding to the recording density) of the system lead-in/out areas SYLDI/SYLDO are set to be larger than those of the data lead-in/out areas DTLDI/DTLDO (to decrease the recording density).

By setting the data bit length and track pitch of the system lead-in/out areas SYLDI/SYLDO to be close to the values of a lead-in area of the current DVD, the compatibility to the current DVD is assured.

In this embodiment as well, the emboss step in the system lead-in/out areas SYLDI/SYLDO of the write-once information storage medium is set to be shallow as in the current DVD-R. This provides an effect of setting a shallow depth of a pregroove of the write-once information storage medium, and increasing the degree of modulation of a playback signal from recording marks formed on the pregroove by write-once recording. However, as its counteraction, this poses a problem that the degree of modulation of a playback signal from the system lead-in/out areas SYLDI/SYLDO decreases. To solve this problem, since the repetitive frequency of pits and spaces at the densest position is separated (to be greatly reduced) from the optical cutoff frequency of the MTF (Modulation Transfer Function) of a playback objective lens by roughening the data bit length (and track pitch) of the system lead-in/out areas SYLDI/SYLDO, the playback signal amplitude from the system lead-in/out areas SYLDI/SYLDO is raised to guarantee playback stability.

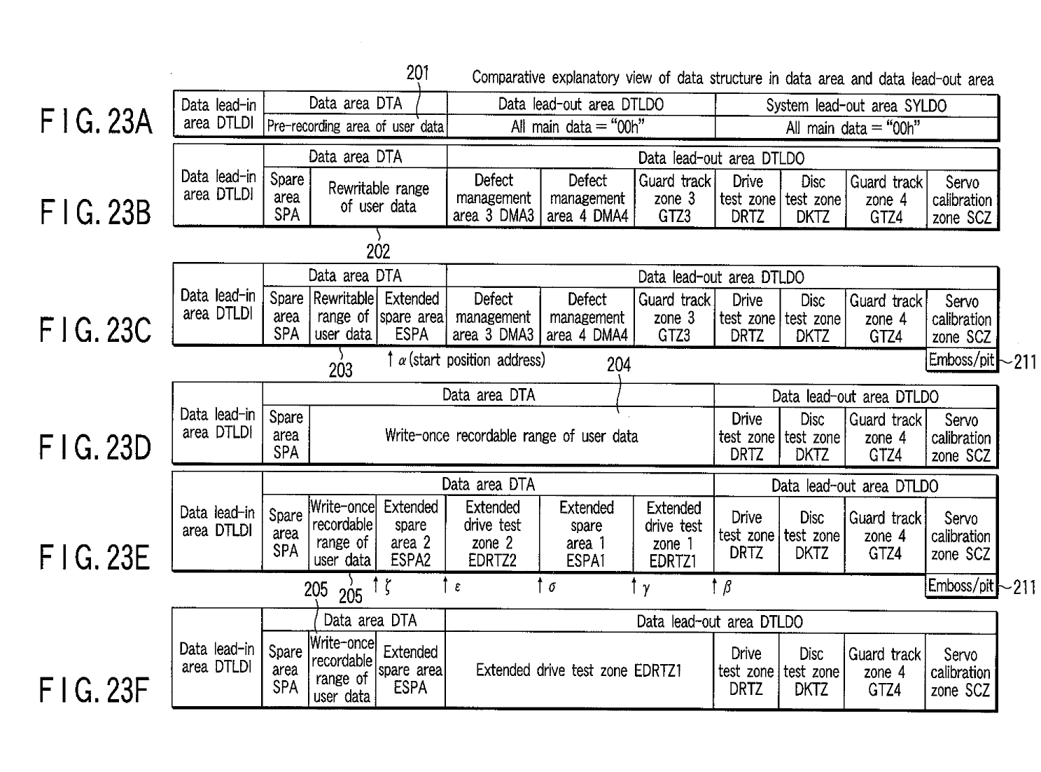

FIGS. 23A to 23F are views showing comparison between the data structures of data areas DTA and data lead-out areas DTLDO of various types of information storage media. FIG. 23A shows the data structure of the read-only information storage medium, FIGS. 23B and 23C show the data structure of the rewritable information storage medium, and FIGS. 23D to 23F show the data structure of the write-once information storage medium. Especially, FIGS. 23B and 23D show the initial structures (before recording), and FIGS. 23C, 23E, and 23F show the data structures after recording (write-once recording or rewrite recording) has progressed to some extent.

As shown in FIG. 23A, data recorded in the data lead-out area DTLDO and system lead-out area SYLDO have a data frame structure (which will be described later), and the values of all main data in these areas are set to be “00h”. On the read-only information storage medium, the entire data area DTA can be used as a pre-recording area 201 of user data. However, as will be described later, in both the embodiments of the write-once information storage medium and rewritable information storage medium, user data rewritable/write-once recordable ranges 202 to 205 are narrower than the data area DTA.

In the write-once or rewritable information storage medium, a spare area SPA is assured on the innermost periphery portion of the data area DTA. When a defect location is generated in the data area DTA, spare processing is done using the spare area SPA. In case of the rewritable information storage medium, spare log information (defect management information) of the spare processing is recorded in third and fourth defect management areas DMA3 and DMA4 in FIGS. 23B and 23C. In case of the write-once information storage medium, the spare log information (defect management information) upon execution of the spare processing is recorded in copy information C_RMZ of the recorded contents in a recording management zone included in a border zone. In the current DVD-R discs, no defect management is done. However, as the number of DVD-R discs to be manufactured increases, some DVD-R discs having defect locations begin to appear, and a demand for improving the reliability of information recorded on the write-once information storage media is increasing. In this embodiment, as shown in FIGS. 23D to 23F, a spare area SPA is also set on the write-once information storage medium to allow defect management by means of the spare processing. Since the defect management processing is applied to write-once information storage media locally having defect locations, the reliability of information to be recorded can be improved.

On the rewritable or write-once information storage medium, when many defects have occurred, the information recording/playback apparatus determines on the user side to automatically set extended spare areas ESPA, ESPA1, and ESPA2, as shown in FIGS. 23C, 23D, and 23F to a state immediately after sales to the user shown in FIGS. 23B and 23D, thus extending spare locations. In this way, by setting the extended spare areas ESPA, ESPA1, and ESPA2, media with many defects can be sold on the ground of manufacture. As a result, the manufacture yield of media improves to attain a price reduction of the media.

When the extended spare area ESPA, ESPA1, or ESPA2 is additionally assured in the data area DTA, as shown in FIG. 23C, 23E, or 23F, the rewritable or write-once recordable range 203 or 205 of user data decreases, and its position information need be managed. On the rewritable information storage medium, that position information is recorded in first to fourth defect management areas DMA1 to DMA4, and also in a control data zone CDZ, as will be described later. In case of the write-once information storage medium, the position information is recorded in the data lead-in area DTLDI and a recording management zone RMZ included in a border out BRDO. As will be described later, the position information is recorded in recording management data RMD in the recording management zone RMZ. The recording management data RMD is additionally recorded as update data in the recording management zone RMZ every time the management data contents are updated. Hence, even when the extended spare areas are re-set time and again (the embodiment of FIG. 23E shows a state wherein an extended spare area 1 ESPA1 is set first, and after that extended spare area 1 ESPA1 is fully used up, since there are many defects and another spare area need be set, another extended spare area 2 ESPA2 is set in due course), they can be timely updated and managed.

A third guard track zone GTZ3 shown in FIGS. 23B and 23C are allocated between the fourth defect management area DMA4 and a drive test zone DRTZ to separate them, and a guard track zone GTZ4 is allocated between a disc test zone DKTZ and servo calibration zone SCZ to separate them. The third and fourth guard track zones GTZ3 and GTZ4 are specified as areas that inhibit recording by means of recording mark formation. Since the third and fourth guard track zones GTZ3 and GTZ4 are included in the data lead-out area DTLDO, a pregroove region (write-once information storage medium) or groove and land areas (rewritable information storage medium) are formed in advance in this area. Since wobble addresses are recorded in the pregroove area or the groove and land areas, as shown in, e.g., FIG. 22, the current position in the information storage medium is determined using this wobble address.

The drive test zone DRTZ is assured as an area where the information recording/playback apparatus makes a trial write before information recording on the information storage medium. The information recording/playback apparatus makes a trial write within this area in advance to determine optimal recording conditions (write strategy), and can then record information in the data area DTA using the optimal recording conditions.

The disc test zone DKTZ is an area which is assured to allow the vendor of information storage media to conduct quality tests (evaluation).

The pregroove region (write-once information storage medium) or groove and land areas (rewritable information storage medium) are formed in advance in the entire data lead-out area DTLDO except for the servo calibration zone SCZ, so as to allow recording (write-once recording or rewrite recording) of recording marks. As shown in FIGS. 23C and 23E, an embossed pit area 211 is assured in the servo calibration zone SCZ. On this area, a continuous track of embossed pits is formed to be continuous from other zones of the data lead-out area DTLDO. This track continuously runs on in a spiral shape to form embossed pits through 360° along the circumference of the information storage medium. This area is assured to detect the tilt amount of the information storage medium using a ODD (Differential Phase Detect) method. When the information storage medium has a tilt, an offset is generated in a tracking error detection signal amplitude using the DPD method, and the title amount based on the offset amount and the tilt direction based on the offset direction can be precisely detected. Using this principle, by forming embossed pits that allow DPD detection on the outermost periphery portion (the outer periphery portion in the data lead-out area DTLDO) of the information storage medium, precise tilt detection can be attained without adding special parts (for tilt detection) to an optical head included in the information recording/playback unit 141 in FIG. 14. Furthermore, by detecting the tilt amount of the outer periphery portion, stable servo control can be implemented (based on tilt amount correction) even in the data area DTA.

In this embodiment, the track pitch in the servo calibration zone SCZ matches that of other zones in the data lead-out area DTLDO, thus improving the productivity of information storage media and achieving a cost reduction of media by the improved yield. That is, on the write-once information storage medium, pregrooves are formed on other zones in the data lead-out area DTLDO. Upon manufacturing a master disc of the write-once information storage medium, the pregrooves are formed by setting a constant feed motor speed of an exposure unit of a master disc recording apparatus. At this time, since the track pitch in the servo calibration zone SCZ matches that of other zones in the data lead-out area DTLDO, the motor speed can also be held constant in the servo calibration zone SCZ, and pitch nonuniformity hardly occurs, thus improving the productivity of information storage media.

As another embodiment, a method of matching at least one of the track pitch and data bit length in the servo calibration zone SCZ with that of the system lead-in area SYLDI is available. The tilt amount and direction in the servo calibration zone SCZ are measured using the DPD method, and the measurement results are also used in the data area DTA to stabilize servo control in the data area DTA, as described above. As a method of predicting the tilt amount in the data area DTA, the tilt amount and direction in the system lead-in area SYLDI are measured in advance by the DPD method, and they can be predicted using the relationship with the measurement results in the servo calibration zone SCZ. Upon using the DPD method, the offset amount and a direction to offset of the detection signal amplitude with respect to the tilt of the information storage medium change depending on the track pitch and data bit length of embossed pits. Therefore, by matching at least one of the track pitch and data bit length in the servo calibration zone SCZ with that of the system lead-in area SYLDI, the detection characteristics associated with the offset amount and direction to offset of the detection signal amplitude match in the servo calibration zone SCZ and system lead-in area SYLDI to allow easy calculation of a correlation, thus facilitating prediction of the tilt amount and direction in the data area DTA.

As shown in FIG. 23D, drive test zones DRTZ are assured at two positions, i.e., the inner and outer periphery sides on the write-once information storage medium. As the number of times of trial writes conducted in the drive test zone DRTZ increases, the optimal recording conditions can be explored in detail by finely changing parameters, thus improving the recording accuracy on the data area DTA. The rewritable information storage medium allows reuse in the drive test zone DRTZ by overwrite. However, when the recording accuracy is to be improved by increasing the number of times of trial writes on the write-once information storage medium, a problem that the drive test zone DRTZ is used up soon is posed. To solve this problem, this embodiment is characterized by allowing to set extended drive test zones EDRTZ from the outer periphery portion in the inner periphery direction, thus extending the drive test zone. This embodiment has the following characteristic features about the method of setting an extended drive test zone and the trial write method in the set extended drive test zone.

(1) Extended Drive Test Zones EDRTZ are Sequentially Set (Framed) Together from the Outer Circumferential Direction Toward the Inner Periphery Side

An extended drive test zone 1 EDRTZ1 is set as a substantial area from a location closest to the outer periphery in the data area (location closest to the data lead-out area DTLDO) in FIG. 23E. After the extended drive test zone 1 EDRTZ1 is used up, an extended drive test zone 2 EDRTZ2 can be set next as a substantial area which exists on the inner periphery side of the zone 1 EDRTZ1.

(2) Trial Writes are Sequentially Made from the Inner Periphery Side in one Extended Drive Test Zone EDRTZ

Upon making a trial write in the extended drive test zone EDRTZ, it is done along the groove area allocated in a spiral shape from the inner periphery side along the outer periphery side, and the current trial write is made at an unrecorded location immediate after the (already recorded) location where the previous trial write was made.

The data area has a structure in which write-once recording is done along a groove area 214 allocated in a spiral shape from the inner periphery side along the outer periphery side. Since processing of “confirmation of the immediately preceding trial write location”→“execution of the current trial write” can be serially executed by a method of sequentially additionally recording trial write information in the extended drive test zone at a location after the previous trial write location, not only the trial write processing is facilitated, but also management of locations that have already undergone the trial write in the extended drive test zone EDRTZ becomes easy.

(3) The Data Lead-Out Area DTLDO can be Re-Set to Include the Extended Drive Test Zone EDRTZ

FIG. 23E shows an example in which in the data area DTA, an extended spare area ESPA1 and extended spare area ESPA2 are set at two locations, and the extended drive test zone EDRTZ1 and extended drive test zone EDRTZ2 are set at two locations. In this case, this embodiment is characterized in that an area including up to the extended drive test zone EDRTZ2 can be re-set as the data lead-out area DTLDO, as shown in FIG. 23F. The range of the data area DTA is re-set while narrowing down the range in conjunction with this re-setting of the area, and management of the user data write-once recordable range 205 in the data area DTA becomes easy. Upon re-setting the range, as shown in FIG. 23F, the setting location of the extended spare area ESPA1 shown in FIG. 23E is considered as an “already used-up extended spare area”, and it is managed that an unrecorded area (an area where a trial write of write-once recording can be made) exists in only the extended spare area ESPA2 in the extended drive test zone EDRTZ. In this case, non-defect information which is recorded in the extended spare area ESPA1 and is used as spare information is entirely moved to the location of a non-spare area in the extended spare area ESPA2, thus rewriting defect management information.

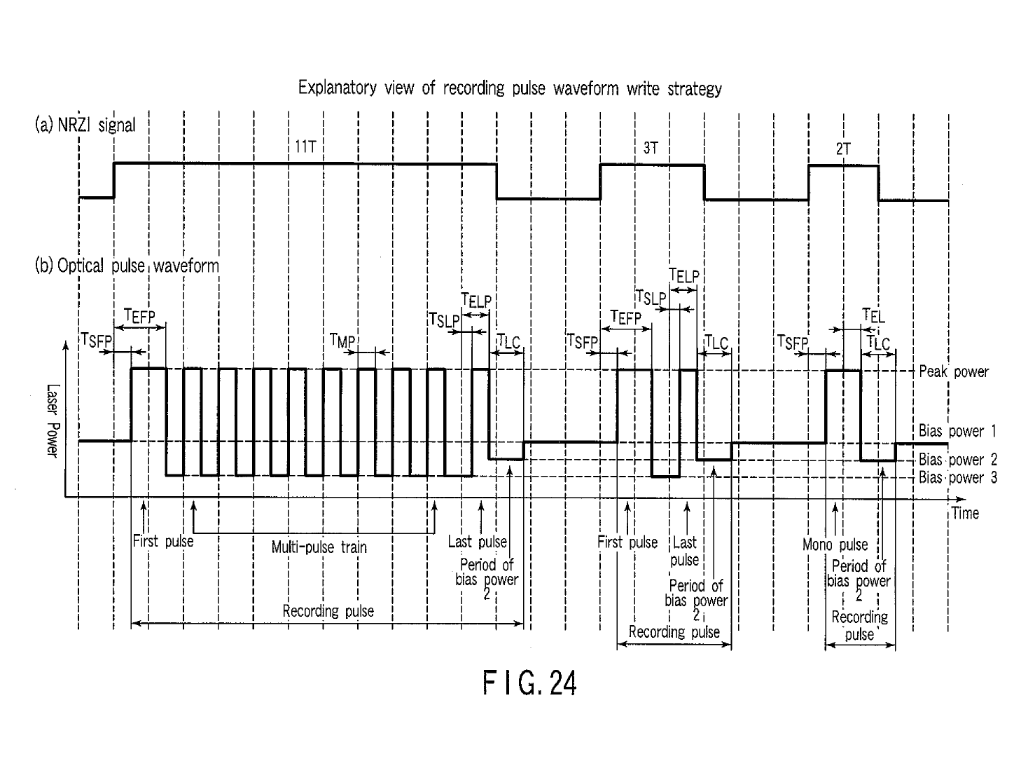

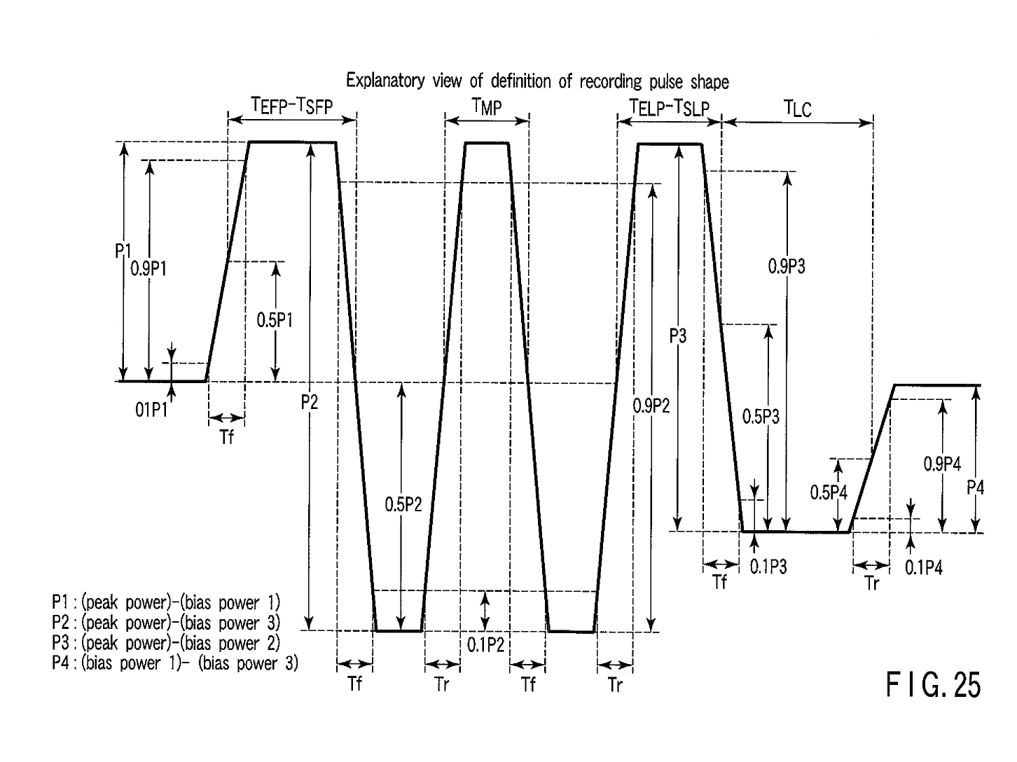

FIG. 24 shows the waveform (write strategy) of recording pulses used to make a trial write on the drive test zone, and FIG. 25 shows the definition of the recording pulse shape.

Marks and spaces are overwritten on a disc by irradiating pulses with a peak power, first bias power, second bias power, and third bias power. The marks are overwritten on the disc by irradiating pulses modulated between the peak power and third bias power. The spaces are overwritten on the disc by irradiating pulses of the first bias power.

The SbER is means for evaluating random errors, and corresponds to a bit error rate induced by a random error.

Before measurement of the PRSNR and SbER, equalizer coefficients are calculated by a minimum square error (MSE) algorithm.

The recording pulses are a train of optical pulses, as shown in FIG. 24.

Recording pulses for a 2 T mark include a mono pulse and the subsequent pulse of the second bias power. Recording pulses for a 3 T mark include a first pulse, a last pulse, and the subsequent pulse of the second bias power. Recording pulses for a mark longer than the 3 T mark include a first pulse, a multi-pulse train, a last pulse and the subsequent pulse of the second bias power. T is a channel clock period.

Recording Pulse Structure for 2 T Mark

Generation of mono pulses starts after an elapse of TSFP from the leading edge of an NRZI signal, and ends 1 T−TELP before the trailing edge of the NRZI signal. The mono pulse period is 1 T−TELP+TSFP. TELP and TSFP are recorded in a control data zone. A second bias power period that follows the mono pulses is TLC. TLC is recorded in the control data zone.

Recording Pulse Structure for Mark Longer than 2 T Mark

Generation of the first pulse starts after an elapse of TSFP from the leading edge of the NRZI signal, and ends after an elapse of TEFP from the trailing edge of the NRZI signal. TEFP and TSFP are recorded in the control data zone. Recording pulses corresponding to 4 T to 13 T form a multi-pulse train. The multi-pulse train includes repetition of pulses each having a pulse width TMP for a period T. Generation of the multi-pulse train starts after an elapse of 2 T from the leading edge of the NRZI signal, and generation of the final pulse of the multi-pulse train ends 2 T before the trailing edge of the NRZI signal. TMP is recorded in the control data zone.

Generation of the last pulse starts 1 T−TSLP before the leading edge of the NRZI signal, and ends 1 T−TELP before the trailing edge of the NRZI signal.

TELP and TSLP are recorded in the control data zone.

The pulse width of the pulse of the second bias power which follows the last pulse is TLC. TLC is recorded in the control data zone.

TEFP−TSFP, TMP, TELP−TSLP, and TLC are maximum periods of the full width and half width. FIG. 25 defines the maximum periods of the full width and half width. A leading period Tr and trailing period Tf are 1.5 ns or less. The difference between the leading period Tr and trailing period Tf is 0.5 ns or less.

TSFP, TEFP, TSLP, TELP, TMP, and TLC are recorded in the control data zone for each ( 1/32) T, and assume the following values.

TSFP falls within the range from 0.25 T (inclusive) to 1.50 T (inclusive).

TELP falls within the range from 0.00 T (inclusive) to 1.00 T (inclusive).

TEFP falls within the range from 1.00 T (inclusive) to 1.75 T (inclusive).

TSLP falls within the range from −0.10 T (inclusive) to 1.00 T (inclusive).

TLC falls within the range from 0.00 T (inclusive) to 1.00 T (inclusive).

TMP falls within the range from 0.15 T (inclusive) to 0.75 T (inclusive).

Adaptive control parameters TSFP, TELP, and TLC have the following restrictions.

The difference between the maximum and minimum values of TSFP is 0.50 T or less.

The difference between the maximum and minimum values of TELP is 0.50 T or less.

The difference between the maximum and minimum values of TLC is 1.00 T or less.

The mono pulse width 1 T−TSFP+TELP falls within the range from 0.25 T (inclusive) to 1.50 T (inclusive).

These parameters are controlled on the accuracy of ±0.2 ns.

If the peak power periods of the first pulse and multi-pulse train overlap each other, a combined peak power period is a total sum of the continuous periods of these peak power periods. If the peak power periods of the first pulse and last pulse overlap each other, a combined peak power period is a total sum of the continuous periods of these peak power periods. If the peak power periods of the final pulse of the multi-pulse train and the last pulse overlap each other, a combined peak power period is a total sum of the continuous periods of these peak power periods.

A recording power has four levels: the peak power, first bias power, second bias power, and third bias power. These are optical powers used to record marks and spaces upon irradiation onto the read surface of a disc.

The peak power, first bias power, second bias power, and third bias power are recorded in the control data zone. The maximum value of the peak power does not exceed, e.g., 10.0 mW. The maximum values of the first bias power, second bias power, and third bias power do not exceed, e.g., 4.0 mW.

The average peak power of the mono pulse, first pulse, and last pulse meets the following requirement.

|(average peak power)−(peak power)|≦5% of peak power

An average first bias power and average second bias power meet the following requirements.

|(average first bias power)−(first bias power)|≦5% of first bias power

|(average second bias power)−(second bias power)|≦5% of second bias power

An average power of the multi-pulse train is that of the instantaneous values of powers during a measurement period.

The measurement period includes all pulses of the multi-pulse train, and is a multiple of T. The average power of the multi-pulse train meets the following requirement.

|(average power of multi-pulse train)−(peak power+third bias power)/2|≦5% of (peak power+second bias power)/2

The instantaneous value of the power is that of an actual power.

The average power is an average value of the instantaneous values of the powers within a predetermined power range.

The power ranges of the average values of the powers meets the following requirements.

Average value of peak powers: |(actual power)−(peak power)|≦10% of peak power

Average value of first bias powers: |(actual power)−(first bias power)|≦10% of first bias power

Average value of second bias powers: |(actual power)−(second bias power)|≦10% of second bias power

Average value of third bias powers: |(actual power)−(third bias power)|≦10% of third bias power

The measurement period of the average power does not exceed the pulse width period of each pulse.

Instantaneous value powers meet the following requirements.

|(instantaneous value peak power)−(peak power)|≦10% of peak power

(instantaneous value first bias power)−(first bias power)|≦10% of first bias power

|(instantaneous value second bias power)−(second bias power)|≦10% of second bias power

|(instantaneous value third bias power)−(third bias power)|≦10% of third bias power

In order to accurately control a mark edge position, the timings of the first pulse, last pulse, and mono pulse are modulated.

An NRZI mark length is classified to M2, M3, and M4. Mark lengths M2, M3, and M4 indicate 2 T, 3 T, and 3T or longer.

An NRZI space length immediately before a mark is classified to LS2, LS3, and LS4. Space lengths LS2, LS3, and LS4 indicate 2 T, 3 T, and 3T or longer.

An NRZI space length immediately after a mark is classified to TS2, TS3, and TS4. Space lengths TS2, TS3, and TS4 indicate 2 T, 3 T, and 3 T or longer.

TLC is modulated as a function of a category of the NRZI mark length. Therefore, TLC assumes the following three values.

TLC(M2), TLC(M3), TLC(M4)

TLC(M) indicates the value of TMC when the category of the mark length of an NRZI signal is M.

These three TLC values are recorded in the control data zone.

TSFP is modulated as a function of the category of the NRZI mark length and that of the NRZI space length immediately before a mark. Therefore, TSFP assumes the following nine values.

TSFP(M2, LS2), TSFP(M3, LS2), TSFP(M4, LS2),

TSFP(M2, LS3), TSFP(M3, LS3), TSFP(M4, LS3),

TSFP(M2, LS4), TSFP(M3, LS4), TSFP(M4, LS4)

TSFP(M, LS) indicates the value when the category of the mark length of the NRZI signal is M and that of the NRZI space length immediately before a mark is LS. These nine TSFP values are recorded in the control data zone.

TELP is modulated as a function of the category of the NRZI mark length and that of the NRZI space length immediately after a mark. Therefore, TELP assumes the following nine values.

TELP(M2, TS2), TELP(M3, TS2), TELP(M4, TS2),

TELP(M2, TS3), TELP(M3, TS3), TELP(M4, TS3),

TELP(M2, TS4), TELP(M3, TS4), TELP(M4, TS4)

TELP(M, TS) indicates the value when the category of the mark length of the NRZI signal is M and that of the NRZI space length immediately after a mark is TS. These nine TELP values are recorded in the control data zone.

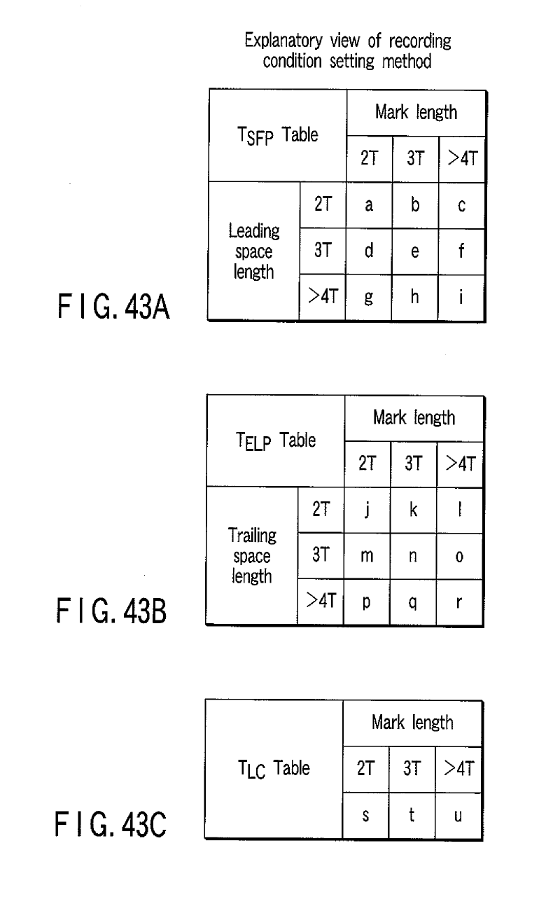

The value of TSFP is expressed by a to i as a function of the mark length and a leading space length (FIG. 43A), the value of TELP is expressed by j to r as a function of the mark length and a trailing space length (FIG. 43B), and the value of TLC is expressed by to u as a function of the mark length (FIG. 43C).

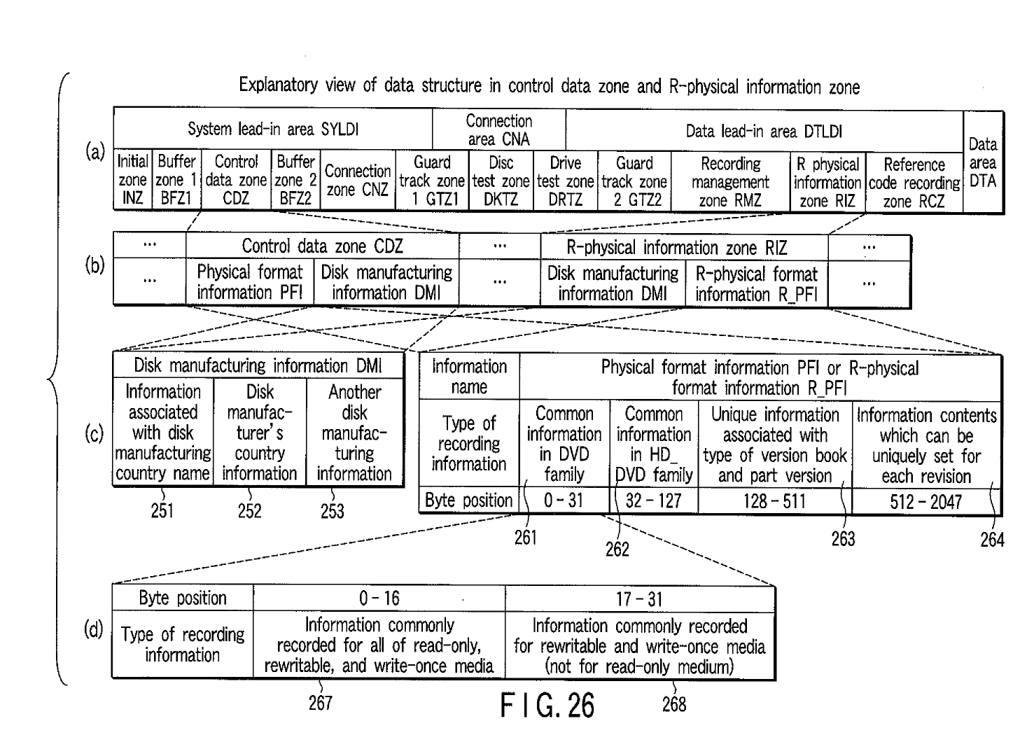

FIG. 26 shows the data structures in the control data zone CDZ and R-physical information zone RIZ. As shown in FIG. 26, the control data zone CDZ includes physical format information PFI, and disc manufacturing information DMI, and the R-physical information zone RIZ includes the same disc manufacturing information DMI and R-physical format information R-PFI.

The disc manufacturing information DMI records information 251 associated with a disc manufacturing country name, and disc manufacturer's country information 252. When sold information storage media infringe a patent, an infringement alert is often issued to a country where the manufacturing site is located or that which consumes (uses) the information storage media. Since each information storage medium is required to record the aforementioned information, the manufacturing site (country name) is determined to facilitate issuance of the patent infringement alert, thus protecting the intellectual properties and promoting the advance in technology. Furthermore, the disc manufacturing information DMI also records another disc manufacturing information 253.

A characteristic feature of this embodiment lies in that the types of information to be recorded are specified depending on the recording locations (the relative byte positions from the head) in the physical format information PFI or R-physical format information R_PFI. More specifically, common information 261 in a DVD family is recorded in a 32-byte area from the 0th byte to the 31st byte as the recording location in the physical format information PFI or R-physical format information R_PFI, and common information 262 in an HD_DVD family as the target of this embodiment is recorded in a 96-byte area from the 32nd byte to the 127th byte. Unique information (specific information) 263 associated with the type of version book and part version is recorded in a 384-byte area from the 128th byte to the 511th byte, and information corresponding to each revision is recorded in a 1536-byte area from the 512th byte to the 2047th byte. In this way, by commonizing the information allocation positions in the physical format information based on the information contents, the locations of recorded information can be commonized independently of the types of media. Therefore, the playback processing of the information playback apparatus or information recording/playback apparatus can be commonized and simplified. The common information 261 in the DVD family, which is recorded from the 0th byte to the 31st byte, is further divided into information 267 which is commonly recorded from the 0th byte to the 16th byte for all of the read-only information storage medium, rewritable information storage medium, and write-once information storage medium, and information 268 which is commonly recorded from the 17th byte to the 31st byte for the rewritable information storage medium and write-once information storage medium but is not recorded for the read-only type, as shown in FIG. 26.

FIG. 27 is a table showing the detailed information contents in the physical format information PFI or R-physical format information R_PFI and comparison based on the medium types (read-only, rewritable, or write-once) of information in the physical format information PFI, shown in FIG. 26, information 267 commonly recorded for all of the read-only, rewritable, and write-once media in the common information 261 in a DVD family sequentially records, from byte positions 0 to 16, book type (read-only/rewritable/write-once) information and version number information, a medium size (diameter) and maximum data transfer rate information, a medium structure (single layer or double layers, the presence/absence of embossed pits/write-once area/rewritable area), recording density (linear density and track density) information, allocation position information of the data area DTA, and presence/absence information (present for all the media in this embodiment) of the burst cutting area BCA.

Information 268 commonly recorded for the rewritable and write-once media in the common information 261 in a DVD family sequentially records, from the 28th byte to the 31st byte, revision number information which specifies a maximum recording speed, revision number information which specifies a minimum recording speed, a revision number table (applied revision number), class state information, and extended (part) version information. A characteristic feature of this embodiment lies in that providing the information from the 28th byte to the 31st byte is to provide the revision information according to the recording speed in the recording area of the physical format information PFI or R-physical format information R_PFI. Conventionally, upon development of media whose recording speed rises like double-speed, quadruple-speed, and the like, a new book must be re-created accordingly on a case-by-case basis, resulting in much troublesome efforts.

As will be described later in the following embodiments, the present invention is that which found out preferable combinations of these apparatus arrangements, data structures, and medium configurations. In order to attain more stable recording/playback, these combinations are very important.

Since the structure of ECC blocks and the like in the conversion sequence explanatory view until a physical sector structure is configured, the structure explanatory view in a data frame, the explanatory view of the ECC block structure, the explanatory view of a frame sequence after scrambling, the explanatory view of the PO interleave method, the structure explanatory view in a physical sector, the explanatory view of the sync code pattern contents, and the like play particularly important roles in the error correction process together with the data structure and the like, they are very important parts so as to attain the high density and high reliability in the information playback apparatus and information storage medium. As will also be described later, upon write-once recording of information on a medium on which certain information (data) has already been written, recording is done after the last part of the already recorded information so as to losslessly record information on the information storage medium. In this case, although the information may be partially rewritten, the configuration of the information storage medium of the present invention is particularly suited to such case since it especially has a high OW erase ratio.

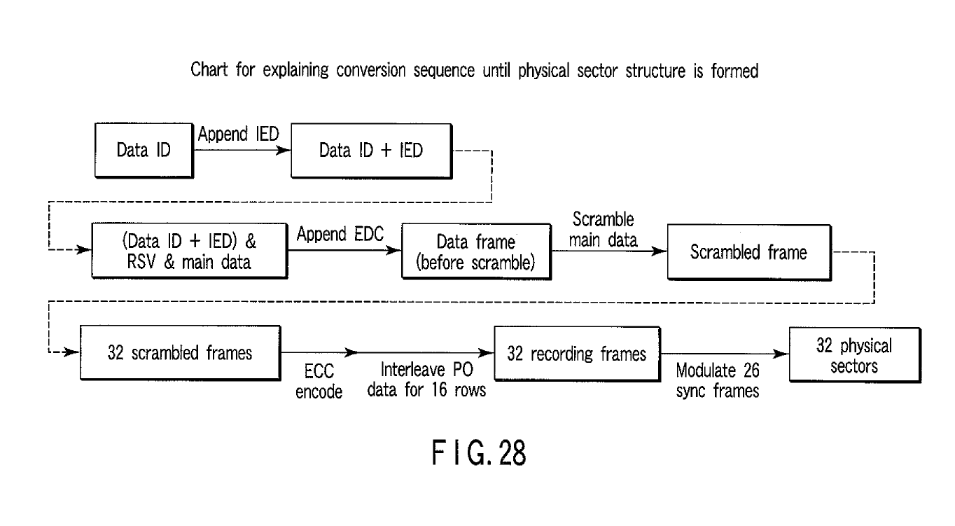

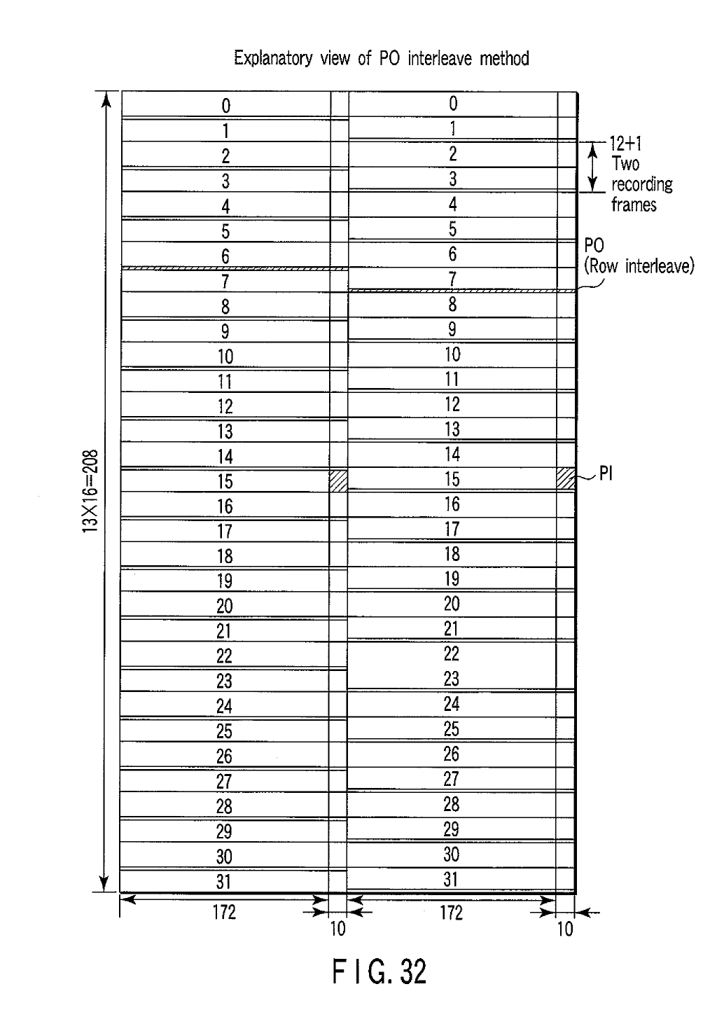

FIG. 28 shows an overview of the conversion procedure until a physical sector structure to be recorded on the information storage medium is formed by configuring an ECC block from a data frame structure that records user data for every 2048 bytes, and by appending a sync code. This conversion procedure is commonly adopted for all of the read-only, write-once, and rewritable information recording media. According to respective conversion stages, a data frame, scrambled frame, recording frame, and recorded data field are defined. The data frame is a location where user data is recorded, and includes 2048-byte main data, a 4-byte data ID, a 2-byte ID error detection code (IED) field, reserved bytes (6 bytes) RSV, and a 4-byte error detection code (EDC). First, after an IED (ID error detection code) is appended to a data ID (to be described later), six reserved bytes and 2048-byte main data are appended to the data frame, and an error detection code (EDC) is appended to the data frame. After that, the main data is scrambled. A cross Reed-Solomon Error correction code is applied to 32 scrambled data frames (scrambled frames) to execute ECC encoding processing. With this processing, recording frames are formed. Each of these recording frames includes a parity of outer-code PO and parity of inner-code PI. The parity codes PO and PI are error correction codes generated for each ECC block including 32 scrambled frames. The recording frame undergoes ETM (Eight to Twelve Modulation) for converting 8-bit data into 12 channel bits, as described above. Sync codes SYNC are appended to every 91 bytes to form 32 physical sectors. A characteristic feature of this embodiment lies in that 32 sectors form one error correction unit (ECC block), as described in a lower right frame in FIG. 28. As will be described later, numbers “0” to “31” in frames in FIG. 31 or 32 indicate those of physical sectors, and a total of 32 physical sectors “0” to “32” form one large ECC block.

It is required for the next-generation DVD to be able to play back accurate information by the error correction processing, even when a scratch with a length equivalent to that on the current-generation DVD is formed on the surface of the information storage medium. In this embodiment, the recording density is increased to attain a large capacity. As a result, in case of one ECC block 16 sectors of the conventional DVD, the length of a physical scratch that can be corrected by error correction can become shorter than the conventional DVD. Since one block is configured by 32 sectors as in this embodiment, an allowable length of a scratch on the surface of the information storage medium, which can be error corrected can be increased, and the compatibility of the ECC block structure and format consistency of the current DVD can be assured.

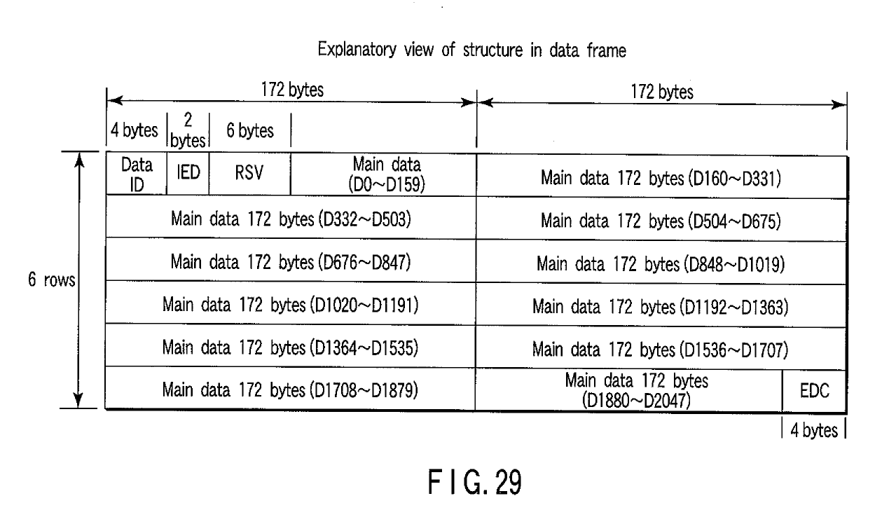

FIG. 29 shows the structure in the data frame. One data frame is made up of 172 bytes×2×6 rows, i.e., 2064 bytes, and includes 2048-byte main data. IED is a short for an ID error detection code, and means an additional code for error detection upon playback of the data ID information. REV is a short for reserve, and means a reserved field in which information can be set in the future. EDC is a short for an error detection code, and means an additional code for error detection of the entire data frame.

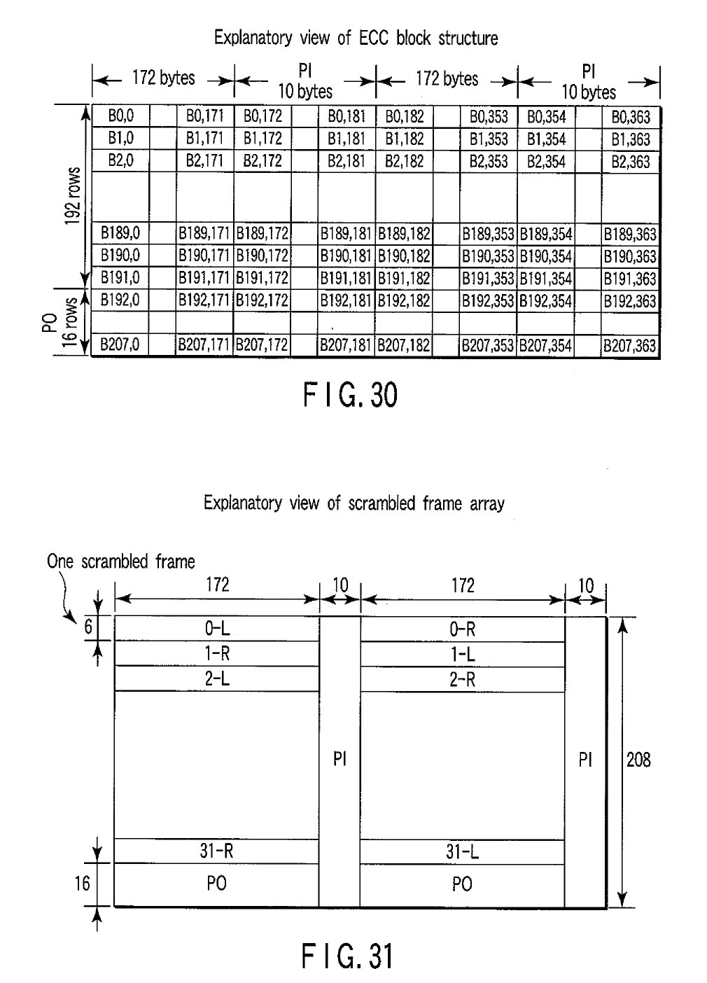

FIG. 30 shows an ECC block structure in this embodiment. An ECC block is formed of 32 successive scrambled frames. One hundred and ninety two rows+16 rows in the vertical direction and (172+10)×2 columns in the horizontal direction are allocated. Each of B0,0, B1,0, . . . is one byte. PO and PI are error correction codes, and are respectively an outer parity and inner parity. This embodiment forms an ECC block structure using product codes. That is, this embodiment forms a structure in which data to be recorded on the information storage medium are two-dimensionally allocated, and as additional bits for error correction, PI (Parity in) and PO (Parity out) codes are appended to the “row” and “column” directions, respectively. By forming the ECC block structure using product codes, high error correction capability by means of erasure correction and repetitive correction processes in the vertical and horizontal directions can be guaranteed.

The ECC block structure shown in FIG. 30 is characterized in that two PI codes are set in an identical “row” unlike in that of the conventional DVD. That is, a PI code having a 10-byte size described at the center of FIG. 30 is appended to 172 bytes allocated on its left side. More specifically, a 10-byte PI code from B0,172 to B0,181 is appended to 172-byte data from B0,0 to B0,171, and a 10-byte PI code from B1,172 to B1,181 is appended to 172-byte data from B1,0 to B1,171.

A PI code having a 10-byte size described at the right end in FIG. 30 is appended to 172-byte data allocated on its left side and at the central position. More specifically, a 10-byte PI code from B0,354 to B0,363 is appended to, e.g., 172-byte data from B0,182 to B0,353.

FIG. 31 is an explanatory view of a scrambled frame array. A (6 rows×172 bytes) unit is handled as one scrambled frame. That is, one ECC block is formed of 32 successive scrambled frames. Furthermore, this system handles a pair of blocks (182 bytes×208 bytes). L is assigned to the numbers of scrambled frames in a left ECC block, and R is assigned to those of scrambled frames in a right ECC block. As a result, the scrambled frames are allocated, as shown in FIG. 31. That is, right and left scrambled frames alternately appear in the left block, and also alternately appear in the right block.

That is, one ECC block is formed of 32 successive scrambled frames. Left half rows of an odd sector are exchanged by right half rows. One hundred and seventy two×2 bytes×192 rows are equal to 172 bytes×12 rows×32 scrambled frames, and form a data area. Sixteen-byte PO codes are appended to form outer codes of RS(208, 192, 17) to 172×2 columns. Ten-byte PI codes (RS(182, 172, 11) are appended to 208×2 rows of each of the right and left blocks. PI codes are appended to PO rows. A numeral in each frame indicates the scrambled frame number, and suffices R and L mean the right and left halves of scrambled frames.

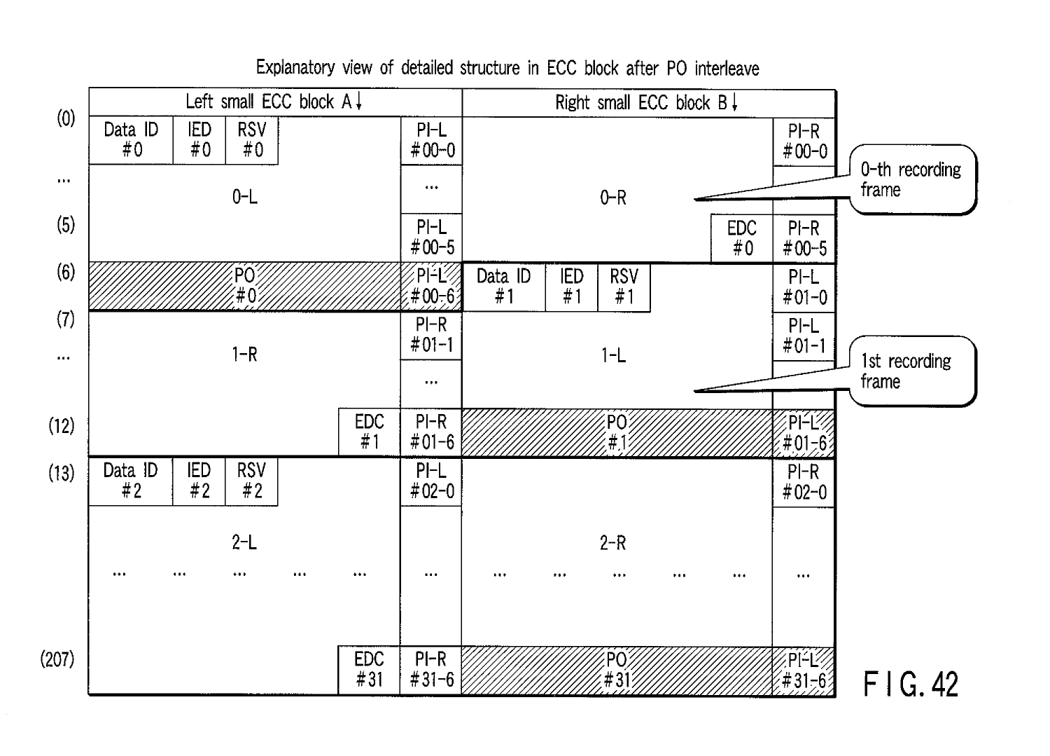

A characteristic feature of this embodiment lies in that the contents of one data frame are dispersedly allocated in a plurality of small ECC blocks. More specifically, in this embodiment, two small ECC blocks form one large ECC block, and the contents of one data frame are alternately dispersedly allocated in these two small ECC blocks. As has already been described above, the PI code having a 10-byte size illustrated at the center in the description of FIG. 30 is appended to 172 bytes allocated on its left side, and the PI code with a 10-byte size illustrated at the right end is appended to 172 bytes allocated on its left side and at the central position. That is, 172 bytes from the left end in FIG. 30 and 10-byte PI code which follows the 172 bytes form a left small ECC block, and central 172 bytes and 10-byte PI code on the right end form a right small ECC block. In correspondence with this structure, symbols in respective frames in FIG. 31 are set. For example, “2-R” or the like in FIG. 31 represents the data frame number and whether the contents of that data frame belong to right or left small ECC block (e.g., the contents of the second data frame belong to a right small ECC block). As will be described later, data in one physical sector is also alternately dispersedly allocated in right and left small ECC blocks for respective physical sectors to be finally formed (left half columns in FIG. 32 are included in a left small ECC block (left small ECC block A shown in FIG. 42) and left half columns are included in a right small ECC blocks (right small ECC block B shown in FIG. 42).

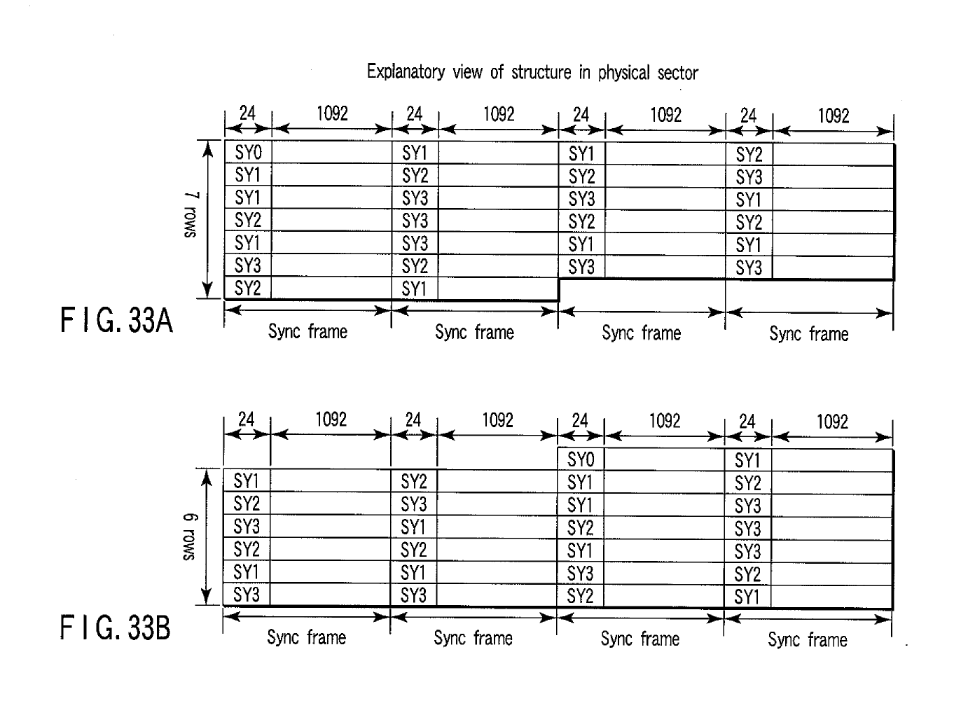

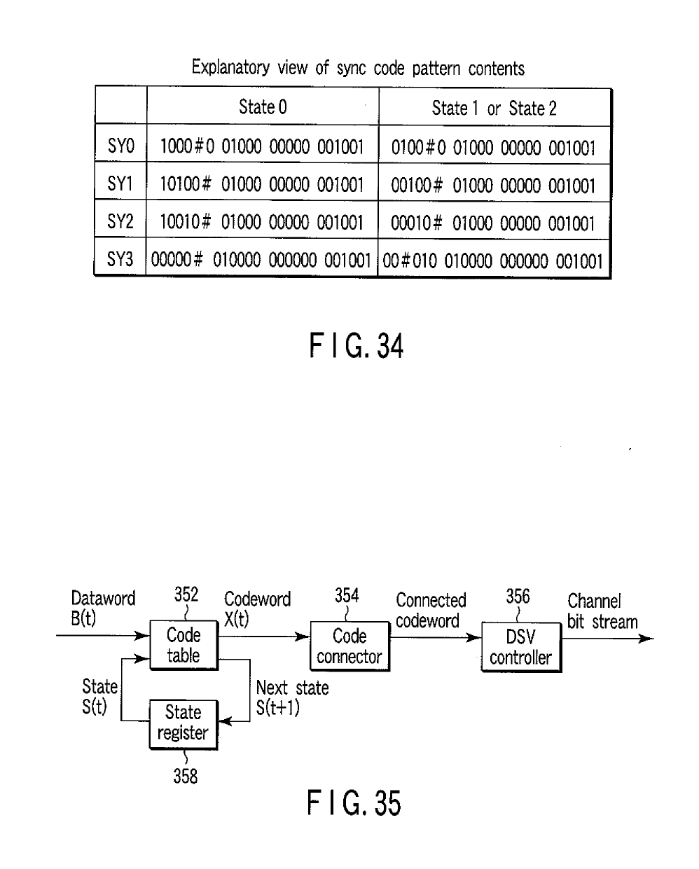

By dispersedly allocating the contents of one data frame to a plurality of small ECC blocks, the error correction capability of data in physical sectors (FIGS. 33A and 33B) can be improved, and also reliability of recording data can be improved. For example, a case will be examined wherein out of tracking has occurred during recording to overwrite the already recorded data with another data, thus destroying data for one physical sector. Since this embodiment applies error correction to the destroyed data in one sector using two small ECC blocks, the load on error correction in one ECC block can be reduced, thus guaranteeing error correction with high performance. Also, in this embodiment, since the data ID is allocated at the head position of each sector even after formation of an ECC block, the data position upon access can be confirmed at high speed.

FIG. 32 is an explanatory view of a PO interleave method. As shown in FIG. 32, 16 parity rows are dispersed row by row. That is, each of the 16 parity rows is allocated for every two recording frames. Therefore, a recording frame formed of 12 rows becomes 12 rows+1 row. After this row interleave, 13 rows×182 bytes are referred to as recording frames. Therefore, an ECC block after row interleave is made up of 32 recording frames. In one recording frame, six rows each exist in right and left blocks, as described above using FIG. 31. PO bytes are allocated at different rows between left blocks (182×208 bytes) and right blocks (182×208 bytes). FIG. 32 shows one completed ECC block. However, upon actual data playback, such ECC blocks continuously arrive at an error correction processing unit. In order to improve the correction performance of such error correction, the interleave method shown in FIG. 32 is adopted.

The relationship from the structure in one data frame shown in FIG. 29 to the PO interleave method shown in FIG. 32 will be described in detail below using FIG. 42. FIG. 42 allows to observe the relation of conversions from FIG. 29 to FIG. 32 at a glance by enlarging the upper part of the ECC block structure view after PO interleave shown in FIG. 32, and clearly specifying the allocation positions of the data ID, IED, RSV, and EDC shown in FIG. 29 in the enlarged view. “0-L”, “0-R”, “1-R, and “1-L” correspond to those in FIG. 31. Each of “0-L” and “1-L” means data after only main data in the left half in FIG. 29, i.e., a 172 bytes×6 rows block on the left side of the center line, is scrambled. Likewise, each of “0-R” and “1-R” means data after only main data in the right half in FIG. 29, i.e., a 172 bytes×6 rows block on the right side of the center line, is scrambled.

Therefore, as can be seen from FIG. 29, the data ID, IED, and RSV are arranged in turn up to the 12th byte in the first row (0th row) of “0-L” or “1-L”.

FIGS. 33A and 33B show the physical sector structure. FIG. 33A shows an even physical sector structure, and FIG. 33B shows an odd data structure. In FIGS. 33A and 33B, outer parity PO information shown in FIG. 32 is inserted into sync data fields in the last two sync frames (that is, a frame including the last sync code SY3 and next sync data, and a frame including a sync code SY1 and next sync data) in each of even and odd recording data fields.

Some bytes of PO on the left side shown in FIG. 31 are inserted into the last two sync frames in the even recording data field, and some bytes of PO on the right side shown in FIG. 31 are inserted into the last two sync frames in the odd recording data field.

As shown in FIG. 31, one ECC block is made up of right and left small ECC blocks, data of different PO groups (PO which belongs to a left small ECC block or that belongs to a right small ECC block) are alternately inserted for respective sectors. Both of the even physical sector structure shown in FIG. 33A and the odd data structure shown in FIG. 33B are divided into two by the center lines. Left “24+1092+24+1092 channel bits” are included in a left small ECC block shown in FIG. 30 or 31, and right “24+1092+24+1092 channel bits” are included in a right small ECC block shown in FIG. 30 or 31.

When the physical sector structure shown in FIGS. 33A and 33B is recorded on the information storage medium, it is serially recorded column by column. Therefore, upon recording channel bit data of, e.g., the even physical sector structure shown in FIG. 33A on the information storage medium, data of 2232 channel bits to be recorded first are included in a left small ECC block, and data of 2232 channel bits to be recorded next are included in a right small ECC block. Furthermore, data of 2232 channel bits to be recorded next are included in a left small ECC block. By contrast, upon recording channel bit data of the odd data structure shown in FIG. 33B on the information storage medium, data of 2232 channel bits to be recorded first are included in a right small ECC block, and data of 2232 channel bits to be recorded next are included in a left small ECC block. Furthermore, data of 2232 channel bits to be recorded next are included in a right small ECC block.

As described above, a characteristic feature of this embodiment lies in that data in one physical sector is alternately assigned to two small ECC blocks for every 2232 channel bits. Put differently, physical sectors are formed by alternately dispersedly allocating data included in right and left small ECC blocks every 2232 channel bits, and are then recorded on the information storage medium. As a result, a structure robust against burst errors can be provided. For example, a state will be examined below wherein a long scratch is formed in the circumferential direction of the information storage medium to cause a burst error that disables to read data over 172 bytes. In this case, since the burst error over 172 bytes is dispersedly allocated in two small ECC blocks, the load on error correction in one ECC block is reduced, thus guaranteeing error correction with better performance.

As shown in FIGS. 33A and 33B, a characteristic feature lies in that the data structure in a physical sector varies depending on whether the physical sector number of a physical sector which forms one ECC block is even or odd. That is, the following structure is adopted.

(1) First 2232-channel bit data of a physical sector belongs to a different small ECC block (right or left).

(2) Data of different PO groups are alternately inserted for respective sectors.

As a result, even after ECC blocks are formed, since a structure in which the data IDs are allocated at the head positions of all physical sectors is guaranteed, the data position upon access can be confirmed at high speed. By inserting PO data that belong to different small ECC blocks into an identical physical sector together, the method and structure that adopt the PO insertion method shown in FIG. 32 are simplified to facilitate information extraction for respective sectors after the error correction processing in the information playback apparatus, and to simplify ECC block data assembly processing in the information recording/playback apparatus.

As a method of practically implementing the aforementioned contents, a structure which has different PO interleave and insertion positions on the right and left sides is adopted. Portions indicated by narrow double lines or by narrow double lines and hatching in FIG. 32 indicate PO interleave and insertion positions. PO is inserted at the last position on the left side for an even physical sector number, and is inserted at the last position on the right side for an odd physical sector number. By adopting this structure, since a structure in which the data IDs are allocated at the head positions of physical sectors is adopted even after ECC blocks are formed, the data position upon access can be confirmed at high speed.

FIG. 35 shows the arrangement of a modulation block.

A code table 352 calculates a codeword X(t) and next state S(t+1) from a dataword B(t) and state S(t) by:
X(t)=H{B(t),S(t)}
S(t+1)=G{B(t),S(t)}

where H is a codeword output function, and G is a next state output function.

A state register 358 receives the next state S(t+1) from the code table 352, and outputs the (current) state S(t) to the code table 352.

Some 12-channel bits in a code conversion table include an asterisk bit “*” and sharp bit “#” together with “0b” and “1b”.

The asterisk bit “*” in the code conversion table indicates that a bit is a merging bit. Some codewords in the conversion table have merging bits at their LSB positions. The merging bit is set to either “0b” or “1b” by a code connector 354 depending on a channel bit which follows the merging bit. If a subsequent channel bit is “0b”, the merging bit is set to “1b”. If a subsequent channel bit is “1b”, the merging bit is set to “0b”.

The sharp bit “#” in the conversion table indicates that a bit is a DSV control bit. The DSV control bit is determined when a DSV controller 356 performs DC component suppression control.

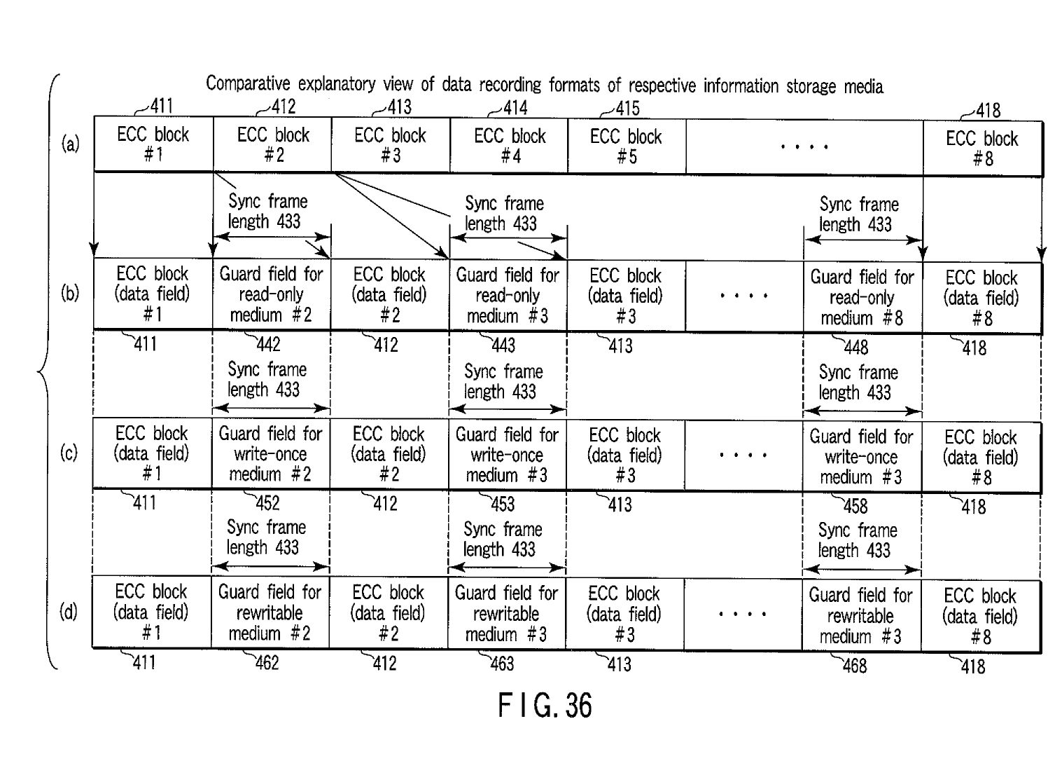

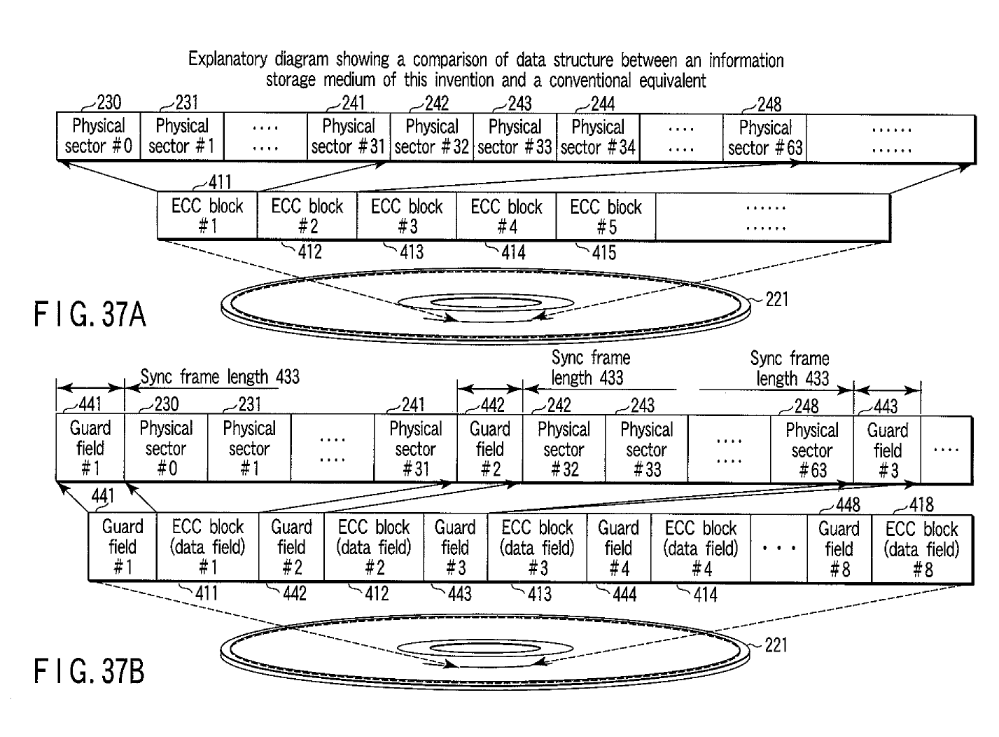

Comparison between the data recording formats of various information storage media in this embodiment will be described below using FIG. 36. (a) in FIG. 36 shows the data recording format in a conventional read-only information storage medium DVD-ROM, conventional write-once information storage medium DVD-R, and conventional rewritable information storage medium DVD-RW. (b) in FIG. 36 shows the data recording format of the read-only information storage medium of this embodiment. (c) in FIG. 36 shows the data recording format of the write-once information storage medium of this embodiment. (d) in FIG. 36 shows the data recording format of the rewritable information storage medium of this embodiment. In the conventional read-only information storage medium DVD-ROM, conventional write-once information storage medium DVD-R, and conventional rewritable information storage medium DVD-RW shown in (a) in FIG. 36, 16 physical sectors form one FCC block. Unlike in the conventional media, in this embodiment shown in (b) to (d) in FIG. 36 and FIG. 32 physical sectors form one ECC block. A characteristic feature of this embodiment lies in that guard fields 442 to 448 having the same length as a sync frame length 433 are assured between neighboring ECC blocks #1 411 to #8 418.

In the conventional read-only information storage medium DVD-ROM, ECC blocks #1 411 to #8 418 are successively recorded, as shown in FIG. 36. Upon executing write-once or rewrite processing called restricted overwrite in the conventional write-once information storage medium DVD-R and conventional rewritable information storage medium DVD-RW to assure the data recording format compatibility to the conventional read-only information storage medium DVD-ROM, some data in an ECC block is destroyed by overwrite, thus posing a problem that the data reliability upon playback impairs considerably. By contrast, like in this embodiment, when the guard fields 442 to 448 are allocated between neighboring data fields (ECC blocks), the overwrite position is restricted to the guard fields 442 to 448, thus preventing data destruction in the data fields (ECC blocks).

The next characteristic feature of this embodiment lies in that the length of each of the guard fields 442 to 448 matches the sync frame length 433 as one sync frame size. As shown in FIGS. 33A to 31, sync codes are allocated at a constant intervals of the sync frame length 433 (1116 channel bits), and the sync code position extraction unit 145 shown in FIG. 14 extracts the sync code position using this constant periodic interval. By matching the length of each of the guard fields 442 to 448 with the sync frame length 433 in this embodiment, since this sync frame interval remains unchanged even when playback access is made to extend over the guard fields 442 to 448, sync code position detection upon playback can be facilitated.

Furthermore, for the purposes of:

(1) improvement of the detection accuracy of the sync code position by matching the frequencies of occurrence of sync codes even at positions that extend over the guard fields 442 to 448; and

(2) easy determination of the positions in physical sectors including the guard fields 442 to 448,

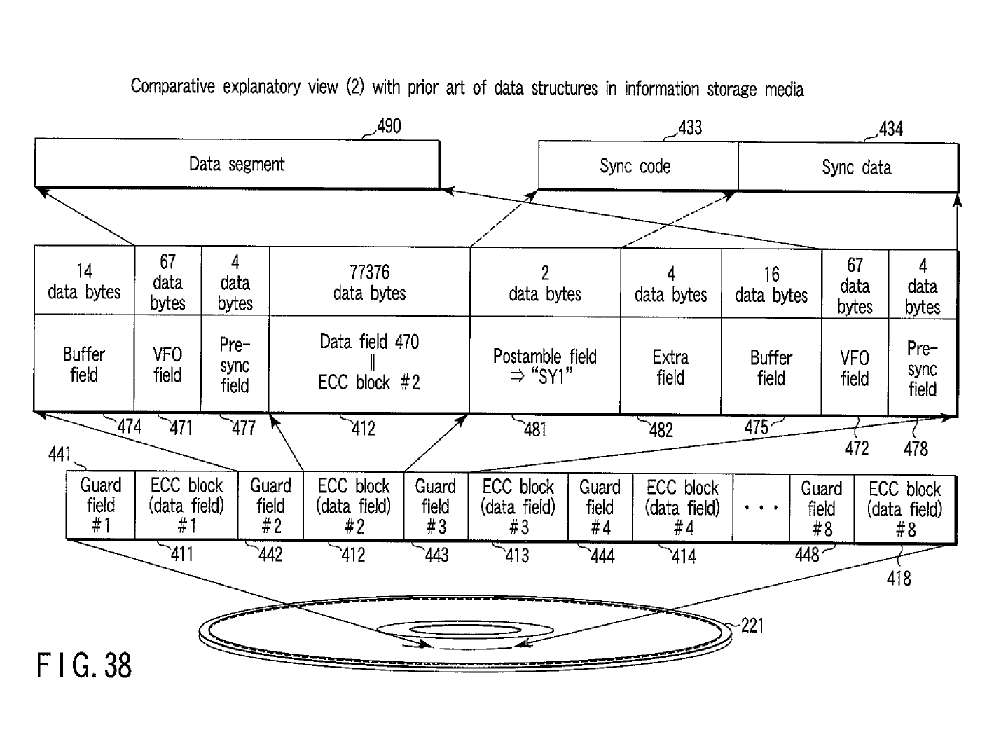

sync codes (sync data) are allocated in the guard fields (point (K2) in FIG. 131). More specifically, as shown in FIG. 38, a postamble field 481 is formed at the start position of the guard fields 442 to 448, and a sync code “SY1” with a sync code number “1” is allocated in that postamble field 481. As can be seen from FIGS. 33A and 33B, combinations of sync code numbers of three successive sync codes in a physical sector are different at all locations. Therefore, not only the position information in a physical sector but also the position in the physical sector as well as that of the guard field can be determined based on the combination of the sync code numbers of three successive sync codes in arbitrary fields.

FIG. 38 shows the detailed structure in the guard field 441 to 448 shown in FIG. 36. A structure in a physical sector includes a combination of a sync code 431 and sync data 432. A characteristic feature of this embodiment lies in that each of the guard fields 441 to 448 also includes a combination of a sync code 433 and sync data 434, and data which is modulated according to the same modulation rules as the sync data 432 in a sector is allocated in the sync data field 434 in the guard field #3 443.

In the present invention, a field in one ECC block #2 412 made up of 32 physical sectors shown in FIG. 30 is called a data field 470.

VFO (Variable Frequency Oscillator) fields 471 and 472 in FIG. 38 are used to attain synchronization of reference clocks of the information playback apparatus or information recording/playback apparatus upon playing back the data field 470. As data contents recorded in the VFO fields 471 and 472, data before modulation by common modulation rules to be described later is repetition of “7Eh”, and a channel bit pattern to be actually recorded after modulation is a repetitive pattern “010001 000100” (a pattern in which a run of three “0”s repeats). In order to obtain this pattern, the first bytes of the VFO fields 471 and 472 must be set in State2 in modulation.

Presync fields 477 and 478 represent the boundary positions between the VFO fields 471 and 472 and the data field 470, and a modulated recorded channel bit pattern is repetition of “100000 100000” (a pattern in which a run of five “0”s repeats). The information playback apparatus or information recording/playback apparatus detects a pattern change position from the repetitive patterns “010001 000100” to “100000 100000” in the presync fields 477 and 478 to recognize the vicinity of the data field 470.

The postamble field 481 indicates the end position of the data field 470, and also the start position of the guard field 443, A pattern in the postamble field 481 matches a pattern of “SY1” in the sync code.

An extra field 482 is used for copy control and illicit copy prevention. If this field is not particularly used for copy control and illicit copy prevention, this field is padded with all “0”s as channel bits.

In buffer fields 474 and 475, data before modulation is the same as in the VFO fields 471 and 472, i.e., a repetition of “7Eh”, and a channel bit pattern to be actually recorded after modulation is a repetitive pattern “010001 000100” (a pattern in which a run of three “0”s repeats). In order to obtain this pattern, the first bytes of the buffer fields 474 and 475 must be set in State2 in modulation.

As shown in FIG. 38, the postamble field 481 that records the pattern of “SY1” corresponds to the sync code field 433, and a field from the extra field 482 immediately after the postamble field 481 to the presync field 478 corresponds to the sync data field 434. A field from the VFO field 471 to the buffer field 475 (i.e., a field including the data field 470 and some of the guard fields before and after the data field 470) is called a data segment 490, and indicate contents different from a “physical segment” to be described later. The data size of each data shown in FIG. 38 is expressed by the number of bytes of data before modulation.

This embodiment is not limited to the structure shown in FIG. 38, and may adopt the following method as another embodiment. That is, the presync field 477 is allocated at the middle position between the VFO fields 471 and 472 the in place of allocating the presync field 477 at the boundary between the VFO field 471 and data field 470. In the other embodiment, a large distance correlation is taken by prolonging the distance between a sync code “SY0” allocated at the head position of the data field 470, and the presync field 477 to set the presync field 477 as a temporary sync position, which is used as distance correlation information (although it is different from the distance between other syncs) of a true sync position. If detection of a true sync fails, a sync is inserted at a position where a true sync is to be detected, which is generated from the temporary sync. A characteristic feature of the other embodiment lies in that the presync field 477 is slightly distant from the true sync (“SY0”). If the presync field 477 is allocated before the VFO fields 471 and 472, since PLL of read clocks is not locked, the role of the presync weakens. Therefore, it is desirable to allocate the presync field 477 at the middle position between the VFO fields 471 and 472.

As described above, upon write-once recording information on a medium on which certain information (data) has been written, in order to losslessly record information on the information storage medium, recording must be done after the last part of the information recorded in advance. In this case, although the information may be partially rewritten, configuration of the information storage medium described in the following embodiment is suited to such case since it especially has a high OW erase ratio. In the era using next-generation large-capacity media, since an information volume to be handled is large, data write-once characteristics in rewritable media are also very important. Using optical recording media of the present invention, media with higher density and higher reliability can be obtained, and recording/playback can be done more stably.

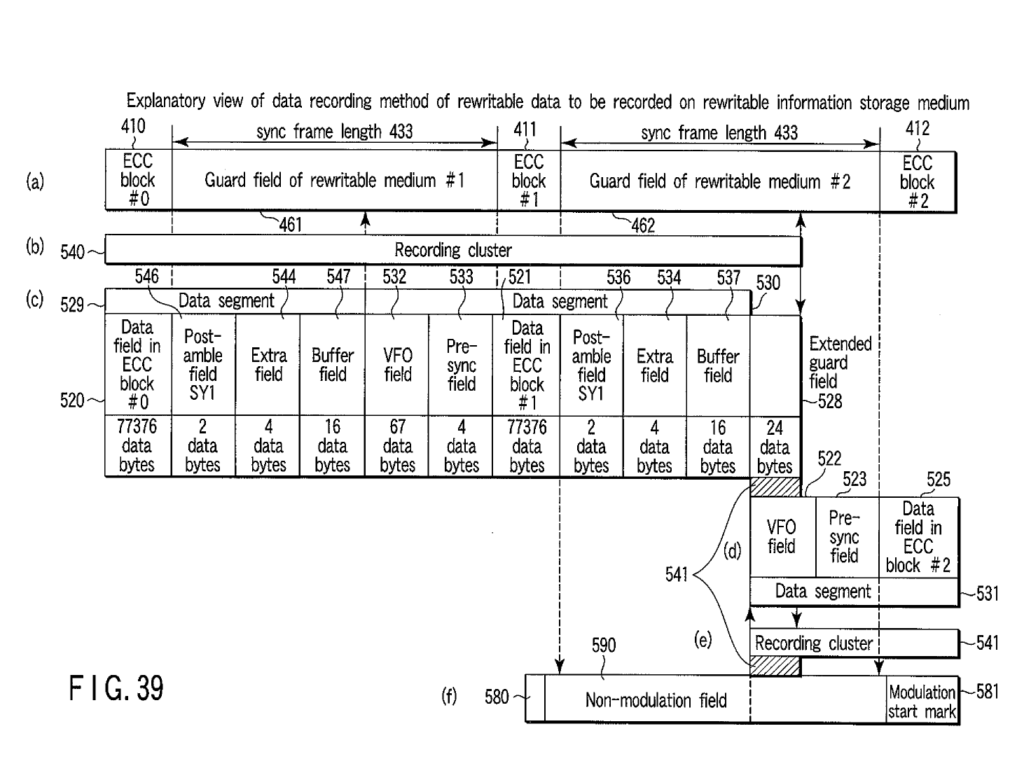

FIG. 39 shows a data recording method used to record rewritable data on the rewritable information storage medium. The layout in a recording cluster in the rewritable information storage medium of this embodiment will be explained using an example that adopts a layout shown in FIG. 39. However, the present invention is not limited to such specific layout, and the rewritable information storage medium may adopt a layout shown in FIG. 39. (a) in FIG. 39 shows the same contents as (d) in FIG. 36 described above. In this embodiment, rewrite processing associated with rewritable data is done for respective recording clusters 540 and 541 shown in (b) and (e) in FIG. 39. One recording cluster includes one or more data segments 529 to 531 and an extended guard field 528 which is allocated at the last position of the recording cluster, as will be described later. That is, the start position of one recording cluster 541 matches that of the data segment 531, and starts from a VFO field 522.

Upon continuously recording a plurality of data segments 529 and 530, since the plurality of data segments 529 and 530 are successively allocated in one recording cluster 540, and a buffer field 547 located at the last position of the data segment 529 is contiguous with a VFO field 532 located at the head position of the next data segment, their phases (of recording reference clocks upon recording) match, as shown in FIGS. 39B and 39C. Upon completion of continuous recording, the extended guard field 528 is allocated at the last position of the recording cluster 540. The data size of the extended guard field 528 has a size for 24 data bytes as data before modulation.

As can be seen from correspondence between

FIGS. 39A and 39C, rewritable guard fields 461 and 462 include postamble fields 546 and 536, extra fields 544 and 534, buffer fields 547 and 537, VFO fields 532 and 522, and presync fields 533 and 523, and the extended guard field 528 is allocated only at the continuous recording end position.

In order to compare the physical ranges of rewrite units, (c) in FIG. 39 shows some fields of the recording cluster 540 as an information rewrite unit, and (d) in FIG. 39 shows some fields of the recording cluster 541 as the next rewrite unit. A characteristic feature of this embodiment lies in that rewrite processing is done so that the extended guard field 528 and the VFO field 522 on the rear side partially overlap each other at an overlapping portion 541 upon rewrite (point (K3)). By rewriting information by partially overlapping the fields, a gap (a field where no recording marks are formed) can be prevented from being generated between the recording clusters 540 and 541 to remove any interlayer crosstalk in a single-sided, dual-recording layer recordable information storage medium, thus detecting a stable playback signal.

A rewritable data size in one data segment in this embodiment is given by:
67+4+77376+2+4+16=77469 data bytes (2)

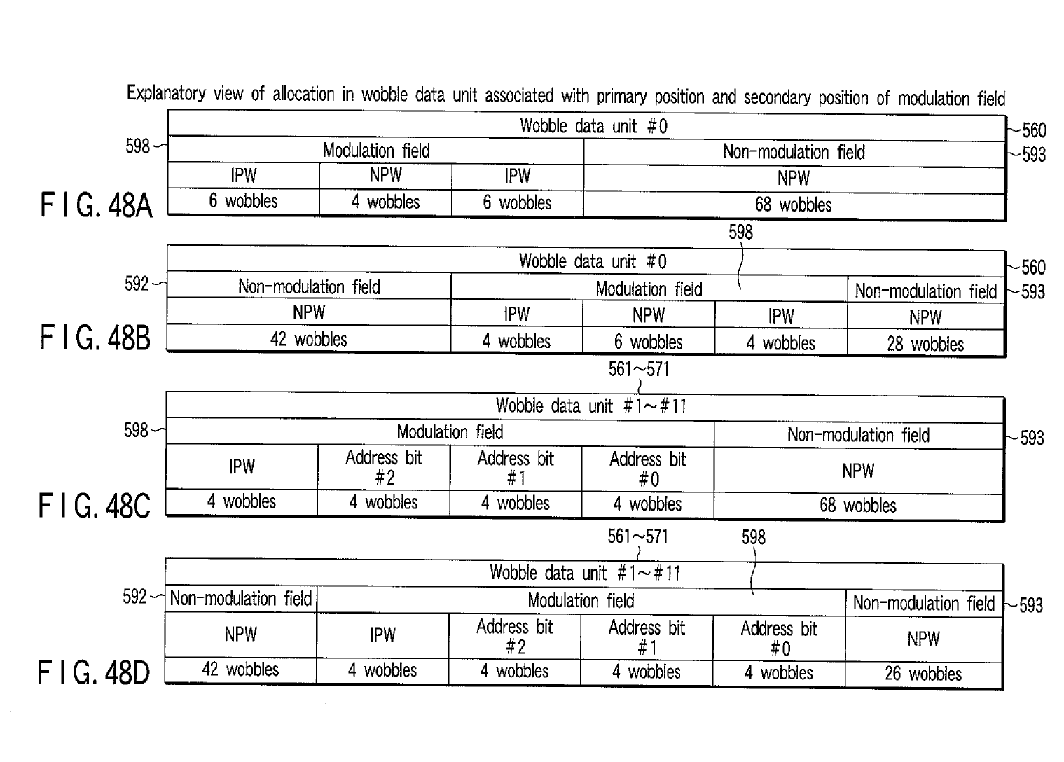

As can be seen from FIGS. 48A and 48B, one wobble data unit 560 is formed of:
6+4+6+68=84 wobbles (3)

Seventeen wobble data units form one physical segment 550, and a length of seven physical segments 550 to 556 matches that of one data segment 531. Hence, within the length of one data segment 531,
84×17×7=9996 wobbles (4)

are allocated. Therefore, from equations (2) and (4), one wobble corresponds to:
77496÷9996=7.75 data bytes/wobble (5)

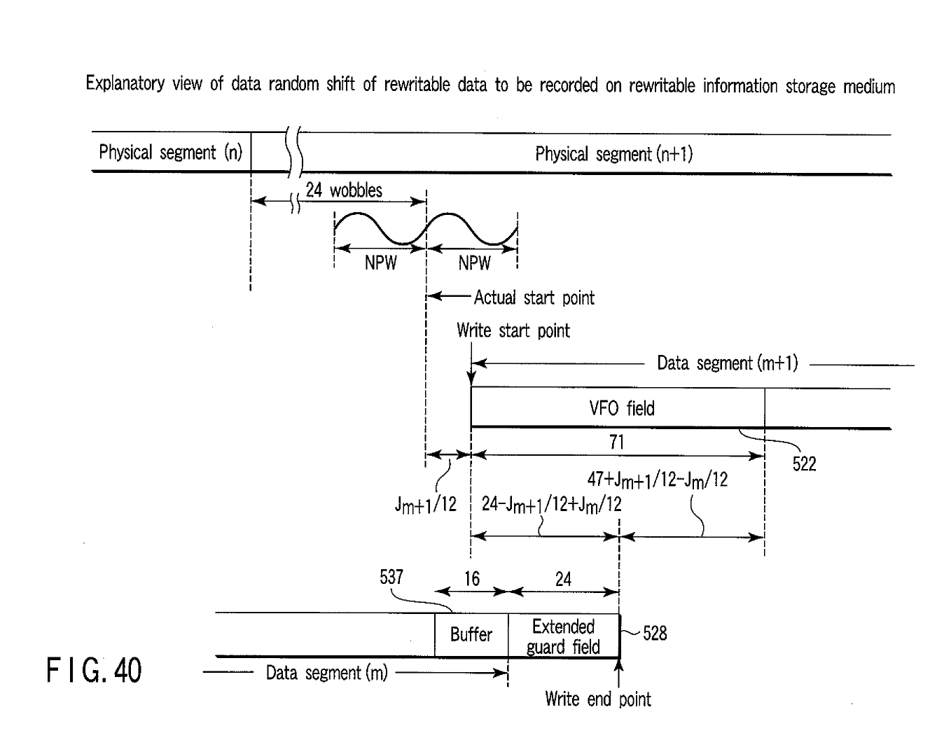

As shown in FIG. 40, the overlapping portion between the next VFO field 522 and extended guard field 528 is located after 24 wobbles from the head position of a physical segment. A field for 16 wobbles from the head position of a physical segment 550 corresponds to a wobble sync field, but a subsequent field for 68 wobbles locates within a non-modulation field 590. Therefore, the overlapping portion between the next VFO field 522 and extended guard field 528 locates within the non-modulation field 590. In this way, by locating the head position of a data segment after 24 wobbles from the head position of the physical segment, not only the overlapping portion locates within the non-modulation field 590 but also a detection time of the wobble sync field 580 and a preparation time of recording processing can be assured properly, thus guaranteeing stable, precise recording processing.

Each recording film of the rewritable information storage medium of this embodiment uses a phase change recording film. In the phase change recording film, since its deterioration starts in the vicinity of a rewrite start/end position, if recording start/recording end is repeated at the same positions, the number of rewrite times is restricted due to deterioration of the recording film. In this embodiment, in order to understate the problem, the recording start position is randomly shifted upon rewrite by (jₘ₊₁/12) data bytes, as shown in FIG. 40.

In FIG. 39, to explain the basic concept, the head position of the extended guard field 528 matches that of the VFO field 522. However, in this embodiment, strictly speaking, the head position of the VFO field 522 is randomly shifted, as shown in FIG. 40.

A DVD-RAM disc as the current rewritable information storage medium also uses a phase change recording film as a recording film, and randomly shifts the recording start/end position to improve the number of rewrite times. A maximum shift amount range upon making a random shift in the current DVD-RAM disc is set to be 8 data bytes. The average channel bit length (as modulated data to be recorded on a disc) on the current DVD-RAM disc is set to be 0.143 Mm. In the rewritable information storage medium of this embodiment, the average channel bit length is given, from FIG. 22, by:
(0.087+0.093)÷2=0.090 μm (6)

When the length of the physical shift range matches the current DVD-RAM disc, a minimum required length as the random shift range of this embodiment is given, using the above values, by:
8 bytes×(0.143 μm÷0.090 μm)=12.7 bytes (7)

In this embodiment, in order to assure easy playback signal detection processing, the unit of the random shift amount matches the “channel bits” after modulation. In this embodiment, since modulation adopts ETM modulation (Eight to Twelve modulation) for converting 8 bits to 12 bits, a random shift amount is mathematically expressed, with reference to data bytes, as:
Jm/12 data bytes (8)

Since a value that Jm can assume is, using the value of equation (7):
2.7×12=152.4 (9)

Jm ranges from 0 to 152. From the above reasons, the length of the random shift range matches the current DVD-RAM disc and can guarantee the same number of rewrite times as in the current DVD-RAM disc, as long as it satisfies equation (9). In this embodiment, in order to assure the number of rewrite times more than the current disc, a small margin is provided to the value of equation (7) to set:
Length of random shift range=14 data bytes (10)

since substitution of the value of equation (10) into equation (8) yields 14×12=168, we set:
Value that Jm can assume=0 to 167 (11)

Since the random shift amount is set to have a range larger than Jm/12 (0≦Jm≦154), as described above, equation (9) is satisfied, and the length of the physical range corresponding to the random shift amount matches the current DVD-RAM disc. Hence, the same number of repetitive recording times as in the current DVD-RAM can be assured.

In FIG. 39, the lengths of the buffer field 547 and VFO field 532 in the recording cluster 540 are constant. Random shift amounts Jm of all the data segments 529 and 530 in the identical recording cluster 540 assume the same value everywhere. Upon continuously recording one recording cluster 540 including many data segments, the recording position is monitored from wobbles. At this time, a wobble slip (to record at a position shifted for one wobble period) infrequently occurs due to a count error of wobbles or rotation nonuniformity of a rotation motor (e.g., Motor in FIG. 14) which rotates the information storage medium, and the recording position on the information storage medium is shifted. The information storage medium of this embodiment is characterized in that upon detection of the recording position shift generated in this way, the adjustment is made in the guard field 461 in FIG. 39 or a write-once guard field 452 shown in FIG. 36C to correct the recording timing. In FIG. 39, the postamble field 546, extra field 544, and presync field 533 record important information that does not allow bit omissions or duplications. However, since the buffer field 547 and VFO field 532 record repetitions of specific patterns, they allow an omission or duplication of only one pattern as long as the repetition boundary position is assured. Therefore, in this embodiment, adjustment is made in the guard field 461 and especially in the buffer field 547 or VFO field 532 in the guard area, thus correcting the recording timing.

As shown in FIG. 40, in this embodiment, an actual start point position as a reference for a position setting is set to match the (wobble central) position with a wobble amplitude “0”. However, since the wobble position detection accuracy is low, as described as “±1 max”, this embodiment permits the actual start point position to have a maximum of:
shift amount up to “±1 data byte” (12)

Let Jm be a random shift amount in the data segment in FIGS. 39 and 40 (as described above, all the random shift amounts in the data segment 529 in the recording cluster 540 match), and Jm+1 be a random shift amount of the data segment 531 to be additionally recorded later. As a value that Jm and Jm+1 given by equation (11) can assume, an intermediate value is assumed, i.e., Jm=Jm+1=84. When the positional accuracy of the actual start point is sufficiently high, the start position of the extended guard field 528 matches that of the VFO 522, as shown in FIG. 39.

By contrast, when the data segment 530 is recorded at a maximally rear position, and the data segment 531 which is additionally recorded or rewritten later is recorded at a maximally front position, the head position of the VFO field 522 may enter the buffer field 537 by a maximum of 15 data bytes based on the value clearly specified in equation (10) and the value of expression (12). The extra field 534 immediately before the buffer field 537 records specific important information. Therefore, in this embodiment:
length of buffer field 527 requires 15 data bytes or more (13)

In the embodiment shown in FIG. 39, a margin for one data byte is added, and the data size of the buffer field 537 is set to be 16 data bytes.

If a gap is formed between the extended guard field 528 and VFO field 522 as a result of random shift, it causes interlayer crosstalk upon playback when the single-sided, double-recording layer structure is adopted. For this reason, even when the random shift is made, the extended guard field 528 and VFO field 522 partially overlap each other so as not to form any gap. Therefore, in this embodiment, the length of the extended guard field 528 must be set to be 15 data bytes or more from the same reason as in expression (13). Since the VFO field 522 which follows has a sufficiently large length of 71 data bytes, no problem is posed upon playback even when the overlapping area between the extended guard field 528 and VFO field 522 becomes broader slightly (since a sufficiently long time to synchronize playback reference clocks in the non-overlapping VFO field 522 is assured). Therefore, the extended guard field 528 can be set to have a value larger than 15 data bytes. In case of continuous recording, a wobble slip infrequently occurs, and the recording position is shifted for one wobble period, as described above. Since one wobble period corresponds to 7.75 (≈8) data bytes, this embodiment considers expression (13) and this value, and sets:
length of extended guard field 528 to be (15+8=)23 data bytes or more (14)

In the embodiment shown in FIGS. 39A to 39F, a margin for one data byte is added as in the buffer field 537, and the length of the extended guard field 528 is set to be 24 data bytes.

In FIG. 39, the recording start position of a recording cluster 541 must be accurately set. The information recording/playback apparatus of this embodiment detects this recording start position using wobble signals recorded in advance on the rewritable or write-once information storage medium. In all fields other than the wobble sync field 580, patterns change from NPWs to IPWs for every four wobbles. By contrast, since the wobble switching unit is partially shifted from four wobbles in the wobble sync field 580, the position of the wobble sync field 580 can be detected most easily. For this reason, after detection of the position of the wobble sync field 580, the information recording/playback apparatus of this embodiment performs a preparation for recording processing, and starts recording. For this purpose, the start position of the recording cluster 541 must be located in the non-modulation field 590 immediately after the wobble sync field 580. FIG. 40 shows such contents. The wobble sync field 580 is allocated immediately after switching of a physical segment. The length of the wobble sync field 580 amounts to 16 wobble periods. After detection of the wobble sync field 580, eight wobble periods are required in prospect of a margin for the preparation of recording processing. Therefore, the head position of the VFO field 522 which is located at the head position of the recording cluster 541 must be allocated at a position 24 wobbles or more after the switching position of a physical segment even in consideration of random shift.

As shown in FIG. 39, at the overlapping position 541 upon rewrite processing, recording processing is repeated a number of times. When rewrite processing is repeated, the physical shape of a wobble groove or wobble land changes (deteriorates), and the quality of a wobble playback signal from there drops. In this embodiment, as shown in FIG. 39, the overlapping position 541 upon rewrite or write-once recording processing is avoided from being recorded in the wobble sync field 580 and wobble address field 586, but is recorded in the non-modulation field 590. Since given wobble patterns (NPW) are merely repeated in the non-modulation field 590, even when the wobble playback signal quality partially deteriorates, the deteriorated wobble playback signal can be interpolated using neighboring wobble playback signals. Since the overlapping position 541 upon rewrite or write-once recording processing is set to be located in the non-modulation field 590, deterioration of the wobble playback signal quality due to the shape deterioration in the wobble sync field 580 or wobble address field 586 can be prevented, and a stable wobble detection signal from wobble address information 610 can be guaranteed.

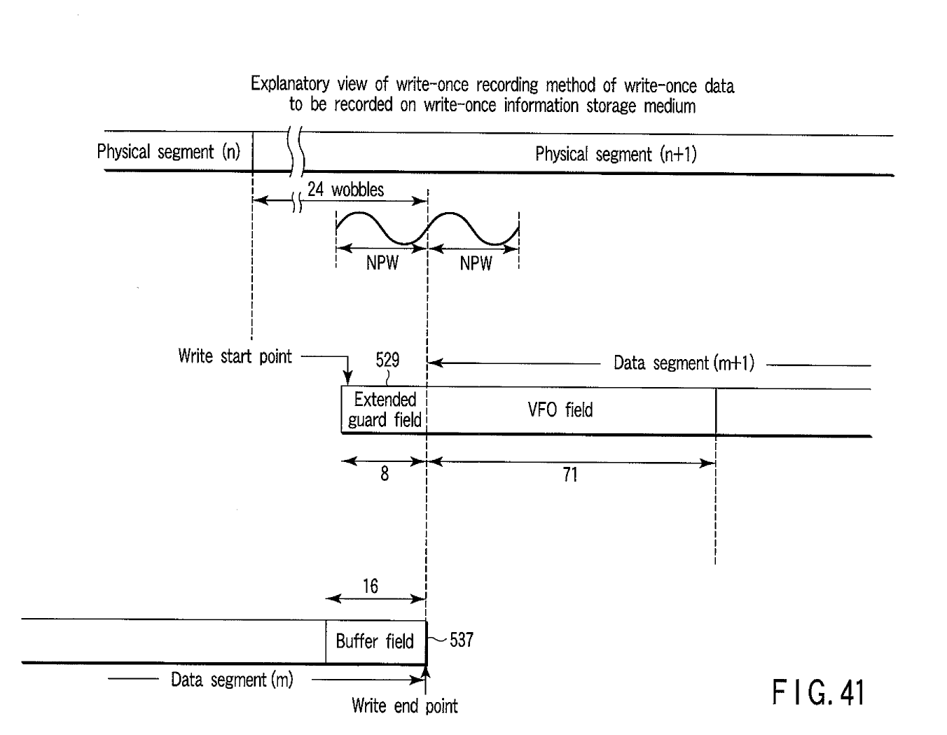

FIG. 41 shows an embodiment of a write-once recording method of write-once data to be recorded on the write-once information storage medium. The write-once information storage medium does not require any random shift described above, since recording is done only once. On the write-once information storage medium, the head position of a data segment is set to be located after 24 wobbles from the head position of the physical segment, as shown in FIG. 40, so that the overwrite position is located in the wobble non-modulation field.

The relationship from the structure in one data frame shown in FIG. 29 to the PO interleave method shown in FIG. 32 will be described in detail below using FIG. 42. FIG. 42 allows to observe the relation of conversions from FIG. 29 to FIG. 32 at a glance by enlarging the upper part of the ECC block structure view after PO interleave shown in FIG. 32, and clearly specifying the allocation positions of the data ID, IED, RSV, and EDC shown in FIG. 29 in the enlarged view. “0-L”, “0-R”, “1-R, and “1-L” in FIG. 42 correspond to those in FIG. 31. Each of “0-L” and “1-L” means data after only main data in the left half in FIG. 29, i.e., a 172 bytes×6 rows block on the left side of the center line, is scrambled. Likewise, each of “0-R” and “1-R” means data after only main data in the right half in FIG. 29, i.e., a 172 bytes×6 rows block on the right side of the center line, is scrambled. Therefore, as can be seen from FIG. 29, the data ID, IED, and RSV are arranged in turn up to the 12th byte in the first row (0th row) of “0-L” or “1-L”.

In FIG. 42, the left side from the central line forms left small ECC block A, and the right side from the central line forms right small ECC block B. Therefore, as can be seen from FIG. 42, data ID#1, data ID#2, IED#0, IED#2, RSV#0, and RSV#2 included in “0-L” and “2-L” are included in left small ECC block A. In FIG. 31, “0-L” and “2-L” are allocated on the left side, and “0-R” and “2-R” are allocated on the right side, while the allocation of “1-R” and “1-L” is reserved: “1-L” is allocated at the right side, and “1-R” is allocated at the right side. Since data ID#1, IED#1, and RSV#1 are allocated up to the 12th bytes from the head of the first row in “1-L”, since the right-left allocation is reversed, data ID#1, IED#1, and RSV#1 included in “1-L” are recorded in right small ECC block B.

In this embodiment, a combination of “0-L” and “0-R” in FIG. 42 is called a “0th recording frame” and a combination of “1-L” and “1-R” is called a “first recording frame”. The boundary between neighboring recording frames is indicated by the bold line in FIG. 42. As can be seen from FIG. 42, the data ID is allocated at the head of each recording frame, and PO and PI-L are allocated at the last of each recording frame. As shown in FIG. 42, a characteristic feature lies in that odd and even recording frames include different small ECC blocks which include the data IDs, and the data ID, IED, and RSV are alternately allocated in left and right small ECC blocks as the recording frames continue. Error correction capability in one small ECC block is limited, and error correction is disabled against random errors exceeding a specific count or a burst error exceeding a specific length. As described above, by alternately allocating the data ID, IED, and RSV in left and right small ECC blocks A and B, the playback reliability of the data ID can be improved. That is, even when many defects are generated on the information storage medium, error correction of either of the left and right small ECC blocks is disabled, and the data ID that belongs to the disabled small ECC block cannot be decoded, since the data ID, IED, and RSV are alternately allocated in left and right small ECC blocks, the other small ECC block can perform error correction and can decode the remaining data ID. Since address information in the data ID has continuity, information of the data ID which cannot be decoded can be interpolated using information of the decodable data ID, As a result, the access reliability can be improved by the embodiment shown in FIG. 42. Numbers in parentheses on the left side of FIG. 42 indicate row numbers in an ECC block after PO interleave. Upon recording on the information storage medium, recording is sequentially done from left to right in the order of row numbers. Since the data IDs included in respective recording frames in FIG. 42 are always allocated at a constant interval, the data ID position searchability can be improved.

FIGS. 33A and 33B show the physical sector structure. FIG. 33A shows an even physical sector structure, and FIG. 33B shows an odd data structure. In FIGS. 33A and 33B, outer parity PO information shown in FIG. 32 is inserted into sync data fields in the last two sync frames (that is, a frame including the last sync code SY3 and next sync data, and a frame including the sync code SY1 and next sync data) in each of even and odd recording data fields.

Some bytes of PO on the left side shown in FIG. 31 are inserted into the last two sync frames in the even recording data field, and some bytes of PO on the right side shown in FIG. 31 are inserted into the last two sync frames in the odd recording data field. As shown in FIG. 31, one ECC block is made up of right and left small ECC blocks, data of different PO groups (PO which belongs to a left small ECC block or a right small ECC block) are alternately inserted for respective sectors. Both of the even physical sector structure shown in FIG. 33A and the odd data structure shown in FIG. 33B are divided into two by the center lines. Left “24+1092+24+1092 channel bits” are included in a left small ECC block shown in FIG. 30 or 31, and right “24+1092+24+1092 channel bits” are included in a right small ECC block shown in FIG. 30 or 31.

When the physical sector structure shown in FIGS. 33A and 33B is recorded on the information storage medium, it is serially recorded column by column. Therefore, upon recording channel bit data of, e.g., the even physical sector structure shown in FIG. 33A on the information storage medium, data of 2232 channel bits to be recorded first are included in a left small ECC block, and data of 2232 channel bits to be recorded next are included in a right small ECC block. Furthermore, data of 2232 channel bits to be recorded next are included in a left small ECC block. By contrast, upon recording channel bit data of the odd data structure shown in FIG. 33B on the information storage medium, data of 2232 channel bits to be recorded first are included in a right small ECC block, and data of 2232 channel bits to be recorded next are included in a left small ECC block. Furthermore, data of 2232 channel bits to be recorded next are included in a right small ECC block.

As described above, a characteristic feature of this embodiment lies in that data in one physical sector is alternately assigned to two small ECC blocks for every 2232 channel bits. Put differently, physical sectors are formed by alternately dispersedly allocating data included in right and left small ECC blocks every 2232 channel bits, and are then recorded on the information storage medium. As a result, a structure robust against burst errors can be provided. For example, a state will be examined below wherein a F long scratch is formed in the circumferential direction of the information storage medium to cause a burst error that disables to read data over 172 bytes. In this case, since the burst error over 172 bytes is dispersedly allocated in two small ECC blocks, the load on error correction in one ECC block is reduced, thus guaranteeing error correction with better performance.

As shown in FIGS. 33A and 33B, a characteristic feature lies in that the data structure in a physical sector varies depending on whether the physical sector number of a physical sector which forms one ECC block is even or odd. That is, the following structure is adopted.

(1) First 2232-channel bit data of a physical sector belongs to a different small ECC block (right or left)

(2) Data of different PC groups are alternately inserted for respective sectors.

As a result, even after ECC blocks are formed, since a structure in which the data IDs are allocated at the head positions of all physical sectors is guaranteed, the data position upon access can be confirmed at high speed. By inserting PO data that belong to different small ECC blocks into an identical physical sector together, the method and structure that adopt the PO insertion method shown in FIG. 32 are simplified to facilitate information extraction for respective sectors after the error correction processing in the information playback apparatus, and to simplify ECC block data assembly processing in the information recording/playback apparatus.

As a method of practically implementing the aforementioned contents, a structure which has different PO interleave and insertion positions on the right and left sides is adopted. Portions indicated by narrow double lines or by narrow double lines and hatching in FIG. 32 indicate PO interleave and insertion positions. PO is inserted at the last position on the left side for an even physical sector number, and is inserted at the last position on the right side for an odd physical sector number. By adopting this structure, since a structure in which the data IDs are allocated at the head positions of physical sectors is adopted even after ECC blocks are formed, the data position upon access can be confirmed at high speed.

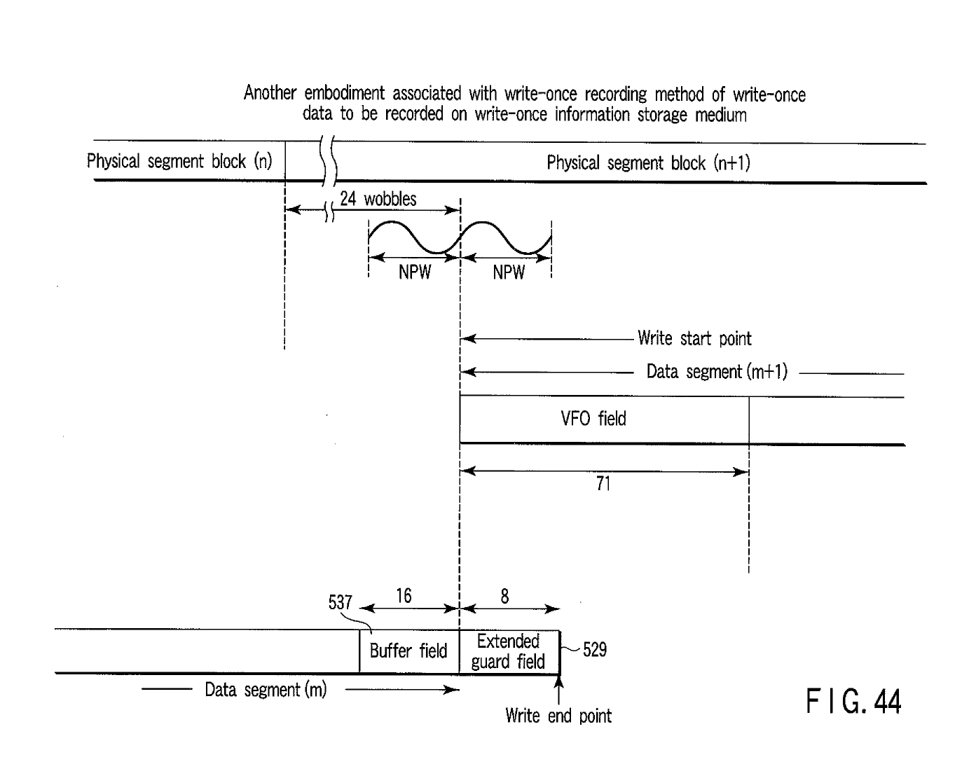

FIG. 44 shows another embodiment associated with the write-once recording method on the write-once information storage medium shown in FIG. 41.

A position 24 wobbles after the boundary position of a physical segment block is a write start point. As new data to be write-once recorded from here, after a VFO field for 71 data bytes is formed, a data field in an ECC block is recorded. This write start point matches the end position of the buffer field 537 of recorded data of the immediately preceding recording, and a position behind a position where the extended guard field 528 is formed for a length of 8 data bytes becomes the recording end position (write end point) of the write-once data. Therefore, upon write-once recording data, the extended guard field 529 recorded by the immediately preceding recording and a new VFO field to be write-once recorded are recorded to overlap each other for 8 data bytes.

A case using the groove recording method as the method (b) will be described below. Some descriptions redundant to those of the method are omitted.

Table 12 is a recording timing parameter setting table.

In this embodiment, the parameter setting ranges are defined by:
0.25T≦TSFP≦1.50T (30)
0.00T≦TELP≦1.00T (31)
1.00T≦TEFP≦1.75T (32)
−0.10T≦TSLP≦1.00T (33)
0.00T≦TLC≦1.00T (34)
0.15T≦TMP≦0.75T (35)

Furthermore, in this embodiment, the parameter values can be changed in accordance with the mark length of a recording mark and its leading and trailing space lengths, as shown in Table 12.

Based on the parameter values and the like determined as described above, “optimal recording conditions (information of the write strategy) for a given storage medium of a drive that has made trial writes in the drive test zone DRTZ” can be determined.

Tables 13, 14, 15, and 16 respectively show a general parameter setting example in the read-only information storage medium, that in the write-once information recording medium, and that in the rewritable information recording medium.

Table 13 shows parameter values of this embodiment in the read-only information storage medium. Table 14 shows parameter values of this embodiment in the write-once information storage medium. Table 15 shows parameter values in rewritable information storage medium. As can be seen from comparison between Table 13 or 14 and Table 15 (especially, comparison of (B) parts), The rewritable information storage medium has a larger recording capacity than the read-only or write-once information storage medium by decreasing the track pitch and increasing the linear density (data bit length). As will be described later, since the rewritable information storage medium adopts land/groove recording, the track pitch is decreased by reducing the influence of crosstalk between neighboring tracks. All of the read-only, write-once, and rewritable information storage media are characterized in that the data bit length and track pitch (corresponding to the recording density) of the system lead-in/out areas SYLDI/SYLDO are set to be larger than those of the data lead-in/out areas DTLDI/DTLDO (to decrease the recording density).

Table 16 shows the detailed information contents in the physical format information PFI or R-physical format information R_PFI and comparison based on the medium types (read-only, rewritable, or write-once) of information in the physical format information PFI. Information 267 commonly recorded for all of the read-only, rewritable, and write-once media in the common information 261 in a DVD family sequentially records, from byte positions 0 to 16, book type (read-only/rewritable/write-once) information and version number information, a medium size (diameter) and maximum data transfer rate information, a medium structure (single layer or double layers, the presence/absence of embossed pits/write-once area/rewritable area), recording density (linear density and track density) information, allocation position information of the data area DTA, and presence/absence information (present for all the media in this embodiment) of the burst cutting area BCA.

Information 268 commonly recorded for the rewritable and write-once media in the common information 261 in a DVD family sequentially records, from the 28th byte to the 31st byte, revision number information which specifies a maximum recording speed, revision number information which specifies a minimum recording speed, a revision number table (applied revision number), class state information, and extended (part) version information. A characteristic feature of this embodiment lies in that providing the information from the 28th byte to the 31st byte is to provide the revision information according to the recording speed in the recording area of the physical format information PFI or R-physical format information R_PFI.

Tables 17 and 18 are tables for explaining another embodiment associated with the physical format information and R-physical format information, and showing a general parameter setting example in a write-once information storage medium.

Table 17 shows another embodiment associated with the data structure in the physical format information and R-physical format information. Table 17 also describes “updated physical format information” for the purpose of comparison. In Table 17, a field from the 0th byte to the 31st byte is used as a recording field of the common information 269 in a DVD family, and a field from the 32nd byte is set for respective books.

Note that as for the physical format information of the HD_DVD-R (the R-physical format information in Table 17), some of byte positions (BP) 256 to 263 in Table 17 are configured to describe the PSN of the start position (corresponding to the start physical segment number of the current border out) of the border zone and that of the updated start position (corresponding to the start physical segment number of the next border out) as in byte positions 197 to 511 in Table 16.

Although not shown, a byte position (BP) 32 of Table 17 describes an actual maximum reading speed guaranteed on the disc of interest. At the BP 32, for example, “0001010b” corresponds to lx, which indicates the channel bit rate of 64.8 Mbps. The actual maximum reading speed is calculated by Value×( 1/10).

Although not shown, a byte position (BP) 33 can describe “layer format table” in association with the physical format of the HD_DVD-R (double-layer disc having layers 0 and 1). This table can have an 8-bit configuration, 3 bits of which indicate the format of layer 0 (the HD_DVD-R format if these 3 bits are 000b), and other 3 bits of which indicate the format of layer 1 (the HD_DVD-R format if these 3 bits are 000b). In case of a single-sided, single-layer R disc, the layer format table at the BP 33 is ignored.

Furthermore, although not shown, byte positions (BP) 133 to 151 of Table 17 can describe the following information. That is, the BPs 133 to 148 describe an actual value of an i-th (i=1, 2, . . . , 16) recording speed. Note that “i-th” indicates the i-th minimum speed of speeds available on the disc of interest. Therefore, the BP 133 as i=1 describes the lowest recording speed. At the BPs 133 to 148, the first to 16th fields are prepared for “i”, and may have no entries. For example, if a certain field describes “00000000b” (no i-th recording speed is available), this means that the byte of the (i-th) field is reserved. Note that the i-th recording speed is calculated by Value×( 1/10).

A BP 149 describes the reflectivity or reflectance of the data area. If the BP 149 describes, e.g., “00101000b”, this means that the reflectivity is 20%. The actual reflectivity is calculated by Value×(½) (%)

A BP 150 describes information of a push-pull signal including a bit of a track shape. If the track shape bit is “0b”, this indicates that the track of interest is present on a groove. If this bit is “1b”, this indicates that the track of interest is present on a land. If 7 bits that represent a push-pull signal is “0101000b”, the value of the push-pull signal is, e.g., “0.40”. An actual amplitude value ((I1−I2)PP/(I1+I2)DC to be described later) of the push-pull signal is calculated by Value×( 1/100).

A BP 151 describes an amplitude of “on-track signal”. If the BP 151 describes “01000110b”, this indicates that the amplitude of the on-track signal is “0.70”. An actual amplitude value of the on-track signal is calculated by Value×( 1/100).

TABLE 12
Recording pulse timing parameter setting table

| | | | Mark length | | |
|---|---|---|---|---|---|
| | | | 2T | 3T | ³4T |
| (a) | T_{LC} table | | a | b | c |
| (b) | T_{SFP} table | | | | |
| | Leading space length | 2T | d | e | f |
| | | 3T | g | h | i |
| | | 3_{4T} | j | k | l |
| (c) | T_{ELP} table | | | | |
| | Trailing space length | 2T | m | n | o |
| | | 3T | p | q | r |
| | | 3_{4T} | s | t | u |

TABLE 13
General parameter setting example in
read-only information storage medium

| | | Single-layer | Double-layer |
|---|---|---|---|
| Parameter | | structure | structure |
| User usable recording capacity | | 15 Gbytes/side | 30 Gbytes/side |
| Use wavelength | | 405 | nm |
| NA (Numerical Aperture) value | | 0.65 | |
| of objective lens | | | |
| Data bit length | (A) | 0.306 | μm |
| | (B) | 0.153 | μm |
| Channel bit length | (A) | 0.204 | μm |
| | (B) | 0.102 | μm |
| Minimum pit length (2T) | (A) | 0.408 | μm |
| | (B) | 0.204 | μm |
| Maximumm pit length (13T) | (A) | 2.652 | μm |
| | (B) | l.326 | μm |
| Track pitch | (A) | 0.68 | μm |
| | (B) | 0.40 | μm |
| Outer diameter of information | | 120 | mm |
| storage medium | | | |
| Total thickness of information | | 0.60 × 2 | mm |
| storage medium | | | |
| Outer diameter of center hole | | 15.0 | mm |
| Inner radius of data area DTA | | 24.1 | mm |
| Outer radius of data area DTA | | 58.0 | mm |
| User data size per sector | | 2048 | bytes |
| ECC | | Reed-Solomon Product code | |
| (Error Correction Code) | | RS(208, 192, 17) × (182, 172, 11) | |
| ECC block size | | 32 physical sectors | |
| Modulation method | | ETM, RLL (1, 10) | |
| Error-correctable error length | | 7.1 | mm |
| Linear velocity | | 6.61 | m/s |
| Channel bit transfer rate | (A) | 32.40 | Mbps |
| | (B) | 64.80 | Mbps |
| User data transfer rate | (A) | 18.28 | Mbps |
| | (B) | 36.55 | Mbps |

(A) means numerical value in system lead-in area SYLDI and system lead-out area SYLDO, and
(B) means numerical value in data lead-in area DTLDI, data area DTA, data lead-out area DTLDO, and middle area MDA

TABLE 14
General parameter setting example in
write-once information storage medium

| Parameter | | Single-layer structure | |
|---|---|---|---|
| User usable recording capacity | | 15 | Gbytes/side |
| Use wavelength | | 405 | nm |
| NA value of objective lens | | 0.65 | |
| Data bit length | (A) | 0.306 | μm |
| | (B) | 0.153 | μm |
| Channel bit length | (A) | 0.204 | μm |
| | (B) | 0.102 | μm |
| Minimum mark/pit length (2T) | (A) | 0.408 | μm |
| | (B) | 0.204 | μm |
| Maximum mark/pit length (13T) | (A) | 2.652 | μm |
| | (B) | 1.326 | μm |
| Track pitch | (A) | 0.68 | μm |
| | (B) | 0.40 | μm |
| Physical address setting | (B) | Wobble address | |
| method | | | |
| Outer diameter of information | | 120 | mm |
| storage medium | | | |
| Total thickness of information | | 1.20 | mm |
| storage medium | | | |
| Outer diameter of center hole | | 15.0 | mm |
| Inner radius of data area DTA | | 24.1 | mm |
| Outer radius of data area DTA | | 58.0 | mm |
| Sector size | | 2048 | bytes |
| ECC | | Reed-Solomon Product code | |
| (Error Correction Code) | | RS(208, 192, 17) × (182, 172, 11) | |
| ECC block size | | 32 physical sectors | |
| Modulation method | | ETM, RLL (1, 10) | |
| Error-correctable error length | | 7.1 | mm |
| Linear velocity | | 6.61 | m/s |
| Channel bit transfer rate | (A) | 32.40 | Mbps |
| | (B) | 64.80 | Mbps |
| User data transfer rate | (A) | 18.28 | Mbps |
| | (B) | 36.55 | Mbps |

(A) means numerical value in system lead-in area SYLDI, and
(B) means numerical value in data lead-in area DTLDI, data area DTA, and data lead-out area DTLDO

TABLE 15
General parameter setting example in
rewritable information storage medium

| Parameter | | Single-layer structure | |
|---|---|---|---|
| User usable recording capacity | | 20 | Gbytes/side |
| Use wavelength | | 405 | nm |
| NA value of objective lens | | 0.65 | |
| Data bit length | (A) | 0.306 | μm |
| | (B) | 0.130 to 0.140 | μm |
| Channel bit length | (A) | 0.204 | μm |
| | (B) | 0.087 to 0.093 | μm |
| Minimum mark/pit length (2T) | (A) | 0.408 | μm |
| | (B) | 0.173 to 0.187 | μm |
| Maximum mark/pit length (13T) | (A) | 2.652 | μm |
| | (B) | 1.126 to 1.213 | μm |
| Track pitch | (A) | 0.68 | μm |
| | (B) | 0.34 | μm |
| Physical address setting | (B) | Wobble address | |
| method | | | |
| Outer diameter of information | | 120 | mm |
| storage medium | | | |
| Total thickness of information | | 0.60 × 2 | mm |
| storage medium | | | |
| Outer diameter of center hole | | 15.0 | mm |
| Inner radius of data area DTA | | 24.1 | mm |
| Outer radius of data area DTA | | 57.89 | mm |
| Sector size | | 2048 | bytes |
| ECC | | Reed-Solomon Product code | |
| (Error Correction Code) | | RS(208, 192, 17) × (182, 172, 11) | |
| ECC block size | | 32 physical sectors | |
| Modulation method | | ETM, RLL (1, 10) | |
| Error-correctable error Length | (A) | 7.1 | mm |
| | (B) | 6.0 | mm |
| Linear velocity | (A) | 6.61 | m/s |
| | (B) | 5.64 to 6.03 | m/s |
| Channel bit transfer rate | (A) | 32.40 | Mbps |
| | (B) | 64.80 | Mbps |
| User data transfer rate | (A) | 18.28 | Mbps |
| | (B) | 36.55 | Mbps |

(A) means numerical value in system lead-in area SYLDI, and
(B) means numerical value in data lead-in area DTLDI, data area DTA, and data lead-out area DTLDO

TABLE 16
Comparative explanatory view of information contents in physical
format information and R-phvsical format information

| Type of | | Physical format information PFI | | | R-physical |
|---|---|---|---|---|---|
| recording | Byte | In read-only | In rewritable | In write-once | format |
| information | position | medium | medium | medium | information * |

| Information | 0 | Book type (read-only/rewritable/write-once) information version number | | |
|---|---|---|---|---|
| common to all | | information | | |
| of read-only, | 1 | Medium size (diameter) maximum data transfer rate information | | |
| rewritable, and | 2 | Medium structure (single or double layers; presence/absence of | | |
| write-once | | emboss/pit/rewrite-once area/rewritable area) | | |
| media | 3 | Recording density (linear density and track density) information | | |
| | 4-15 | Allocation position information of data area DTA | | |
| | 16 | presence/absence information of burst cutting area BCA (present in all types | | |
| | | of media in this embodiment) | | |
| Information | 17 | Reserved | Revision number information that specifies highest recording | |
| common to | | field | speed | |
| rewritable and | 18 | | Revision number information that specifies lowest recording | |
| write-once | | | speed | |
| media in DVD | 19 • 25 | | Revision number table (applied revision number) | |
| family | 26 | | Class state information | |
| | 27 | | Extended (part) version information | |
| | 28 • 31 | | Reserved field | |
| HD_DVD | 31 • 127 | | Reserved field | |
| Unique | 128-175 | | Medium manufacturer name information | |
| information | 176-191 | | Additional information from medium manufacturer | |
| associated with | 192 | | Polarity (identification of H → L or L → H) information of | |
| type of version | | | recording mark | |
| book and part | 193 | | Linear velocity information upon recording or playback | |
| version | 194 | | Rim intensity value of optical system along circumferential | |
| | | | direction | |
| | 195 | | Rim intensity value of optical system along radial direction | |
| | 196 | | Recommended laser power (light amount value on recording | |
| | | | surface) upon playback | |
| | 197-511 | | Reserved field | Start PSNs of current border out and next |
| | | | | border out * |
| Information | 512 | Reserved | Peak power on land | Peak power |
| contents which | | field | area | |
| can be uniquely | 513 | | Bias power 1 on land | Bias power 1 |
| set for each | | | area | |
| revision | 514 | | Bias power 2 on land | Bias power 2 |
| | | | area | |
| | 515 | | Bias power 3 on land | Bias power 3 |
| | | | area | |
| | 516 | | Peak power on groove | End time of first pulse (T_{EFP} in |
| | | | area | FIG. 24B) |
| | 517 | | Bias power 1 on | Multi-pulse interval (T_{MP} in FIG. 24B) |
| | | | groove area | |
| | 518 | | Bias power 2 on | Start time of last pulse (T_{SLP} in |
| | | | groove area | FIG. 24B) |
| | 519 | | Bias power 3 on | Period of bias power 2 of 2T mark (T_{LC} |
| | | | groove area | in FIG. 24B) |
| | 520-196 | | . . . | . . . |
| | 197-204 | | Reserved field | Start position information of border |
| | | | | zone |

| | |
|---|---|
| 204 • 2047 | Reserved field |

TABLE 17
Explanation of another embodiment associated with physical
format information and R-physical format information

| Type of | | Physical format information PFI | | | R-physical | Updated physical |
|---|---|---|---|---|---|---|
| recording | Byte | In read-only | In rewritable | In write-once | format | format |
| information | position | medium | medium | medium | information | information |

| Information | 0 | Book type (read-only/rewritable/write-once) information version number | | | | |
|---|---|---|---|---|---|---|
| common to all | | information | | | | |
| of read-only, | 1 | Medium size (diameter) maximum data transfer rate information | | | | |
| rewritable, and | 2 | Medium structure (single or double layers; presence/absence of | | | | |
| write-once | | emboss/pit/rewrite-once area/rewritable area) | | | | |
| media | 3 | Recording density (linear density and track density) information | | | | |
| | 4-15 | Allocation position information of data area DTA | | | | |
| | 16 | presence/absence information of burst cutting area BCA (present in all | | | | |
| | | types of mediain this embodiment) | | | | |
| Information | 17 | Reserved | Revision number information that specifies highest recording | | | |
| common to | | field | speed | | | |
| rewritable and | 18 | | Revision number information that specifies lowest recording | | | |
| write-once | | | speed | | | |
| media in DVD | 19 • 25 | | Revision number table (applied revision number) | | | |
| family | 26 | | Class state information | | | |
| | 27 | | Extended (part) version information | | | |
| | 28 • 31 | | Reserved field | | | |
| Unique | 31 • 127 | | Reserved field | | | |
| information | 128 | | Polarity (identification of H → L or L → H) information of | | | |
| associated with | | | recording mark | | | |
| type of version | 129 | | Linear velocity information upon recording or playback | | | |
| book and part | 130 | | Rim intensity value of optical system along circumferential | | | |
| version | | | direction | | | |
| | 131 | | Rim intensity value of optical system along radial direction | | | |
| | 132 | | Recommended laser power (light amount value on recording | | | |
| | | | surface) upon playback | | | |
| | 133-151 | | Reserved field | Start position (PSN) | Updated start | BPS 256 to |
| | | | | of border zone | position (PSN) | 263 in R- |
| | | | | | | physical |
| | | | | | | format |
| | | | | | | information |

| | 256-263 | | Reserved field | |
|---|---|---|---|---|
| Information | 512 | Reserved | Peak power on | Peak power |
| contents which | | field | land area | |
| can be uniquely | 513 | | Bias power 1 | Bias power 1 |
| set for each | | | on land area | |
| revision | 514 | | Bias power 2 | Bias power 2 |
| | | | on land area | |
| | 515 | | Bias power 3 | Bias power 3 |
| | | | on land area | |
| | 516 | | Peak power on | End time of first pulse (T_{EFP} in FIG. 16) |
| | | | groove area | |
| | 517 | | Bias power 1 | Multi-pulse interval {T_{MP} in FIG. 16) |
| | | | on groove area | |
| | 518 | | Bias power 2 | Start time of Last pulse (T_{SLP} in FIG. 16) |
| | | | on groove area | |
| | 519 | | Bias power 3 | Period of bias power 2 of 2T mark (T_{LC} in |
| | | | on groove area | FIG. 16) |
| | 520-2047 | | . . . | . . . |

The present invention is the invention that finds out preferred combinations of these apparatus arrangements, data structures, and medium configurations. Using optical recording media of the present invention, media with a higher density and higher reliability can be obtained, and more stable recording/playback can be implemented.

Table 18 shows general parameters of a write-once, single-sided, double-layer disc.

TABLE 18
General parameter setting example in
read-only information storage medium

| Parameter | | Double-layer structure | |
|---|---|---|---|
| User usable recording capacity | | 30 | Gbytes/side |
| Use wavelength | | 405 | nm |
| NA value of objective lens | | 0.65 | |
| Data bit length | (A) | 0.306 | μm |
| | (B) | 0.153 | μm |
| Channel bit length | (A) | 0.204 | μm |
| | (B) | 0.102 | μm |
| Minimum mark/pit length (2T) | (A) | 0.408 | μm |
| | (B) | 0.204 | μm |
| Maximum mark/pit length (13T) | (A) | 2.652 | μm |
| | (B) | 1.326 | μm |
| Track pitch | (A) | 0.68 | μm |
| | (B) | 0.40 | μm |
| Physical address setting | (B) | Wobble address | |
| method | | | |
| Outer diameter of information | | 120 | mm |
| storage medium | | | |
| Total thickness of information | | 1.20 | mm |
| storage medium | | | |
| Outer diameter of center hole | | 15.0 | mm |
| Inner radius of data area DTA | | 24.6 | mm (Layer 0) |
| Inner radius of data area DTA | | 24.7 | mm (Layer 1) |
| Outer radius of data area DTA | | 58.1 | mm |
| Sector size | | 2048 | bytes |
| ECC | | Reed-Solomon Product code | |
| (Error Correction Code) | | RS(208, 192, 17) × (182, 172, 11) | |
| ECC block size | | 32 physical sectors | |
| Modulation method | | ETM, RLL (1, 10) | |
| Error-correctable error length | | 7.1 | mm |
| Linear velocity | | 6.61 | m/s |
| Channel bit transfer rate | (A) | 32.40 | Mbps |
| | (B) | 64.80 | Mbps |
| User data transfer rate | (A) | 18.28 | Mbps |
| | (B) | 36.55 | Mbps |

(A) means numerical value in system lead-in area SYLDI and system lead-out area SYLDO, and
(B) means numerical value in data lead-in area DTLDI, data area DTA, middle area and data lead-out area DTLDO

Table 18 shows nearly the same general parameters as those of the write-once, single-sided, single-layer disc shown in Table 14, except for the following points. The user usable recording capacity is 30 GB, the inner radius of the data area of layer 0 is 24.6, that of layer 1 is 24.7 mm, and the outer radius of the data area is 58.1 mm (common to layers 0 and 1).

A description especially about a write-once information storage medium (write-once type medium) will be given below.

<<WAP Layout>>

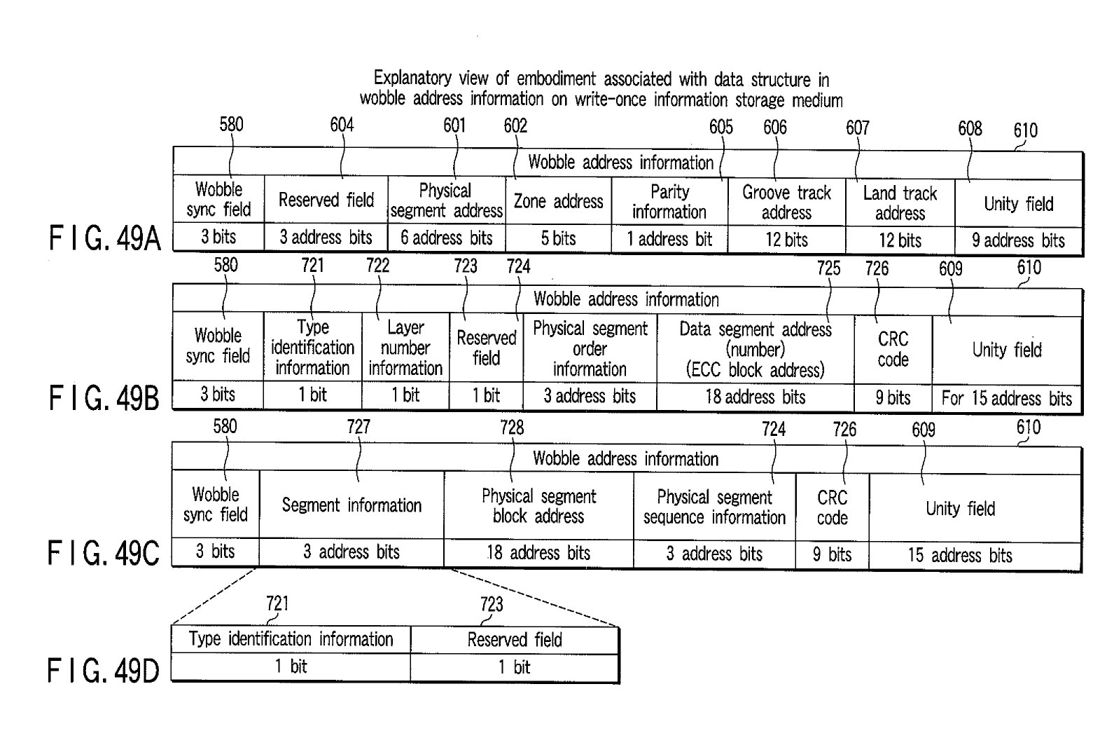

A physical segment must be aligned to information of a wobble address at a periodic position (WAP). Each WAP information is indicated by 17 wobble data units WDU. A physical segment length is the same as that of the 17 WDUs. FIG. 35 shows the layout of a WAP address field. FIG. 35 corresponds to FIGS. 49C and 49D in case of a single-sided, single-layer medium. A numerical value in the WAP layout field indicates a WDU number in a physical segment. The first WDU in the physical segment must be “0”.

Bits b0 to b8 of the WAP describe CRC; b9 to b11, a physical segment order; b12 to b30, a PS block address; and b31 to b32, segment information. Of the segment information, the bit b31 describes a reserved field; and b32, a type. The type indicates that of a physical segment (0b=type 1 (FIG. 22B), 1b=type 2 (FIG. 22C) or type 3 (FIG. 22D)). The PS block address is assigned to each PS block. As the physical segment order, “000b” is set in the first physical segment in a PS block, and values are similarly assigned to the remaining six types of physical segments.

The WOU is made up of 84 wobbles. A wobble period is 93 T (T a channel clock period). Table 19 shows a primary WDU in a SYNC field.

TABLE 19
Primary WDU of SYNC field

| IPW | NPW | IPW | NPW |
|---|---|---|---|
| 6 wobbles | 4 wobbles | 6 wobbles | 68 wobbles |

Table 20 shows a primary WDU in an address field. The address field records 3 bits (0b as a normal phase wobble (NPW), 1b as an inverted phase wobble (IPW)).

TABLE 20
Primary WDU of address field

| IPW | bit 2 | bit 1 | bit 0 | NPW |
|---|---|---|---|---|
| 4 wobbles | 4 wobbles | 4 wobbles | 4 wobbles | 68 wobbles |

Table 21 shows a secondary WDU in the SYNC field.

TABLE 21
Secondary WDU of SYNC field

| NPW | IPW | NPW | IPW | NPW |
|---|---|---|---|---|
| 42 wobbles | 6 wobbles | 4 wobbles | 6 wobbles | 26 wobbles |

Table 22 shows a secondary WDU in the address field. The address field records 3 bits (0b as a normal phase wobble (NPW), 1b as an invert phase wobble (IPW)).

TABLE 22
Secondary WDU of address field

| NPW | IPW | bit 2 | bit 1 | bit 0 | NPW |
|---|---|---|---|---|---|
| 42 | 4 | 4 | 4 | 4 | 26 |
| wobbles | wobbles | wobbles | wobbles | wobbles | wobbles |

Table 23 shows a WDU in a unity field. The WDU in the unity field is not modulated.

TABLE 23
WDU of unity field
NPW
84 wobbles

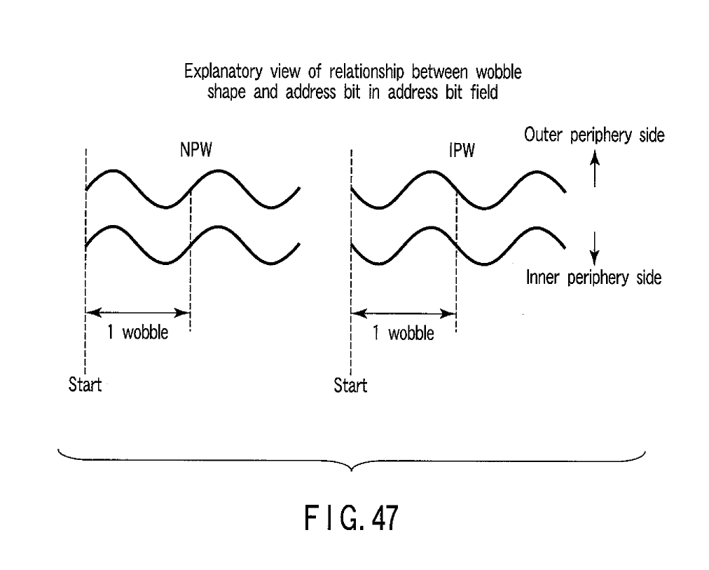

The NPW and IPW are recorded on a track to have waveforms shown in FIG. 47. The start position of a physical segment is equal to that of the SYNC field.

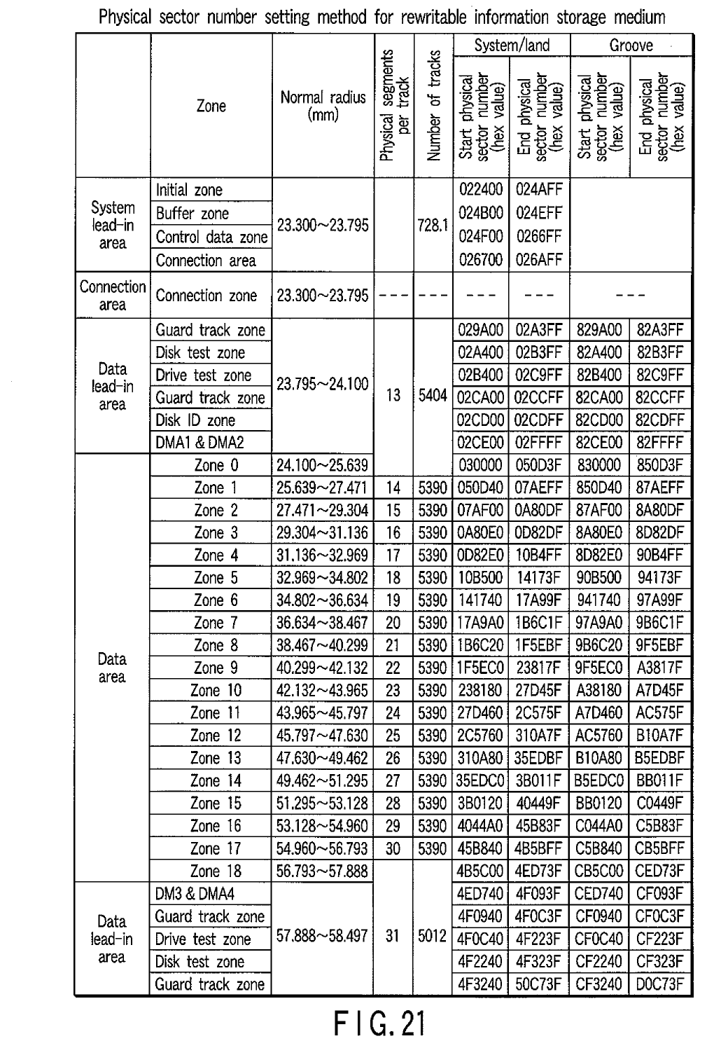

As shown in Tables 19 to 22, there are two modulated wobble positions, i.e., the primary WDU and secondary WDU. Normally, the primary WDU is selected. However, during mastering processing, modulated wobbles may have already existed on neighboring tracks. In such case, the secondary WDU is selected to prevent modulated wobbles from neighboring, as shown in FIG. 21. Physical segments are classified into types 1, 2, and 3, as shown in FIG. 22, depending on their modulated wobble positions.

The type of a physical segment is selected according to the following rules.

1) A physical segment of type 1 or 2 is repeated 10 times or more.

2) A physical segment of type 2 is not repeated 28 times or more.

3) A physical segment of type 3 is selected once at a transition position from that of type 1 to that of type 2.

4) The modulated wobble position is separated by a 2-wobble length or more from one of neighboring tracks.

Table 24 shows details of the drive test zone layout in BPs 52 to 99.

TABLE 24
Drive test zone allocation

| Byte position (BP) | Contents |
|---|---|
| 52-55 | Start PSN of inner periphery |
| | drive test zone of layer 0 |
| | (03 8100h) |
| 56-59 | Size of inner periphery drive |
| | test zone of layer 0 (4B00h) |
| 60-63 | Start PSN of inner periphery |
| | drive test zone of layer 1 |
| | (FC E600h) |
| 64-67 | Size of inner periphery drive |
| | test zone of layer 1 (4B00h) |
| 68-71 | Start PSN of outer periphery |
| | drive test zone of layer 0 |
| | (75 1000h) |
| 72-75 | Size of outer periphery drive |
| | test zone of layer 0 (3C00h) |
| 76-79 | Start PSN of outer periphery |
| | drive test zone of layer 1 |
| | (8B 6F00h) |
| 80-83 | Size of outer periphery drive |
| | test zone of layer 1 (3C00h) |
| 84-87 | Start PSN of additional drive |
| | test zone of layer 0 |
| 88-91 | Size of additional drive test |
| | zone of layer 0 (3C00h) |
| 92-95 | Start PSN of additional drive |
| | test zone of layer 1 |
| 96-99 | Size of additional drive test |
| | zone of layer 1 (3C00h) |

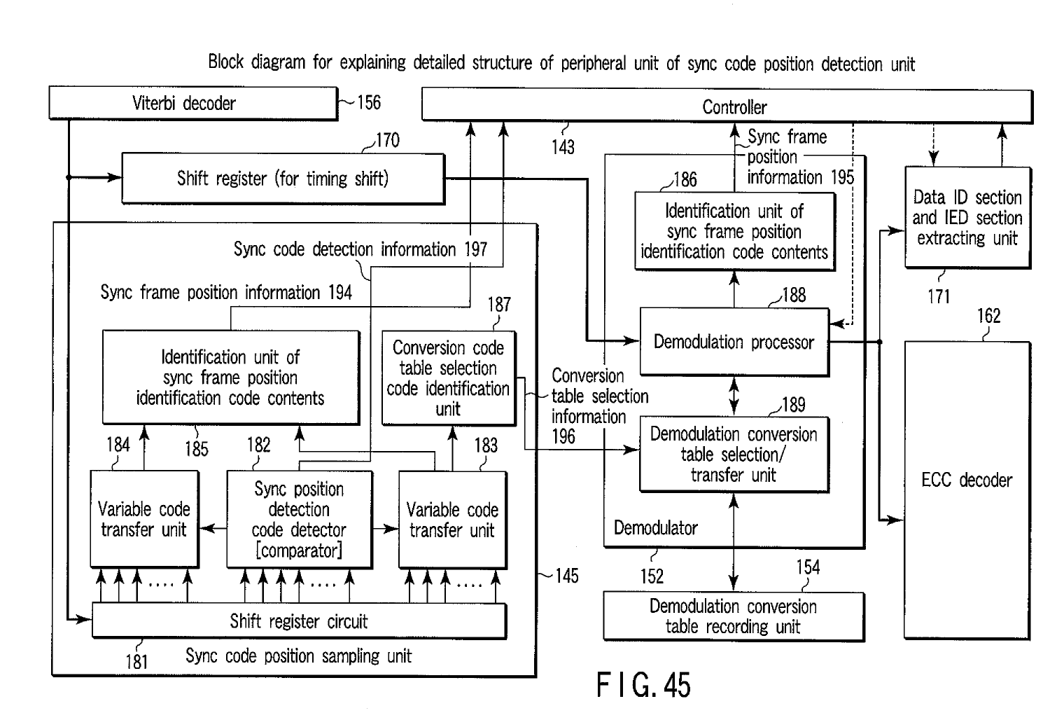

FIG. 45 shows the detailed arrangement of a peripheral unit including a sync code position extraction unit 145 shown in FIG. 14. A sync code includes a sync position detection code part having a fixed pattern, and a variable code part. A sync code position detection code detector 182 detects the position of the sync position detection code part having the fixed pattern from a channel bit string output from the Viterbi decoder 156. Variable code transfer units 183 and 184 extract variable code data located before and after the sync position detection code part. A sync frame position identification code contents identifier 185 then determines a sync frame in a sector (to be described later) in which the detected sync code is located. User information recorded on the information storage medium is transferred, in turn, to a shift register circuit 170, a demodulation processor 188 in the demodulation circuit 152, and an ECC decoding circuit 162.

In this embodiment, an H-format achieves the high density of an information storage medium (especially, the linear density improves) by using the PRML method in playback in the data area, data lead-in area, and data lead-out area, and assures the compatibility to the current DVD and playback stability by using the slice level detection method in playback in the system lead-in area and system lead-out area.

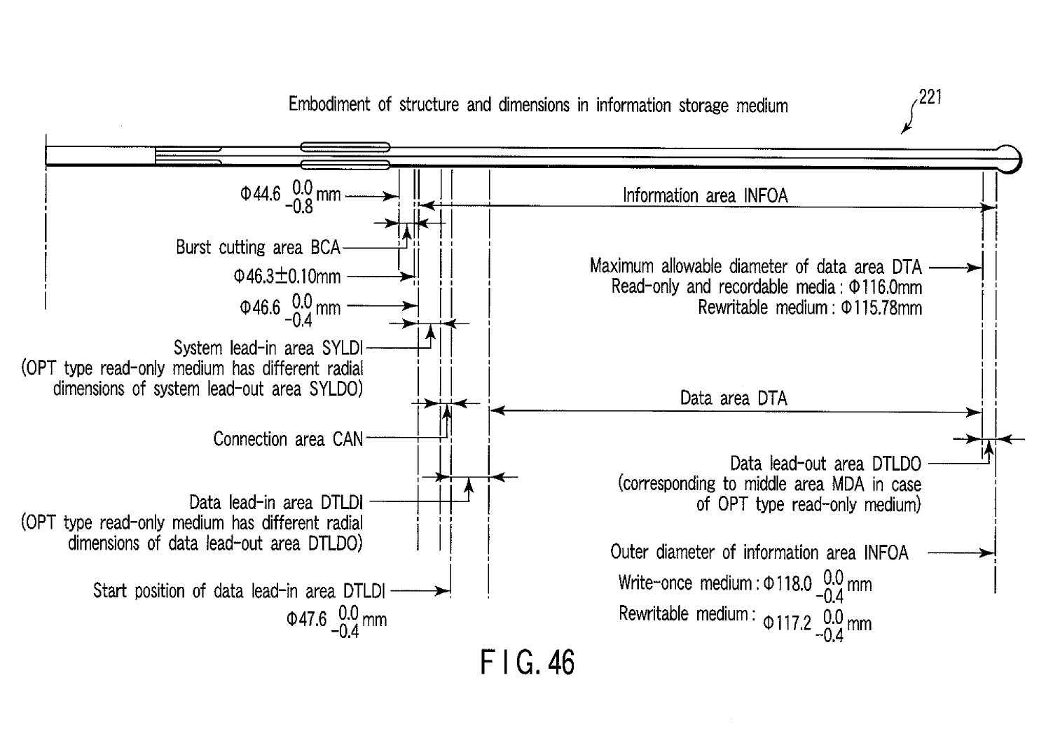

FIG. 46 shows the structure and dimensions in an information storage medium of this embodiment. As embodiments, those of three types of information storage media:

“read-only information storage medium” which is read-only and does not allow recording;

“write-once information storage medium” which allows additional recording only once (write-once recording); and

“rewritable information storage medium” which allows rewrite recording time and time again

are clearly specified. As shown in FIG. 46, most of the structure and dimensions are common to these three types of information storage media. All of the three types of information storage media have a structure in which a burst cutting area BCA, system lead-in area SYLDI, connection area CNA, data lead-in area DTLDI, and data area DTA are allocated in turn from the inner periphery side. A data lead-out area DTLDO is allocated on the outer periphery portion of all the types of media except for an OPT type read-only medium. As will be described later, a middle area MDA is allocated on the outer periphery portion of the OPT type read-only medium. On the system lead-in area SYLDI, information is recorded in the form of embosses (prepits), and this area is read-only (write-once recording is inhibited) on both the write-once and rewritable media. On the read-only information storage medium, information is recorded in the data lead-in area DTLDI in the form of embosses (prepits). However, on the write-once and rewritable information storage media, the data lead-in area DTLDI allows write-once recording (rewrite recording on the rewritable medium) of new information by means of formation of recording marks.

As will be described later, on the write-once and rewritable information storage media, the data lead-out area DTLDO includes both an area that allows write-once recording (rewrite recording on the rewritable medium) of new information, and a read-only area on which information is recorded in the form of embosses (prepits). As described above, since the PRML method is used to play back signals recorded on the data area DTA, data lead-in area DTLDI, data lead-out area DTLDO, and middle area MDA shown in FIG. 46, an increase in density (especially, improvement of the linear density) of information storage media is achieved. Also, since the slice level detection method is used to play back signals recorded on the system lead-in area SYLDI and system lead-out area SYLDO, the compatibility to the current DVD and playback stability are assured.

Unlike in the current DVD specifications, in the embodiment shown in FIG. 46, the burst cutting area BCA and system lead-in area are positionally separated not to overlap each other. By physically separating these areas, interference between information recorded in the system lead-in area SYLDI and that recorded in the burst cutting area BCA upon information playback can be prevented, and information playback with high accuracy can be assured.

The data structure in the burst cutting area BCA shown in FIG. 46 will be described below. Upon measurement of a BCA signal, a focused spot of a laser beam emitted by an optical head must be focused on a recording layer. A playback signal obtained from the burst cutting area BCA is filtered by a secondary lowpass Bessel filter having a cutoff frequency of 550 kHz. The following signal characteristics of the burst cutting area BCA are specified between the center in the information storage medium to the radial positions of 22.4 mm to 23.0 mm. In the playback signal from the burst cutting area BCA, IBHmax and IBHmin respectively define maximum and minimum levels when a BCA code channel bit=“0”, and IBLmax defines a maximum bottom level when a BCA code channel bit=“1”. Also, (IBHmin+IBLmax)/2 defines an intermediate level.

In this embodiment, respective detection signal characteristics include a condition that meets (IBLmax/IBHmin)≦0.8, and a condition that meets (IBHmax/IBHmin)≦1.4. With reference to an average level of IBL and IBH, a position where the BCA signal crosses that reference position is considered as an edge position. The period of the BCA signal is specified when the rotational speed is 2760 rpm (46.0 Hz). The period between leading edges (trailing positions) is defined by 4.63×n±1.00 μs, and the width of a pulse position where the amount of light drops (an interval from a given trailing position to the next leading position) is defined by 1.56±0.75 μs.

In many cases, the BCA code is recorded after completion of manufacture of the information storage medium. However, the BCA code may be recorded in advance as prepits. The BCA code is recorded in a direction along the circumference of the information storage medium, so that a direction in which a pulse width is narrow agrees with a direction in which the light reflectance is low. The BCA code is modulated by an RZ modulation method upon recording. A pulse with a narrow pulse width (=low reflectance) must be narrower than half the channel clock width of the modulated BCA code.

FIG. 47 shows the bit assignment method of this embodiment. As shown in the left side of FIG. 47, a wobble pattern which initially wobbles from the start position of one wobble toward the outer periphery side is called an NPW (Normal Phase Wobble), and is assigned data “0”. As shown in the right side, a wobble pattern which initially wobbles from the start position of one wobble toward the inner periphery side is called an IPW (Invert Phase Wobble), and is assigned data “1”.

FIGS. 48A to 48D explain the presence ratio of the modulation fields and non-modulation fields in respective wobble data units. In all wobble units shown in FIGS. 48A to 48D, 16 wobbles form a modulation field 598, and 68 wobbles form a non-modulation field 593. This embodiment is characterized in that the non-modulation field 593 is broader than the modulation field 598. By setting the broader non-modulation field 593, a wobble detection signal, write clocks, or playback clocks can be stably synchronized in a PLL circuit using the non-modulation field 593. In order to attain stable synchronization, the non-modulation field 593 is desirably broader twice or more than the width of the modulation field 598.

The address information recording format using wobble modulation in the H-format of the write-once information storage medium of the present invention will be described below. The most characteristic feature of the address information setting method using wobble modulation in this embodiment lies in that “assignment is made using the sync frame length 433 as a unit”. One sector is formed of 26 sync frames, and one ECC block includes 32 physical sectors. Hence, one ECC block includes 832 (=26×32) sync frames.

Each physical segment is divided into 17 wobble data units (WDUs). Seven sync frames are assigned to the length of one wobble data unit.

Each of wobble data units #0 560 to #11 571 includes the modulation field 598 for 16 wobbles, and the non-modulation fields 592 and 593 for 68 wobbles, as shown in FIGS. 48A to 48D. The most characteristic feature of this embodiment lies in that the occupation ratio of the non-modulation fields 592 and 593 to the modulation field is very large. Since the groove or land area is wobbled always at a constant frequency on the non-modulation fields 592 and 593, PLL (Phase Locked Loop) is applied using these non-modulation fields 592 and 593, and reference clocks upon playing back recording marks recorded on the information storage medium or recording reference clocks used upon recording new recording marks can be stably extracted (generated).

Since the occupation ratio of the non-modulation fields 592 and 593 to the modulation field 598 is very large in this embodiment, the accuracy and extraction (generation) stability of extraction (generation) of playback reference clocks or extraction and that of recording reference clocks can be greatly improved. That is, upon executing phase modulation based on wobbles, when a playback signal passes through a bandpass filter for waveform shaping, a phenomenon occurs in which the detection signal waveform amplitude after shaping becomes small before and after the phase change position. Therefore, the following problem is posed. That is, when the frequency of occurrence of phase change points due to phase modulation becomes high, the waveform amplitude variation becomes large, and the clock extraction accuracy drops. Conversely, when the frequency of occurrence of phase change points in the modulation field is low, bit shifts upon detection of wobble address information readily occur. To solve this problem, this embodiment improves the clock extraction accuracy by forming the modulation field and non-modulation field by phase modulation, and setting a high occupation ratio of the non-modulation field.

In this embodiment, since the switching position between the modulation field and non-modulation field can be predicted, the non-modulation field is gated to detect a signal of only the non-modulation field for the purpose of the clock extraction, and clocks are extracted from the detection signal. Especially, when a recording layer 3-2 is formed of an organic dye recording material using the recording principle according to this embodiment, a wobble signal is relatively hardly extracted upon using the pre-groove shape/dimensions described in “3-2-D] basic feature associated with pre-groove shape/dimensions in this embodiment” in “3-2) basic feature description common to organic dye film in this embodiment”. To solve this problem, since the occupation ratio of the non-modulation fields 592 and 593 to the modulation field is set to be very large, the reliability of wobble signal detection is improved.

Upon transition from the non-modulation field 592 or 593 to the modulation field 598, an IPW field as a modulation start mark is set using four or six wobbles, and wobble-modulated wobble address fields (address bits #2 to #0) appear immediately after detection of the IPW field as the modulation start mark in a wobble data part shown in FIGS. 48C and 48D. FIGS. 48A and 48B show the contents of a wobble data unit #0 560 corresponding to the wobble sync field 580 shown in FIG. 49C, and FIGS. 48C and 48D show the contents of the wobble data units corresponding to a wobble data part from segment information 727 to a CRC code 726 shown in FIG. 49C. FIGS. 48A and 48C show the wobble data unit contents corresponding to a primary position 701 of the modulation field to be described later, and FIGS. 48B and 48D show the wobble data unit contents corresponding to a secondary position 702 of the modulation field. As shown in FIGS. 48A and 48B, in the wobble sync field 580, six wobbles are assigned to each of IPW fields, and four wobbles are assigned to an NPW field bounded by the IPW fields. As shown in FIGS. 48C and 48D, in the wobble data part, four wobbles are respectively assigned to the IPW field and all the address bit fields #2 to #0.

FIGS. 49A to 49D show an embodiment associated with the data structure in wobble address information on the write-once information storage medium. FIG. 49A shows the data structure in wobble address information on a rewritable information storage medium for the sake of comparison. FIGS. 49B and 49C show two different embodiments associated with the data structure in wobble address information on the write-once information storage medium.

In wobble address information 610, three address bits are set using 12 wobbles. That is, four continuous wobbles form one address bit. In this way, this embodiment adopts a structure in which the address information locations are distributed for every three address bits. When all pieces of wobble information 610 are concentratively recorded at one location in the information storage medium, all the pieces of information cannot be detected when dust or scratches are formed on the surface. As in this embodiment, the locations of the wobble address information 610 are distributed for every three address bits (12 wobbles) included in one of the wobble data units 560 to 576 so as to record groups of information for respective address bits as integer multiples of three address bits. Even when it is difficult to detect information at a given location due to the influence of dust or scratches, another information can be detected.

Since the locations of the wobble address information 610 are distributed, and the wobble address information 610 is allocated to be completed for each physical segment, the address information can be detected for each physical segment. Therefore, upon accessing by the information recording/playback apparatus, the current position can be detected for each physical segment.

Since this embodiment adopts the NRZ method, a phase never changes in four continuous wobbles in the wobble address information 610. By using this feature, the wobble sync field 580 is set. That is, since a wobble pattern which can never be generated in the wobble address information 610 is set for the wobble sync field 580, the allocation position of the wobble sync field 580 is easily identified. This embodiment is characterized in that one address bit is set to have a length other than four wobbles at the position of the wobble sync field 580 with respect to the wobble address fields 586 and 587 each of which forms one address bit by four continuous wobbles. More specifically, in the wobble sync field 580, a wobble pattern change that can never be taken place on the wobble data part (FIGS. 48C and 48D) is set like that a field (IPW field) where a wobble bit=“1” is set to be different from four wobbles, i.e., “six wobbles→four wobbles→six wobbles, as shown in FIGS. 48A and 48B. When the method of changing the wobble periods is adopted, as described above, as the practical method of setting a wobble pattern which can never be generated in the wobble data part in the wobble sync field 580, the following effects are provided.

(1) Wobble detection (determination of wobble signals) can be stably continued without breaking PLL associated with slot positions 512 of wobbles, which is executed inside the wobble signal detector.

(2) The wobble sync field 580 and modulation start marks 581 and 582 can be easily detected by shift of the address bit boundary positions, which is done inside the wobble signal detector.

A characteristic feature of this embodiment lies in that the wobble sync field 580 is formed to have a 12-wobble period and the length of the wobble sync field 580 matches three address bit lengths, as shown in FIGS. 48A to 48D. In this way, by assigning the entire modulation field (for 16 wobbles) in one wobble data unit #0 560 to the wobble sync field 580, the start position of the wobble address information 610 (the allocation position of the wobble sync field 580) is more easier to detect. This wobble sync field 580 is allocated in the first wobble unit in the physical segment. By allocating the wobble sync field 580 at the head position in the physical segment, the boundary position of the physical segment can be extracted by only detecting the position of the wobble sync field 580.

As shown in FIGS. 48C and 48D, an IPW field as a modulation start mark (see FIG. 47) is allocated at the head position ahead of address bits #2 to #0 in the wobble data units #1 561 to #1 571. Since the non-modulation fields 592 and 593 allocated at positions ahead of it have continuous NPW waveforms, the wobble signal detector 135 extracts the position of the modulation start mark by detecting a switching position from the NPW to IPW.

For reference, the contents of the wobble address information 610 in the rewritable information storage medium shown in FIG. 49A record:

(1) Physical Segment Address 601

Information indicating the physical segment number in a track (in one round in an information storage medium 221).

(2) Zone Address 602

Indicates the zone number in the information storage medium 221.

(3) Parity Information 605

Information which is set to detect an error upon playback from the wobble address information 610 and indicates if a sum obtained by individually adding 14 address bits from reserved information 604 to the zone address 602 in address bit units is an even or odd number. The value of the parity information 605 is set so that a result obtained by exclusively ORing a total of 15 address bits including one address bit of this address parity information 605 becomes “1”.

(4) Unity Field 608

As described above, each wobble data unit is set to include the modulation field 598 for 16 wobbles and the non-modulation fields 592 and 593 for 68 wobbles, so that the occupation ratio of the non-modulation fields 592 and 593 to the modulation field 598 is set to be very large. Furthermore, by increasing the occupation ratio of the non-modulation fields 592 and 593, the accuracy and stability of extraction (generation) of playback reference clocks or recording reference clocks are improved. In the unity field 608, all NPW fields continue to form a non-modulation field with a uniform phase.

FIG. 49A shows the numbers of address bits assigned to these pieces of information. As described above, the contents of the wobble address information 610 are separated for respective three bit addresses and are distributed in respective wobble data units. Even when a burst error has occurred due to dust or scratches on the surface of the information storage medium, the probability of errors which spread across different wobble data units is very low. Therefore, the number of times that the recording location of identical information extends over different wobble data units is reduced as much as possible, thus matching the delimited position of each information with the boundary position of each wobble data unit. In this way, even if a burst error has occurred due to dust or scratches on the surface of the information storage medium and specific information cannot be read, another information recorded in other wobble data units can be read to improve the playback reliability of the wobble address information.

The most characteristic feature of this embodiment also lies in that the unity fields 608 and 609 are allocated last in the wobble address information 610, as shown in FIGS. 49A to 49C. As described above, since wobble waveforms in the unity fields 608 and 609 are defined by NPWs, NPWs continue substantially in three continuous wobble data units. By utilizing this feature, the wobble signal detector 135 in FIG. 14 can easily extract the position of the unity field 608 allocated last in the wobble address information 610 by searching for a location where the NPWs continue for a length of three wobble data units 576. Using this position information, the wobble signal detector 135 can detect the start position of the wobble address information 610.

Of various kinds of information shown in FIG. 49A, the physical segment address 601 and zone address 602 indicate the same values between neighboring tracks, while a groove track address 606 and land track address 607 change their values between neighboring tracks. Therefore, an indefinite bit field 504 appears in a field where the groove track address 606 and land track address 607 are recorded. In order to reduce this indefinite bit frequency, this embodiment indicates addresses (numbers) using gray codes for the groove track address 606 and land track address 607. The gray code means a code which changes by only “11 bit” after conversion when an original value is changed by “1”. In this way, the indefinite bit frequency is reduced, and not only the wobble detection signals but also playback signals from recording marks can be detected stably.

As shown in FIGS. 49B and 49C, on the write-once information storage medium, the wobble sync field 680 is allocated at the head position of a physical segment to allow easy detection of the head position of the physical segment or the boundary position between neighboring physical segments. Since type identification information 721 of the physical segment shown in FIG. 49D indicates the allocation position of the modulation field in the physical segment in the same manner as the wobble sync pattern in the aforementioned wobble sync field 580, the allocation position of another modulation field 598 in the identical physical segment can be predicted in advance, and an advance preparation of detection of the forthcoming modulation field can be made, thus improving the signal detection (determination) accuracy in the modulation field. Layer number information 722 on the write-once information storage medium shown in FIG. 49B indicates a single-sided, single recording layer or either one recording layer in case of single-sided, double recording layers, and means:

the single-sided, single recording layer medium or “L0 layer” (a front-side layer on the laser beam incident side) in case of the single-sided, double recording layers when it is “0”; or

“L1 layer” (a back-side layer on the laser beam incident side) of the single-sided, double recording layers when it is “1”.

Physical segment order information 724 indicates a relative allocation order of physical segments in a single physical segment block. As can be seen from comparison with FIG. 49A, the head position of the physical segment order information 724 in the wobble address information 610 matches that of the physical segment address 601 on the rewritable information storage medium. By determining the position of the physical segment order information in correspondence with that on the rewritable medium, the compatibility between different medium types can improve, and a common address detection control program using wobble signals can be used in an information recording/playback apparatus which can use both the rewritable information storage medium and write-once information storage medium, thus simplifying the arrangement.

A data segment address 725 in FIG. 49B describes address information of a data segment using a number. As has already been described above, in this embodiment, 32 sectors form one ECC block. Therefore, the lower 5 bits of the physical sector number of a sector allocated at the head in a specific ECC block match those of the sector numbers of sectors allocated at the head in neighboring ECC blocks. When the physical sector number of the sector allocated at the head in the ECC block is set so that its lower 5 bits are “00000”, the values of the lower 6th bits or higher of the physical sector numbers of all sectors included in the identical ECC block match. Therefore, address information obtained by removing the lower 5-bit data of the physical sector number of each sector included in the identical ECC block, and extracting only data of the lower 6th bit or higher is set as an ECC block address (or ECC block address number). The data segment address 725 (or physical segment block number information) which is recorded in advance by wobble modulation matches the ECC block address. Hence, if the position information of each physical segment block by wobble modulation is indicated as a data segment address, the data size is reduced by 5 bits compared to indication as the physical sector number, thus simplifying the current position detection upon accessing.

The CRC code 726 shown in FIGS. 49B and 49C is a CRC code (error correction code) for 24 address bits from the type identification information 721 of the physical segment to the data segment address 725 or that for 24 address bits from the segment information 727 to the physical segment order information 724, and even when a wobble modulation signal is partially erroneously read, it can be partially corrected by this CRC code 726.

On the write-once information storage medium, a field corresponding to the remaining 15 address bits is assigned to the unity field 609, and the contents of five, 12th to 16th wobble data units are defined by all NPWs (no modulation field 598 is included).

A physical segment block address 728 in FIG. 49C is an address for each physical segment block which forms one unit by seven physical segments, and the physical segment address for the first physical segment block in the data lead-in area DTLDI is set to be “1358h”. The value of this physical segment block address is sequentially incremented by one from the first physical segment block in the data lead-in area DTLDI to the last physical segment block in the data lead-out area DTLDO as well as the data area DTA.

The physical segment order information 724 represents the order of physical segments in one physical segment block: “0” is set for the first physical segment, and “6” is set for the last physical segment.

The embodiment shown in FIG. 49C is characterized in that the physical segment block address 728 is allocated at a position ahead of the physical segment order information 724. For example, address information is normally managed using this physical segment block address like in RMD field 1. Upon accessing a predetermined physical segment block address according to these pieces of management information, the wobble signal detector detects the location of the wobble sync field 580 shown in FIG. 49C first, and then sequentially decodes information in turn from that recorded immediately after the wobble sync field 580. When the physical segment block address is allocated at the position ahead of the physical segment order information 724, the wobble signal detector decodes the physical segment block address first, and can then check a predetermined physical block address or not without decoding the physical segment order information 724, thus improving accessibility using wobble addresses.

This embodiment is also characterized in that the type identification information 721 is allocated immediately after the wobble sync field 580 in FIG. 49C. As described above, the wobble signal detector 135 detects the location of the wobble sync field 580 shown in FIG. 49C first, and then sequentially decodes information in turn from that recorded immediately after the wobble sync field 580. Therefore, by allocating the type identification information 721 immediately after the wobble sync field 580, since the allocation position of the modulation field in the physical segment can be immediately confirmed, access processing using the wobble addresses can be speeded up.

Since this embodiment uses the H-format, a predetermined value of the wobble signal frequency is set to be 697 kHz.

<<Definition of Clearance>>

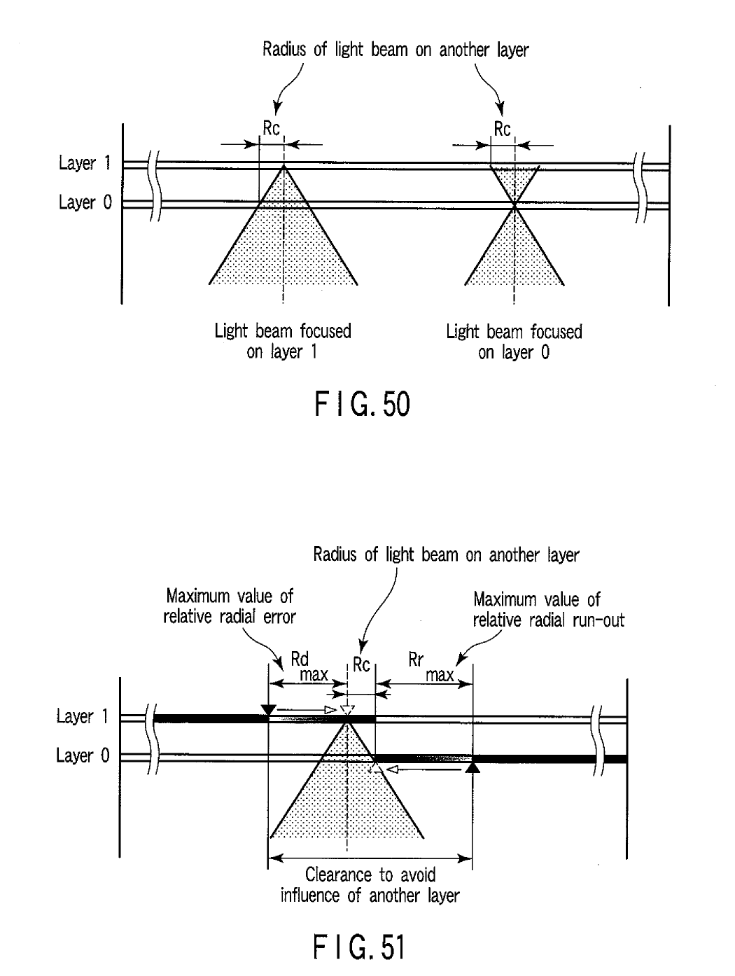

On a single-sided, multi-layer disc, if a light beam focused on a given layer of the disc is diffused to another layer, it is reflected by the other layer or the layer on which the light beam is focused (see FIG. 50). Therefore, read/write accesses to the given layer are influenced by light reflected by the other layer of the disc. In order to avoid this influence, the state of the other layer of the disc must be constant in association with the presence of recording marks. An area that influences the quality of read/write accesses to the given layer needs to be clearly defined on the other layer of the disc with reference to a focusing point. In this way, read/write accesses at a given position on the layer can be appropriately made by maintaining constant the state of this area on the other layer of the disc. A radial distance of this area is called a “clearance” (see FIG. 51).

The clearance must be calculated in consideration of three elements: the radius, on the other layer, of a light beam focused on the given layer, a maximum value of a relative radial error between layers 0 and 1, and a maximum value of a relative radial run-out between layers 0 and 1. These values are defined as follows.

The maximum value of the relative radial error between layers 0 and 1:

Rdmax=40 μm

The maximum value of the relative radial run-out between layers 0 and 1

Rrmax=(40+60)/2=50 μm

The deviation (radial run-out) of the track shape from a perfect circle is 40 μm (peak-to-peak) for layer 0 and is 60 μm (peak-to-peak) for layer 1. Hence, the average calculated on the disc is 50 μm.

A theoretical value of the radius, on the other layer, of a light beam focused on the given layer is given by:

Rc_theoretical=Ts1□ tan(sin−1(NA/n))=14 μm

Ts1 (maximum value of the thickness of a space layer)=30 μm

NA (numerical aperture)=0.65

n (refractive index of the space layer)=1.5

As for Rc_practical as an actual radius, since the intensity of a light beam becomes maximum at the central portion and becomes minimum at the edge, an effective radius can be recognized as about 10 μm.

A clearance C1 of the disc is calculated by:

C1=Rdmax+Rrmax+Rc_practical=100 μm

The format of the information area is formed in consideration of the clearances of the edges of respective areas in the information area.

Note that FIG. 51 merely shows an example of the positional deviations. Hence, the relative radial run-out of layer 1 does not always deviate outwardly, and that of layer 0 does not always deviate inwardly.

<<Example of Clearance (Number of Physical Sectors)>>

It is significant in terms of the compatibility to simply express the clearance by the number of physical sectors.

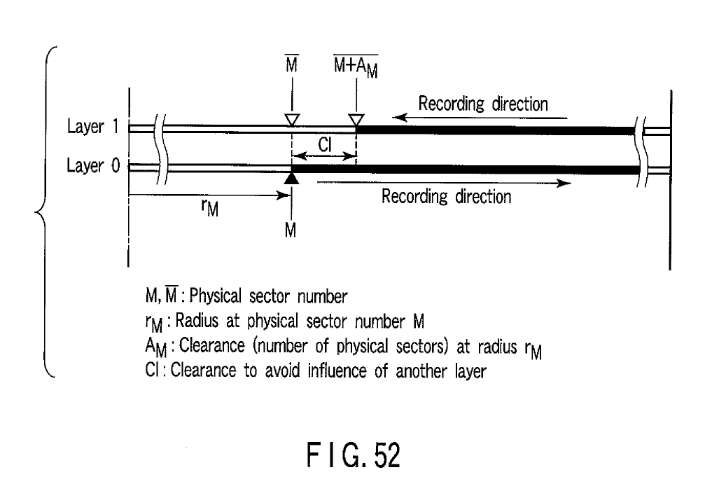

FIG. 52 shows a given physical sector PSN on layer 0 and the corresponding recordable physical sector on layer 1. The physical sector numbers on layers 0 and 1 have a bit inversion relationship.

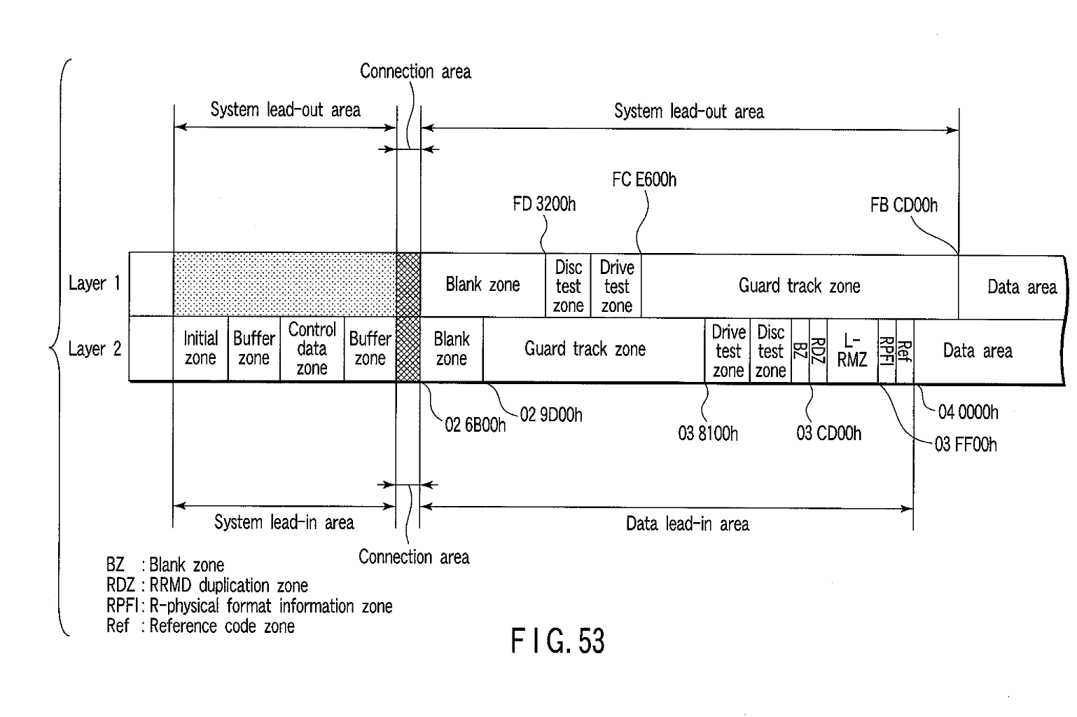

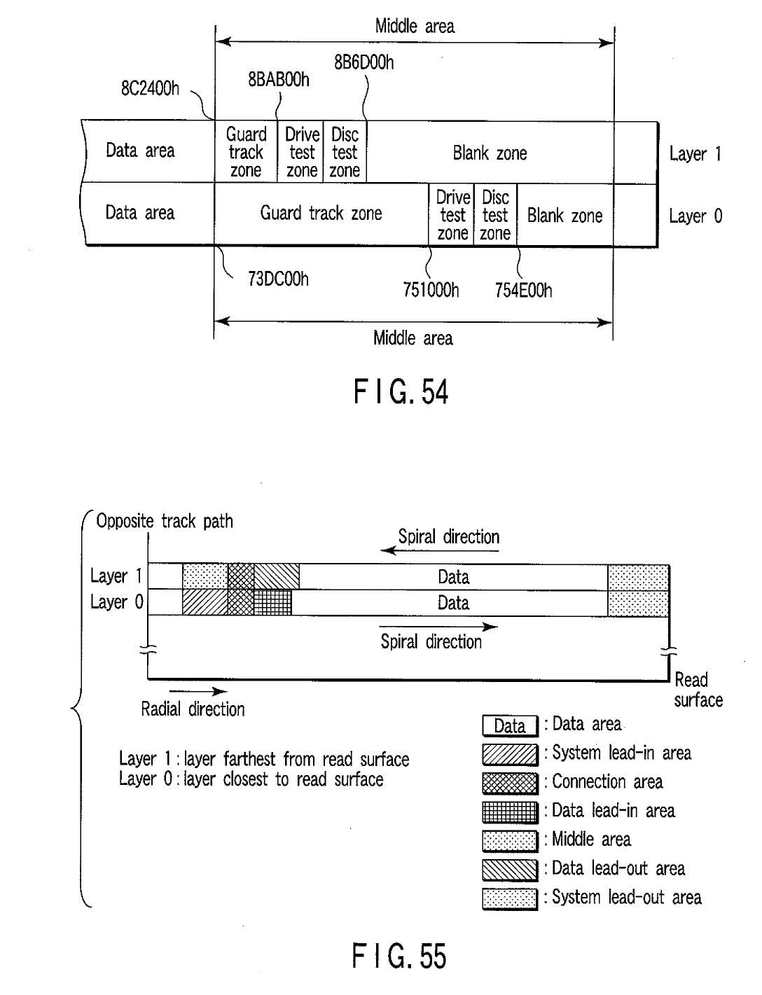

FIG. 53 shows an overview of the lead-in area and lead-out area. FIG. 54 shows an overview of middle areas of layers 0 and 1 in an initial state. The layout of the middle area can be changed by reallocation, and FIG. 54 shows that before change. The boundaries of respective zones and areas of the lead-in area, lead-out area, and middle area must match those of data segments.

The system lead-in area, connection area, data lead-in area, and data area are formed on the inner periphery side of layer 0 in turn from the innermost periphery. The system lead-out area, connection area, data lead-out area, and data area are formed on the inner periphery side of layer 1 in turn from the innermost periphery. In this manner, since the data lead-in area which includes a management area is formed only on layer 0, when layer 1 undergoes finalization, information of layer 1 is also written in the data lead-in area of layer 0. In this way, all pieces of management information can be obtained by reading only layer 0 upon start-up, and each of layers 0 and 1 need not be read. In order to record data on layer 1, data must be fully recorded on layer 0. The management area is padded at the time of finalization.

The system lead-in area of layer 0 includes an initial zone, buffer zone, control data zone, and buffer zone in turn from the inner periphery side. The data lead-in area of layer 0 includes a blank zone, guard track zone, drive test zone, disc test zone, blank zone, RZD (RMD duplication zone), L-RMD (recording position management data), R-physical format information zone, and reference code zone in turn from the inner periphery side. The start address (inner periphery side) of the data area of layer 0 has a difference from the end address (inner periphery side) of the data area of layer 1 due to the presence of a clearance, and the end address (inner periphery side) the data area of layer 1 is located on the outer periphery side of the start address (inner periphery side) of the data area of layer 0.

The data lead-out area of layer 1 includes a blank zone, disc test zone, drive test zone, and guard track zone in turn from the inner periphery side.

The blank zone is a zone on which grooves are formed but no data is recorded. The guard track zone records a specific pattern for a test, i.e., data “00h” before modulation. The guard track zone of layer 0 is formed for recording on the disc test zone and drive test zone of layer 1. For this reason, the guard track zone of layer 0 corresponds to a range defined by adding at least a clearance to the disc test zone and drive test zone of layer 1. The guard track zone of layer 1 is formed for recording on the drive test zone, disc test zone, blank zone, RZD (RMD duplication zone), L-RMD, R-physical format information zone, and reference code zone of layer 0. For this reason, the guard track zone of layer 1 corresponds to a range defined by adding at least a clearance to the drive test zone, disc test zone, blank zone, RZD (RMD duplication zone), L-RMD, R-physical format information zone, and reference code zone of layer 0.

As shown in FIG. 54, each of the middle areas of layers 0 and 1 includes a guard track zone, drive test zone, disc test zone, and blank zone in turn from the inner periphery side. The guard track zone of layer 0 is formed for recording on the drive test zone and disc test zone of layer 1. For this reason, the end position of the guard track zone of layer 0 is located on the outer periphery side of the start position of the disc test zone of layer 1 by at least the width of a clearance. The blank zone of layer 1 is formed for recording on the drive test zone and disc test zone of layer 0. For this reason, the end position of the blank zone of layer 1 is located on the inner periphery side of the start position of the drive test zone of layer 0 by at least the width of a clearance.

<<Track Path>>

This embodiment adopts opposite track paths shown in FIG. 55 to maintain continuity of recording from layer 0 to layer 1. In sequential recording, recording on layer 1 does not start unless recording on layer 0 is complete.

<<Physical Sector Layout and Physical Sector Number>>

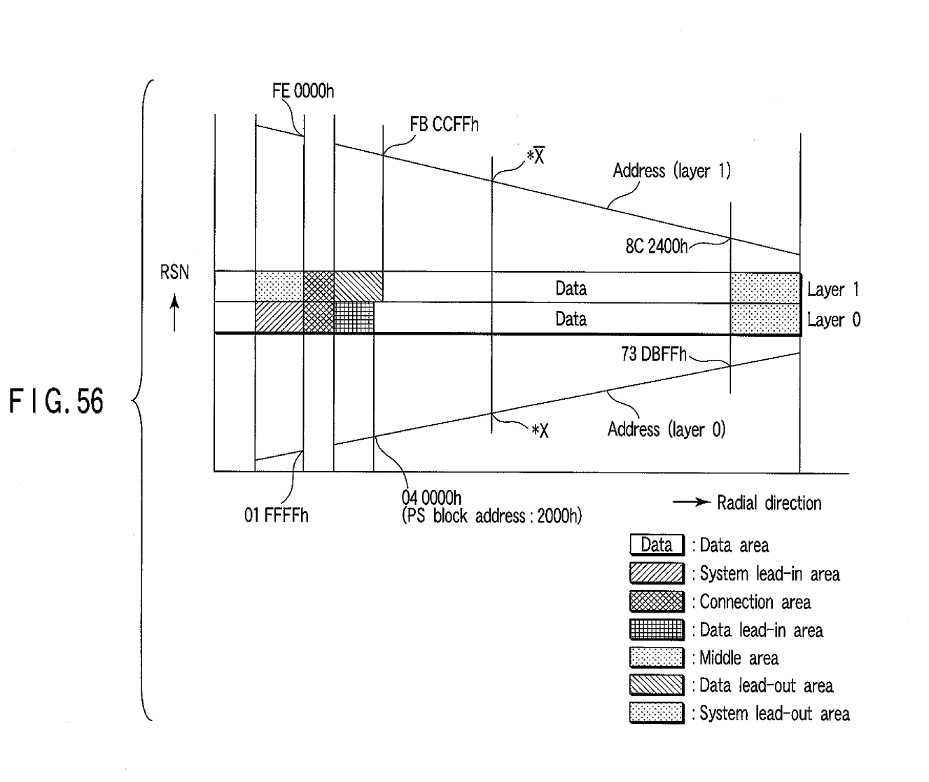

Each PS block includes 32 physical sectors. The physical sector number (PSN) of layer 0 on an HD DVD-R for the single-sided, double-layer disc is successively incremented in the system lead-in area, and from the beginning of the data lead-in area to the end of the middle area, as shown in FIG. 56. However, the PSN of layer 1 assumes inverted bits to those of layer 0, and is successively incremented from the beginning of the middle area (outer side) to the end of the data lead-out area (inner side) and from the outer side of the system lead-out area to the inner side of the system lead-out area. A numerical value of the bit inversion is calculated so that a bit value “1” becomes “0” (and vice versa). The physical sectors of respective layers whose PSNs are bit-inverted have nearly the same distances from the center of the disc.

A physical sector whose PSN is X is included in a PS block with a PS block address which has a value calculated by dividing X by 32, and omitting fractions.

The PSNs of the system lead-in area are calculated to have that of a physical sector at the end position of the system lead-in area as “131071” (01 FFFFh).

The PSNs of layer 0 except for the system lead-in area are calculated to have that of a physical sector at the start position of the data area after the data lead-in area as “262144” (04 0000h). The PSNs of layer 1 except for the system lead-out area are calculated to have that of a physical sector at the start position of the data area after the middle area as “9184256” (8C 2400h).

<<Middle Area>>

The structure of the middle area is changed by middle area extension. If the volume of data recorded by the user is small, the dummy data size for finalization can be reduced by extending the middle area, and the finalization time can be shortened.

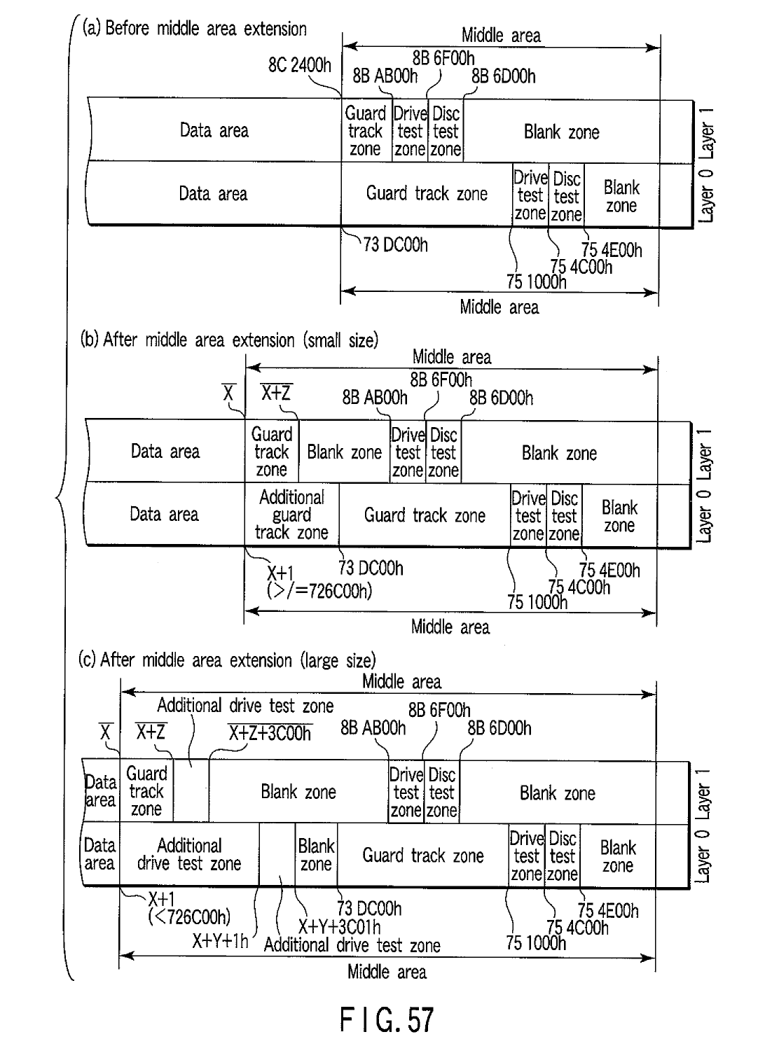

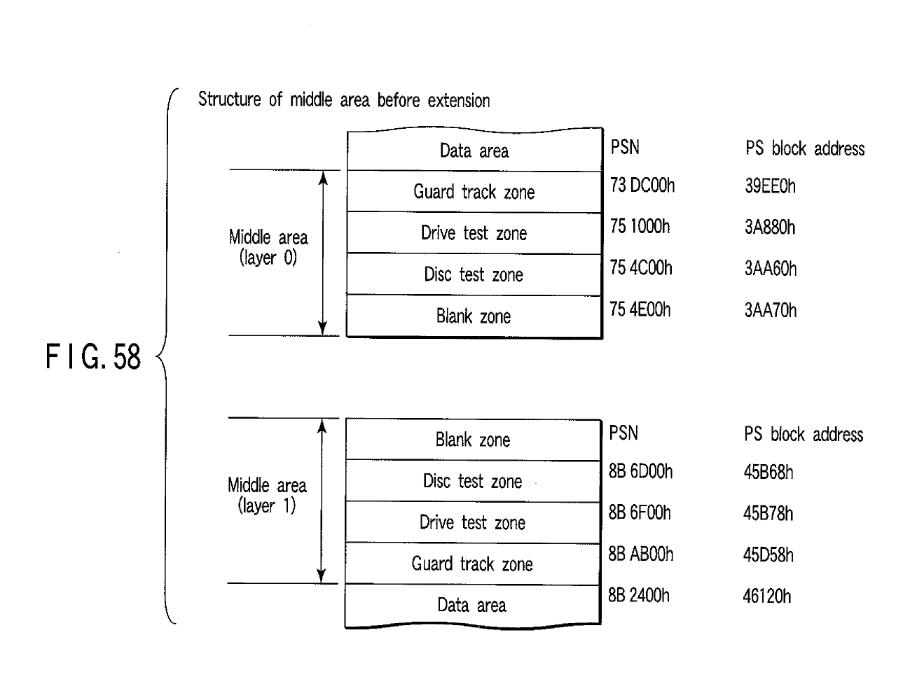

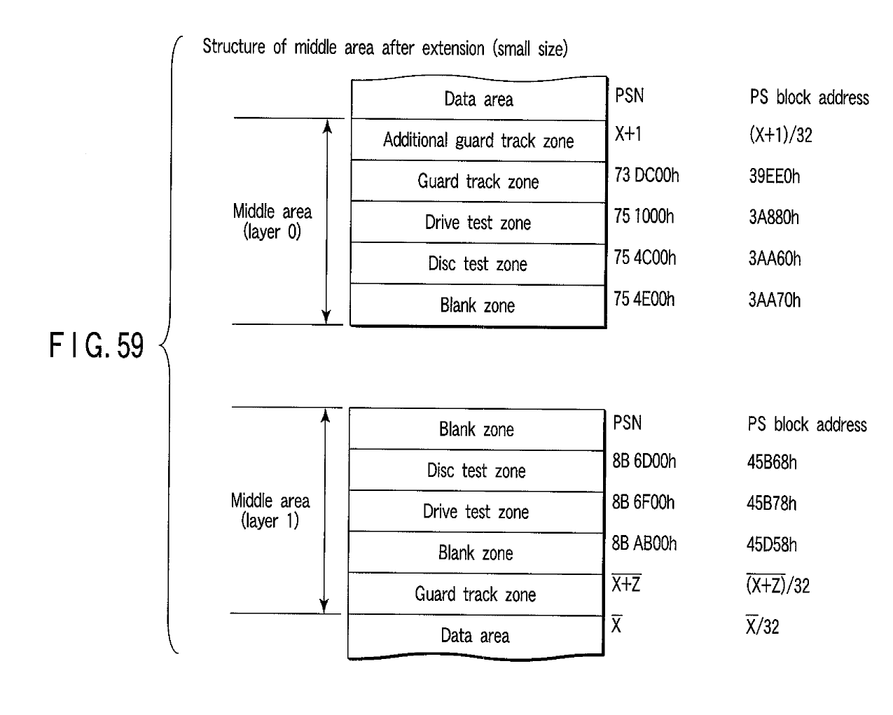

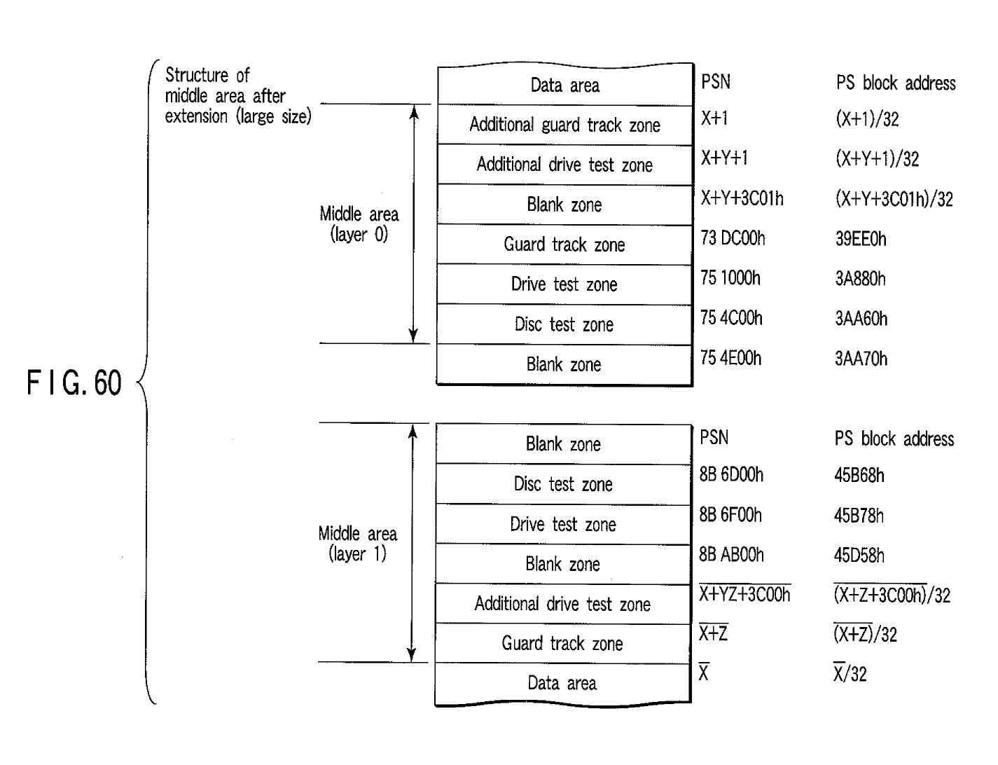

FIG. 57 shows overviews of middle area extension. Details of extension will be described later. FIGS. 58, 59, and 60 show the structures of the middle area before and after extension. FIG. 58 is a view for explaining the structure of the middle area before extension. FIGS. 59 and 60 are views for explaining the structure of the middle area after extension. There are two extension modes, and one of FIGS. 59 and 60 is executed in accordance with the extension size of the middle area. A small or large size is determined depending on whether or not the extension size (that (73DC00h-726C00h) of the guard track zone) is smaller than a 17000h sector. FIG. 59 shows the structure after extension when the extension size is the small size, and FIG. 60 shows that when the extension size is the large size. The size of the guard track zone, formation of an additional guard track zone of layer 0, and formation of drive test zones after extension depend on the end PSN of the data area of layer 0.

Each data segment of the guard track zone of layer 0 must be padded with “00h” before recording on layer 1. Each data segment of the guard track zone of layer 1 must be padded with “00h” before finalization of the disc.

The drive test zones are prepared for the purpose of the test by a drive. These zones are recorded from an outer PS block to an inner PS block. All data segments of the drive test zone of layer 0 may be padded with “00hT” before recording on layer 1.

The disc test zones are prepared for the purpose of the quality test by the disc manufacturer.

Each data segment of the blank zone does not include any data. The size of the outermost blank zone of layer 0 must amount to 968 PS blocks or more. The size of the outermost blank zone of layer 1 must amount to 2464 PS blocks or more.

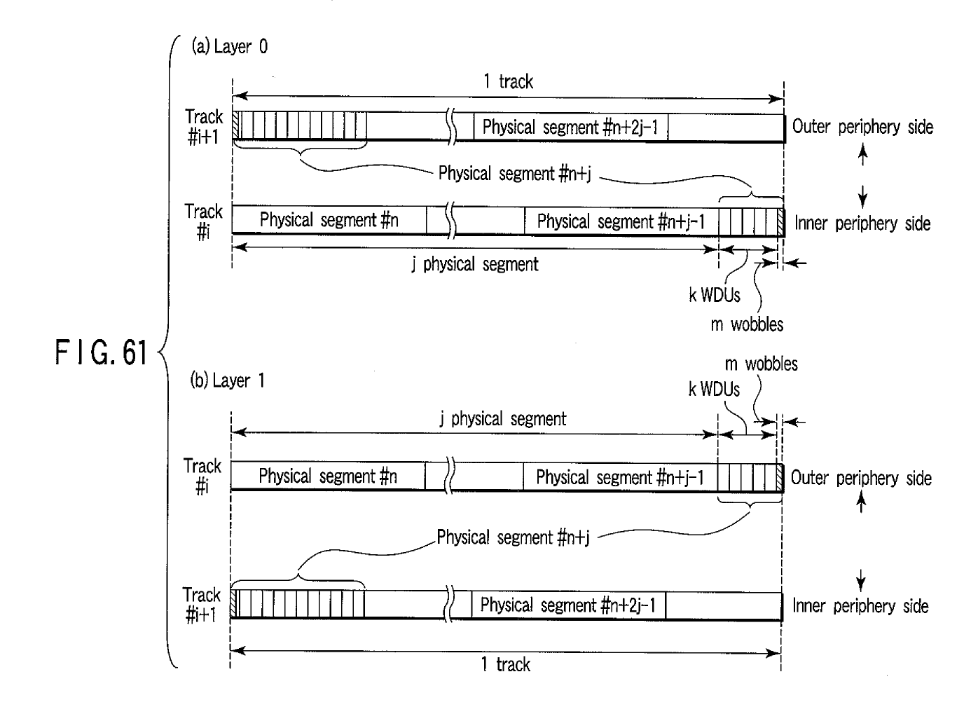

Type selection aims at avoiding modulated wobbles from aligning. FIG. 61 shows an overview of two neighboring tracks. The start point of track #i is the same as that of physical segment #n (where i and n are natural numbers). Track #i includes j physical segments, k WDUs, and m wobbles (where j is a natural number, and k and m are non-negative integers). If both k and m are not zero, physical segment #n+j is allocated on tracks #i and #i+1.

Finalization:

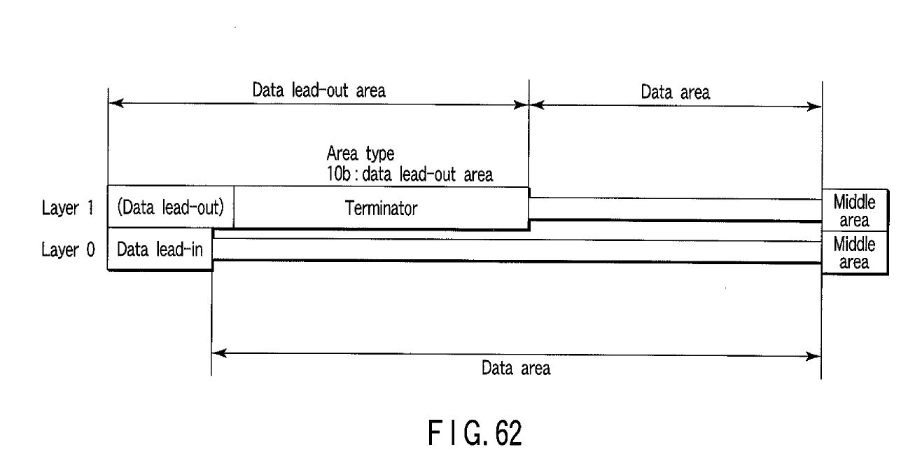

Upon finalizing the data area, a terminator is recorded in an unrecorded part of the data area. Main data of the terminator is set to be “00h”, and its area type is a data lead-out attribute. When user data is recorded on layer 1, the terminator is recoded on the entire unrecorded part of the data area, as shown in FIG. 62.

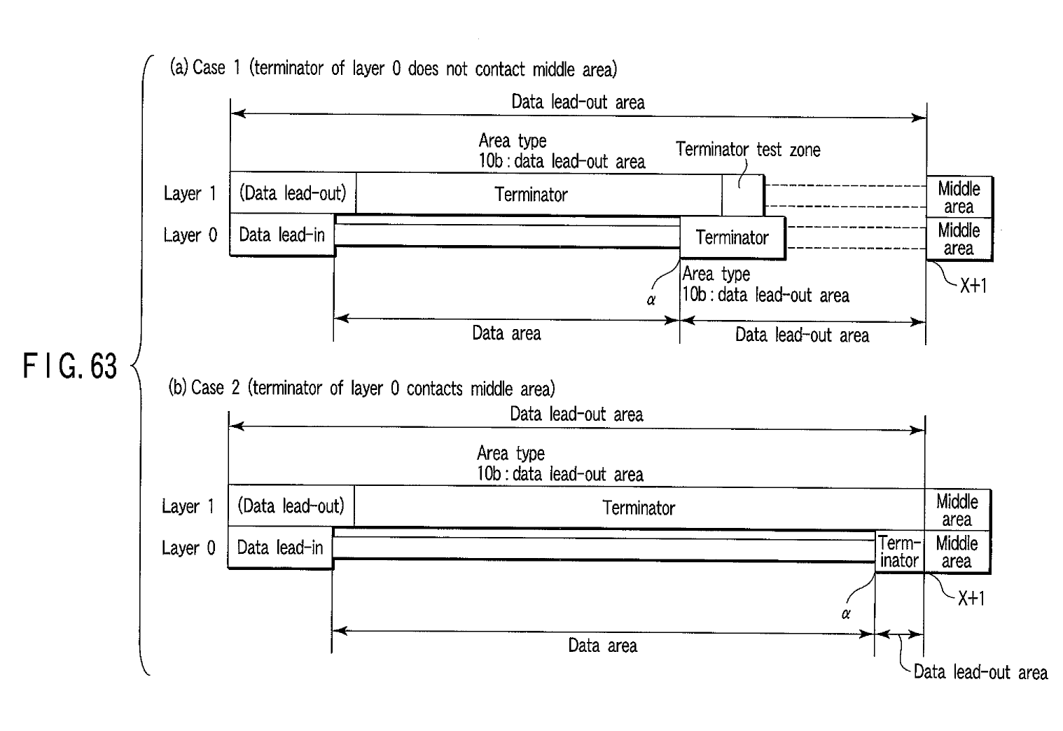

When no data area is recorded on layer 1, the terminator is recorded on layers 0 and 1, as shown in FIG. 63. The terminator of layer 0 must be recorded to contact the data area. If there are sufficient unrecorded data segments between the data area and middle area, the terminator need not be recorded on all of these data segments, and a new terminator test zone is allowed to be created on layer 1 (see FIG. 63). The new terminator test zone is used for the test by a drive, and requires its size for 480 PS blocks.

After recording the terminator, the guard track zones of layer 1, which are allocated on the data lead-out area and middle area, and the additional guard track zone of layer 1 must be padded with “00h” if they are not recorded. Before the guard track zone allocated on the data lead-out area is padded, the drive test zone, an unrecorded part of the RMD duplication zone, the L-RMZ, the R-physical format information zone, and the reference code zone must be recorded.

As shown in FIG. 63, when the terminator does not contact the middle area, the guard track zones allocated on the middle areas of layers 0 and 1, and the additional guard track zone allocated on the middle area of layer 0 may not be recorded.

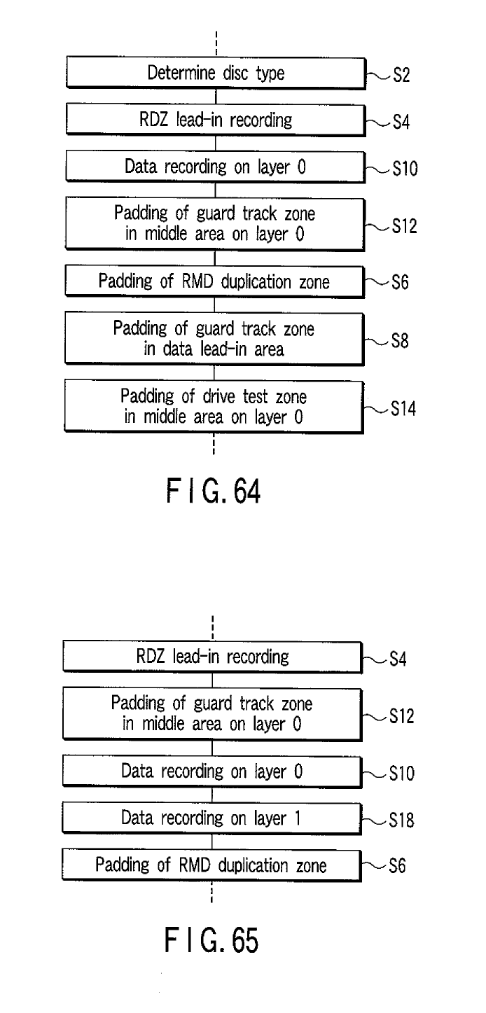

As another modification, in order to start data recording on the data area of layer 0 at a timing as early as possible, data recording on the data area of layer 0 may be executed immediately after RDZ lead-in recording of the RMD duplication zone, as shown in FIG. 64. In FIG. 64 as well, padding of the drive test zone of the middle area of layer 0 can be omitted. However, if the size of recording data is larger than the recording capacity of the data area of layer 0, and the data is recorded to extend over layers 0 and 1, some troubles are posed. In such case, after RDZ lead-in recording of the RMD duplication layer, the guard track zone of the middle area of layer 0 is padded, and data recording on the data area of layer 0 and that on the data area of layer 1 may be executed, as shown in FIG. 65. If the guard track zone of the middle area of layer 0 is padded, recording on layer 1 can start.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A multi-layer information recording medium comprising:
a transparent substrate;
a first information layer comprising tracks of concentric or spiral shape, the first information layer comprising a first organic dye layer formed on the transparent substrate and a first reflecting layer formed on the first organic dye layer;
a second information layer comprising tracks of concentric or spiral shape, the second information layer comprising an intermediate layer formed on the first reflecting layer, a second organic dye layer formed on the intermediate layer, and a second reflecting layer formed on the second organic dye layer;
wherein the first and second information layers are configured to allow recording and playback of information using light with a wavelength ranging from 180 nm to 620 nm; and
wherein the amounts of track eccentricity on the first information layer and the second information layer fall within a range from 0 to 70 μm.

2. A medium according to claim 1, wherein at least one of a radial position where the first information layer is formed, radial positions of a pit formation part and a groove formation part, radial positions of a mirror part and a groove formation part, a radial position of a zone boundary, and a radial position where wobble shapes are different is different from a radial position where the second information layer is formed, radial positions of a pit formation part and a groove formation part, radial positions of a mirror part and a groove formation part, a radial position of a zone boundary, and a radial position where wobble shapes are different.

3. A medium according to claim 1, wherein at least one of a crystalline position and an initialization position where the first information layer is formed is different from a crystalline position and an initialization position where the second information layer is formed.

4. An information recording/playback apparatus for performing recording and playback on a multi-layer information recording medium according to claim 1.

5. An information recording medium comprising:
a transparent substrate;
a first information layer formed on the transparent substrate and comprising tracks of a concentric or spiral shape, the first information layer comprising a phase change recording layer, a dielectric layer, and a reflecting layer;
a second information layer formed on the first information layer and comprising tracks of a concentric or spiral shape, the second information layer comprising a phase change recording layer, a dielectric layer, and a reflecting layer;
wherein the first and second information layers are configured to allow recording and playback with a wavelength falling within a range from 180 nm to 620 nm; and
wherein the amounts of track eccentricity on the first information layer and the second information layer fall within a range from 0 to 70 μm.

6. A medium according to claim 5, wherein at least one of a radial position where the first information layer is formed, radial positions of a pit formation part and a groove formation part, radial positions of a mirror part and a groove formation part, a radial position of a zone boundary, and a radial position where wobble shapes are different is different from a radial position where the second information layer is formed, radial positions of a pit formation part and a groove formation part, radial positions of a mirror part and a groove formation part, a radial position of a zone boundary, and a radial position where wobble shapes are different.

7. A medium according to claim 5, wherein at least one of a crystalline position and an initialization position where the first information layer is formed is different from a crystalline position and an initialization position where the second information layer is formed.

8. An information recording/playback apparatus for performing recording and playback on a multi-layer information recording medium according to claim 5.

9. A multi-layer information recording medium comprising:
a first information layer comprising a transparent resin substrate comprising tracks of a concentric or spiral shape and embossed with first information, and a first reflecting layer formed on the transparent resin substrate;
a second information layer comprising a transparent resin layer comprising tracks of a concentric or spiral shape, the transparent resin layer formed on the first reflecting layer and embossed with second information, and a second reflecting layer formed on the transparent resin layer,
wherein the first and second information layers are configured to allow playback using light with a wavelength falling within a range from 180 nm to 620 nm, and
wherein the amounts of track eccentricity on the first information layer and the second information layer fall within a range from 0 to 70 μm.

10. A medium according to claim 9, wherein at least one of a radial position where the first information layer is formed, radial positions of a pit formation part and a groove formation part, radial positions of a mirror part and a groove formation part, a radial position of a zone boundary, and a radial position where wobble shapes are different is different from a radial position where the second information layer is formed, radial positions of a pit formation part and a groove formation part, radial positions of a mirror part and a groove formation part, a radial position of a zone boundary, and a radial position where wobble shapes are different.

11. A medium according to claim 9, wherein at least one of a crystalline position and an initialization position where the first information layer is formed is different from a crystalline position and an initialization position where the second information layer is formed.

12. An information recording/playback apparatus for performing recording and playback on a multi-layer information recording medium according to claim 9.

13. A multi-layer information recording medium comprising:
a transparent substrate;
a first information layer comprising tracks of a concentric or spiral shape and comprising a first organic dye layer formed on the transparent substrate and a first reflecting layer formed on the first organic dye layer;
a second information layer comprising tracks of a concentric or spiral shape and comprising an intermediate layer formed on the first reflecting layer, a second organic dye layer formed on the intermediate layer, and a second reflecting layer formed on the second organic dye layer;
wherein the first and second information layers are configured to allow recording and playback at a linear velocity of not less than 30 m/sec;
wherein the first and second information layers are configured to allow recording and playback using light with a wavelength which is more than 620 nm and is not more than 830 nm; and
wherein the amounts of track eccentricity on the first information layer and the second information layer fall within a range from 0 to 70 μm.

14. A medium according to claim 13, wherein at least one of a radial position where the first information layer is formed, radial positions of a pit formation part and a groove formation part, radial positions of a mirror part and a groove formation part, a radial position of a zone boundary, and a radial position where wobble shapes are different is different from a radial position where the second information layer is formed, radial positions of a pit formation part and a groove formation part, radial positions of a mirror part and a groove formation part, a radial position of a zone boundary, and a radial position where wobble shapes are different.

15. A medium according to claim 13, wherein at least one of a crystalline position and an initialization position where the first information layer is formed is different from a crystalline position and an initialization position where the second information layer is formed.

16. An information recording/playback apparatus for performing recording and playback on a multi-layer information recording medium according to claim 13.

17. An information recording medium comprising:
a transparent substrate;
a first information layer formed on the transparent substrate and comprising tracks of a concentric or spiral shape, the first information layer further comprising a phase change recording layer, a dielectric layer, and a reflecting layer;
a second information layer comprising an intermediate layer formed on the first information layer, the second information layer further comprising tracks of a concentric or spiral shape, a phase change recording layer, a dielectric layer, and a reflecting layer;
wherein the first and second information layers are configured to allow recording and playback at a linear velocity of not less than 30 m/sec;
wherein the first and second information layers are configured to allow recording and playback using light with a wavelength which is more than 620 nm and is not more than 830 nm,
wherein the amounts of track eccentricity on the first information layer and the second information layer fall within a range from 0 to 70 μm.

18. A medium according to claim 17, wherein at least one of a radial position where the first information layer is formed, radial positions of a pit formation part and a groove formation part, radial positions of a mirror part and a groove formation part, a radial position of a zone boundary, and a radial position where wobble shapes are different is different from a radial position where the second information layer is formed, radial positions of a pit formation part and a groove formation part, radial positions of a mirror part and a groove formation part, a radial position of a zone boundary, and a radial position where wobble shapes are different.

19. A medium according to claim 17, wherein at least one of a crystalline position and an initialization position where the first information layer is formed is different from a crystalline position and an initialization position where the second information layer is formed.

20. An information recording/playback apparatus for performing recording and playback on a multi-layer information recording medium according to claim 17.

21. A multi-layer information recording medium comprising:
a transparent substrate;
a first information layer comprising tracks of a concentric or spiral shape and comprising a first organic dye layer formed on the transparent substrate and a first reflecting layer formed on the first organic dye layer;
a second information layer comprising tracks of a concentric or spiral shape and comprising an intermediate layer formed on the first reflecting layer, a second organic dye layer formed on the intermediate layer, and a second reflecting layer formed on the second organic dye layer;
wherein the first and second information layers are configured to allow recording and playback using light beams with not less than two different wavelengths; and
wherein the amount of track eccentricity on the first information layer and the second information layer fall within a range from 0 to 70 μm.

22. A medium according to claim 21, wherein at least one of a radial position where the first information layer is formed, radial positions of a pit formation part and a groove formation part, radial positions of a mirror part and a groove formation part, a radial position of a zone boundary, and a radial position where wobble shapes are different is different from a radial position where the second information layer is formed, radial positions of a pit formation part and a groove formation part, radial positions of a mirror part and a groove formation part, a radial position of a zone boundary, and a radial position where wobble shapes are different.

23. A medium according to claim 21, wherein at least one of a crystalline position and an initialization position where the first information layer is formed is different from a crystalline position and an initialization position where the second information layer is formed.

24. An information recording/playback apparatus for performing recording and playback on a multi-layer information recording medium according to claim 21.

25. A multi-layer information recording medium comprising:
a first information layer comprising a transparent resin substrate comprising tracks of a concentric or spiral shape and embossed with first information, and a first reflecting layer formed on the transparent resin substrate;
a second information layer having a transparent resin layer comprising tracks of a concentric or spiral shape, the transparent resin layer formed on the first reflecting layer and is embossed with second information, and a second reflecting layer formed on the transparent resin layer;
wherein the first and second information layers are configured to allow playback from one surface using light beams with not less than two different wavelengths; and
wherein the amount of track eccentricity on the first information layer and the second information layer fall within a range from 0 to 70 μm.

26. A medium according to claim 25, wherein at least one of a radial position where the first information layer is formed, radial positions of a pit formation part and a groove formation part, radial positions of a mirror part and a groove formation part, a radial position of a zone boundary, and a radial position where wobble shapes are different is different from a radial position where the second information layer is formed, radial positions of a pit formation part and a groove formation part, radial positions of a mirror part and a groove formation part, a radial position of a zone boundary, and a radial position where wobble shapes are different.

27. A medium according to claim 25, wherein at least one of a crystalline position and an initialization position where the first information layer is formed is different from a crystalline position and an initialization position where the second information layer is formed.

28. An information recording/playback apparatus for performing recording and playback on a multi-layer information recording medium according to claim 25.

29. An inspection method of an information recording medium, comprising:
irradiating a multi-layer information recording medium with an illumination that does not contain light components of wavelengths of more than 620 nm, the information recording medium comprising a first information layer and a second information layer having tracks of a concentric or spiral shape and configured to allow playback from using light with a wavelength ranging from 180 nm to 620 nm;
sensing images for at least one round of the tracks by focusing a light spot on the tracks of the first information layer and the second information layer using an image sensing mechanism; and
extracting paths of the tracks by processing obtained image information using an image processing unit; and
calculating eccentricity amounts of the tracks based on the extracted information using an arithmetic and control unit.

30. A method according to claim 29, wherein the image sensing mechanism comprises a CCD camera.

31. An inspection method of an information storage medium, comprising:
irradiating a multi-layer information recording medium with a laser beam using a laser beam irradiation device, the information recording medium comprising a first information layer and a second information layer comprising tracks of a concentric or spiral shape and configured to allow playback from one surface using light with a wavelength ranging from 180 nm to 620 nm;
measuring reflectance distributions for at least one round of the tracks of the first information layer and the second information layer using a reflectance distribution measurement mechanism;
extracting paths of the tracks by processing the obtained reflectance distributions by an image processing unit; and
calculating eccentricity amounts of the tracks based on the extracted information by an arithmetic and control unit.

32. A method according to claim 31, wherein the laser beam has a wavelength that exceeds 620 nm.

33. A method according to claim 31, wherein tracks which have undergone trial recording for learning, optimization, and the like of a write strategy are used as the tracks of the first information layer and the second information layer.

34. An inspection apparatus of an information recording medium, comprising:
an illumination system configured to irradiate a multi-layer information recording medium with an illumination that does not contain light components with wavelengths of 620 nm or less, the information recording medium comprising a first information layer and a second information layer comprising tracks of a concentric or spiral shape and configured to allow playback using light with a wavelength ranging from 180 nm to 620 nm;
an image sensing mechanism configured to sense images of the tracks of the first information layer and the second information layer;
an image processing unit configured to extract paths of the tracks by processing image information obtained by the image sensing mechanism; and
an arithmetic and control unit configured to calculate eccentricity amounts of the tracks based on the extracted information.

35. An apparatus according to claim 34, wherein the image sensing mechanism comprises a CCD camera.
